(19) United States
(12) Patent Application Publication
(10) Pub. No.: US 2015/0347600 A1
(43) Pub. Date: Dec. 3, 2015

(54) Broadband Centralized Transportation Communication Vehicle For Extracting Transportation Topics of Information and Monitoring Terrorist Data

(71) Applicant: Joseph Akwo Tabe, Silver Spring, MD (US)

(72) Inventor: Joseph Akwo Tabe, Silver Spring, MD (US)

(21) Appl. No.: 14/742,937

(22) Filed: Jun. 18, 2015

Related U.S. Application Data
(63) Continuation-in-part of application No. 13/481,756, filed on May 25, 2012.
Application No. 13/481,756 is a continuation-in-part of application No. 11/254,973, filed on Oct. 21, 2005, now abandoned.

(51) Int. Cl. G06F 17/30

(52) U.S. Cl. CPC G06F 17/30867; G06F 17/30619

(57) ABSTRACT

Described herein is a search engine for extracting science, engineering, and transportation topics of information from a database such as the web and analyzing occurrences of the topics of information that were queried or found in the database to identify a pattern in which the topics were stored or extracted for providing communications responsive to different science, engineering, and transportation platforms, and enabling these platforms to talk to one another through a centralized system that integrates with government transportation agencies seamlessly in real time. The search engine provides centralized communications with existing transportation industries, science and engineering companies, homeland security departments, car rental companies and garages through their local existing systems and enable these systems to talk to each other and communicate better in real time interaction, real responsive, centralized database interaction, real resourceful, and real responsible to science, engineering, and transportation analysis and maintenance reprogramming, monitoring of terrorists desiring transportation topics, and providing centralized social network platforms for engineering students and engineering professionals.

### CROSS-REFERENCE TO RELATED APPLICATIONS

This application is a continuation-in-part of U.S. patent application Ser. No. 13/481,756, filed on May 25, 2012. U.S. patent application Ser. No. 13/481,756 is a continuation-in-part of U.S. patent application Ser. No. 11/254,973, filed on Oct. 21, 2005.

### BACKGROUND

Science and engineering education is a global endeavor and globalizing engineering education and standards would challenge the longstanding scientific preambles of the United States. Advances to globalize science and engineering are needed and would bring economic leadership to the nation. Establishing a centralized science and engineering social network for educational institutions and engineering professionals would present a social forum for knowledge of works to be shared and would expedite the rate at which students may develop solving real world problems. Knowledge on real world problems such as global warming and environmental emergencies would be easily shared by students and engineering professionals through a centralized science and engineering social network. Through the centralized network, engineering professionals would be able to identify the best, brightest, and most innovative science and engineering talents. These talents are needed for industrial advancements, but are not easily identified without the implementation of science and engineering social Network.

The large and constantly expanding size of the Internet and World Wide Web presents difficult challenges for using search engines. For example, most engines at this time are unable to index (create database entries for) the entirety of science, engineering and transportation files, forms or documents that are available on the Internet, or even a substantial fraction of these files, forms or documents. The storage space and computational time constraints which limit the ability of the engines to index information may also limit the complexity of the database entries. This may create various problems for a user without proper search engines.

### BRIEF SUMMARY

Disclosed embodiments provide a centralized transportation search engine comprising Standard Transportation Engineering Social Network (STESN). STESN relates to providing a search engine for searching transportation topics of information, providing transportation topics advertisements, providing a knowledge base social network for university engineering students and engineering professionals, providing preventive maintenance scheduling responsive to files storage medium for transportation companies, and providing solutions to failed transportation components. In the disclosure, embodiments provide a neural network operatively configured with at least a programmable architecture being configured with at least one dedicated processing elements. The communication apparatus further comprising at least software configured with at least a memory device comprising values being accessible to said dedicated processing elements.

Certain embodiments provide a centralized transportation and engineering marketplace for engineering and transportation services. The services are important transportation and engineering topics of information that could not be found elsewhere. These services include bodies of transportation knowledge that are stored in computer codes and would be readily described when such information is queried. STESN will serve as the continuous distributor of knowledge around the world while also helping the Department of Transportation (DOT) keep track of foreign motor carriers crossing U.S. borders and the type of services that those motor carriers need in order to safely operate on U.S. soil. STESN is an online transportation search engine for searching transportation topics of information, a social network for engineering students and engineering professionals, and a system for national security. STESN allows transportation companies to control their cost while generating higher traffic to their website. STESN also serves as the centralized communication point between foreign motor carriers and DOT.

Automotive part stores advertisements are connected to consumers through STESN to the websites of their choice of stores. Parts stores are connected to STESN for advertisements and include a click to go system for selected parts for purchase. Advertisers on TESN would be able to take advantage of their trademarks or bid on a word.

The objectives of disclosed embodiments is to advance science and engineering knowledge and knowledge of works through STESN that would deliver forefront computational and network capabilities for scientist and engineers to extend their frontiers of science. Developing new talent in science and engineering requires finding new ways to teach. STESN is the vehicle that would drive the organizational mission because complex problems can best be solved by cross functional teams and that people who work, live, and learn in integrated science and engineering settings develop stronger interpersonal communications and applied science skills. STESN would embody programs to educate students of different disciplines and reach new innovative aspects of science, engineering, and technologies.

STESN further objective is to enable a chart function where the leaders of educational institutions, businesses, and industries would present the visibility of crisis and refresh the public and students on the social compacts. and direct partnerships toward solutions for the crisis. These leaders would be able to engage national crisis and post a national strategy, addressing the crisis and the level of competitiveness needed to address the science and engineering aspect of the crisis. STESN further objective is to enable a collaborative network forum, which is required to make sustainable change across the spectrum of education, science, engineering, technology, innovation, and crisis.

Disclosed embodiments further provide a centralized transportation vehicle comprising a search engine system that includes an entity extractor. a categorizer. and a query generator for managing and sharing science. engineering. and transportation activities such that when a topic on science, engineering and transportation information is queried, responses are retrieved to enrich knowledge, transportation preventive maintenance scheduling, generating solutions to queried transportation component failure, extracting names of terrorist desiring a rental car, and analyzing failed transportation component through a centralized database. The search engine system further comprises a communication apparatus comprising at least a hardware device.

Some embodiments provide the hardware device comprising at least one dedicated processing elements being configured with at least an input array, at least an output array, and/or at least a query array. Certain embodiments provide an entity extractor configured to identify a set of entities as described in the engineering, science and transportation topic of information through selected files, forms, or document content for enabling searching the information related thereto using an information retrieval system.

Disclosed embodiments further provide the categorizer operable to define an organized classification of the science, engineering and transportation files, forms or document content with each class in the organization of component content having associated therewith a classification label. In the disclosure, the classification label corresponds to a category of topics of science, engineering and transportation information in the information retrieval system. The categorizer is configured to assign the selected science, engineering and transportation files, forms or document content a classification label from the organized classification of science. Engineering and transportation component content. Certain embodiments provide a query generator operatively configured to automatically formulate a query that restricts a search for science, engineering and transportation topics of information.

The search could be restricted at the information retrieval system for the particular information concerning the set of entities to the category of science, engineering and transportation topics of information in the information retrieval system identified by the assigned classification label to enable speedy responses to information from the centralized transportation vehicle. The centralized transportation vehicle is in communication with a computer apparatus comprising at least a database comprising at least information for science, engineering and transportation topics.

Certain embodiments provide an interactive device configured for allowing computational devices to talk to each other through the use of networks connections. Computational devices include computers and other portable devices such as wireless telephones, mega telecommunication, personal digital assistants and automobile-based computers, electronic devices, and portable devices. The networks connecting computational devices for the instant invention include wireless and wired networks which are formed using land lines such as copper wire or fiber optic cable. and wireless networks which employ earth and/or satellite-based wireless transmission links and a combination of wired and wireless network portions. These networks are organized using a client/server architecture in which server computational devices manage science, engineering and transportation operational resources such as preventive maintenance files, solutions to failed transportation component, fuel consumption per vehicle in a fleet, computational transportation devices processing power which could be requested by client computational devices such as users of the network. Other computational devices not operated directly by an end user such as at least proxy servers may represent either clients or servers.

A communication apparatus may be configured for optimizing and for sharing science, engineering and transportation topics of information. Certain embodiments provide the communication apparatus further comprising at least a cache engine operatively configured with at least one array. The cache engine further comprises at least a markup language configured with at least one array for entering searchable science, engineering and transportation topics of information. Some embodiments provide the computer apparatus further comprising a spider, and/or a crawler, each configured for disseminating science, engineering and transportation topics of information.

Disclosed embodiments further provide a web configured for disseminating science, transportation and/or engineering topics of information. Certain embodiments provide the centralized transportation search vehicle further comprising a structured science, transportation and engineering network environment communicatively connected to at least one support system configured with at least an index and/or a catalog comprising science, transportation and/or engineering data. Some embodiments provide the data further includes at least one of: parts purchasing, science and engineering assignments, science and engineering research environment, standard maintenance solution, preventive maintenance scheduling, preventive maintenance forms, fuel consumption logs, mileage logs, solutions to failed components, equipment sales, parts graphics, marketing, name searches, sounds, text, video, engineering and/or science topics of information, engineering materials and/or tools, and an advertisement.

The centralized transportation vehicle is provided with a system that generates a query for end users using an entity extractor, a categorizer, a query generator with a short run aspect vector. The entity extractor is configured to identify set of entities in selected file content for searching information related to science, engineering and transportation operation and maintenance scheduling through the information retrieval system. The categorizer is further configured to establish an organized classification of individual company file content per equipment with each class in the organization of the content having associated classification labels that correspond to a category of information in the information retrieval system. The file content further contains equipment components per make and models relevant for retrieval of solutions to specific queries. The categorizer assigns the selected file content a classification label from the organized classification of content in relation to responding to the queried information in real time.

The query generator may gather each query that restricts a search at the information retrieval system to the category of information in the information retrieval system identified by the assigned classification of the individual companies. The category of information allows the query generator comprising a short length aspect vector generator to generate terms for refining the query using context information surrounding the set of entities in the selected file content so that files and transportation files. forms. or documents are made searchable through the centralized transportation vehicle.

Disclosed embodiments provide STESN in communication with computers in the science, engineering and transportation industries, including putting transportation technologies together by directing end users to transportation topics of information through the centralized transportation vehicle. In the disclosure, embodiments would provide easier means for employees of these industries to share files and data resources through a centralized science, engineering and transportation network systems. The shared network will enable communication with every transportation industries, garages, and transportation companies, engineering companies, and science companies seamlessly through a resourceful time sharing via shared Internet access. The centralized transportation vehicle includes science and engineering searches through a centralized transportation system. The centralized transportation system further includes server-based network to enable reliability of solutions to local and distance transportation industries. The server network is operable to connect industrial employees through a local social network environment to include topics of information resourceful to their business maintenance program and preventive maintenance, providing step by step repair procedures for a failed vehicle component.

Disclosed embodiments further provide a centralized science, engineering and transportation network system configured with server adaptors to maximize productivity and end user longevity. Certain embodiments provide the server adaptor configured to allow users to communicate through STESN search engines. Thus, the entire network system will periodically need maintenance and the URL may be modified at random times by their web masters.

When a webmaster changes the content of a web page, including adding or removing content or deleting the page altogether. STESN search engine database would not immediately reflect these changes. A typical search will produce a single link that either point to STESN web site or its modified web site. Accordingly, when a user clicks on the URL and an error results comes on, if the user is unable to access the envisioned content, STESN search engines would strive to keep track of the Web by continuously finding, indexing and cataloging web pages.

Some embodiments provide a server adaptor software configured to automatically re-route traffic signals when any of the server ports experience a failure or are disconnected. Files are always monitored and allow access to multiple server files containing client data to enable prevention of any loss of information when the hardware experiences a failure.

Disclosed embodiments further provide a multiple file storage system being centralized for maximum protection. Certain embodiments provide the centralized science. engineering. and transportation network system being configured with a switch to connect client system and servers together to create a client server network within the system and a social environment for communications. Some embodiments further provide the backup storage software being operable for providing backup file scheduling such as tape backup and server file storage backup in weekly. daily. or monthly intervals. The backup storage allows the centralized science, engineering, and transportation system access to remotely recover any lost file. Other embodiments provide a process comprising a network system operable to eliminate single point failure by advancing an application/technology to keep single components on hand for emergency use. In the disclosed embodiments. indexing is provided for storing of links pointing to information resources including some or all of the data associated with the information resource.

In other cases, embodiments provide STESN search engines in communication with computer applications called spiders or robots for indexing the different elements of web sites on the Internet and for gathering content information for STESN search engine database. Essentially. STESN search engine robot is configured to index significant number of information resources in the Internet. The robot is further configured for updating links in STESN search engine database in a queried dependency manner so that science. engineering. and transportation topics of information are better shared to:

1. Improve knowledge and productivity

2. Improve homeland security and data mining

3. Improve environmental safety

4. Cut maintenance cost

5. Gain maintenance and repair flexibility

6. Share resources to gain optimal output in minimal time

7. Increase collaboration through file sharing

8. Improve corporate data security

9. Detect intrusion through multiple firewall configuration

10. Enable corporate privacy control and prevents confidential information

11. Enable anti-spam filtration of unwanted queries

12. Utilize bus to offer point to point lanes to the database

13. Deliver peak performance to meet demands for industrial multitasking

14. Enables continuous background virus check and scanning at firewall

15. Enable multimedia application with intensified multitasking between industries

16. Connecting employees with maximum performance through a social environment

17. Centralized Engineering Social Network

The cycle time for STESN search engine robots is the time between sampling the same web site and incorporating any changes into STESN search engine database. The sampling requires a significant period of time as long as several months. Moreover, if a particular site is not accessible when a robot comes around to examine it, the robot will not index the web pages on that web site until some future time. In the worst case scenario, the URL pointing to the web site (including any URLs to any of its web pages) could be excluded from the STESN search engine database entirely. As more web sites come online, the amount of time for STESN search engine robot operation to cover the entire Internet would continue to increase, requiring additional computing resources.

Embodiments provide a time-delay between indexing and/or re-indexing any content resource (e.g., a web page). Certain embodiments provide the indexing and re-indexing comprises information stored in the STESN search engine database that is stale (e.g., outdated or not “fresh” URLs). In the disclosed embodiments, over a given time period an equal amount of computing resources are dedicated to refreshing each link stored in the STESN search engine database. However, given the large number of dynamically changing Internet resources to monitor, and only limited resources (bandwidth and storage) available to do the monitoring, there is a need in the relevant technology for a system and a method of deciding which resources should be updated first and when.

In some embodiments, the network system is the World Wide Web, and may include millions of web involving science, engineering and transportation content servers being located anywhere in the world. Each science, engineering and transportation content server may store or “host” one or more web sites. Each web site includes one or more web pages. Disclosed embodiments further provide science, engineering and transmission media communicatively connected to STESN search engine servers, clients and transportation content servers hosting the web sites to a network system. Certain embodiments provide the network system further comprising other transmission media and computational devices being wired or wirelessly interconnected to a centralized science, engineering and transportation communication environment in a network.

In a typical searching sequence, communication is established over the network between at least a client and STESN search engine server. Some embodiments provide the communication environment further comprising a web browser program on the client machine. Other embodiments provide a search criteria being entered by a user of the client machine, and being transmitted to the STESN search engine server. STESN search engine server being operable for searching the information available on the network, including science, engineering and transportation topics of information. The topics of information are made searchable on the information content servers containing science, engineering and transportation files, forms, or documents relevant to the search criteria. The search includes searching the database stored on STESN search engine server. The database further includes previously-formed entries corresponding to web pages accessible over the network environment. The results of the search are transmitted back to the requesting client. The client may. for example. access particular web pages that are included in the results directly over network environment as desired by the user.

Disclosed embodiments provide processes comprising constructs that store science, engineering, and transportation definitions comprising descriptions of particular tasks to be performed. The task to be performed is described using one or more protocols and/or one or more other processes. By this definition. a process is a grouping of protocols and other processes, wherein the functions described by the protocols and processes perform desired tasks. Certain embodiments provide processes further comprising logical statements written in any scripting language operable to further perform error and recovery operations for the centralized transportation vehicle. Some embodiments provide like protocols and processes comprising written generic format that identifies a type of software module that can be the target of the task of the relationship between the centralized transportation vehicle and the end users. but does not identify a specific software module or modules on which the task is to be performed from local computers. Other embodiments provide the end users comprising servers.

Disclosed embodiments further provide a classification label corresponding to categories of science, engineering and transportation topics of information in the information retrieval system. Certain embodiments provide a categorizer configured for assigning the selected science, transportation files, forms, document content, or a classification label from the organized classification of science and engineering topics and transportation component content. A query generator is configured to automatically formulate a query that restricts a search for science, engineering and transportation topics of information at the information retrieval system. The information retrieval system comprises particular information concerning the set of entities for the category of science, engineering, and transportation topics of information in the information retrieval system. The information is to be identified by the assigned classification label being provided to enable speedy responses to science, engineering and transportation topics of information from the centralized transportation vehicle.

The entity extractor identifies the set of entities in selected file content for searching science, engineering and transportation topics of information, including related transportation operation and maintenance scheduling through the information retrieval system. The files are requested from server computers or web servers. Disclosed embodiments provide a server comprising a computer apparatus configured for hosting web page for the centralized transportation vehicle. The server is connected to the Internet and the science, engineering and transportation topics of information are routed through the transportation vehicle or STESN search engine. The server is configured for retrieval of information specific to the queried topics of information from another server comprising a database system.

Generally, a database system may be developed and STESN search engine may be in communication with the database system and an end user. The search engine directories would route all the science, engineering and transportation topics of information from the server containing the database system. The database system is developed to aid users in finding specific types of information unique to science, engineering and transportation vehicles preventive maintenance and safeties. STESN search engine is often used for communications with the database system, distinguishing itself from directory by routing all science, engineering and transportation topics of information from the internet to the database server system.

STESN may be further configured for collecting science, engineering and transportation topics of information automatically using programs such as spiders, robots and/or crawlers, which will visit the centralized transportation vehicle web page and collect the needed data by downloading files in relation to the queried topics of information and process the files. The centralized transportation vehicle is a process-driven science, engineering and transportation management system for managing data relating to science, engineering and transportation codes and modules. In one instance of the disclosure. STESN is configured to link computers in the science, engineering and transportation industries, including science and engineering technologies together by directing end users to topics of information through the centralized transportation vehicle, making it easier for employees of these industries to share files and data resources through a centralized transportation network system.

The centralized transportation vehicle comprises a centralized science, engineering and transportation social network system that includes server-based network to enable reliable science and engineering network and solutions to local and distance transportation industries. The Web content for the network system is based on queries so that when a user submits a query containing science, engineering and transportation topics of information, the network system in communication with the search engine would respond with a listing of links pointing to information resource. The search engine is further configured for matching entries on science, engineering, and transportation topics of information with the information on the database server.

The centralized transportation network system uses direct attached storage to the server hard drive comprising a network attached storage to consolidate files stored. The centralized transportation network system is further configured with a server adaptor to maximize productivity and end user longevity. The network adaptor is configured for allowing end users to communicatively be connected to the search engine. The centralized transportation network system is further configured with at least a switch being operable to connect client system and servers together to create a client server network within the system. Disclosed embodiments further provide a backup server for allowing the centralized transportation system access to remotely recover any lost file.

Certain embodiments provide a transformation system comprising a process-based interface for science, engineering, and transportation topics of information in communication with end users. Some embodiments provide a search engine comprising computer applications consisting of spiders and robots being operable for indexing different elements of web sites on the Internet and for gathering content information.

Disclosed embodiments provide a computer apparatus comprising techniques for extracting science, engineering and transportation topics of information through search patterns from a database such as the Web. Certain embodiments provide techniques comprising one or more topics of information that act as the initial search. Some embodiments provide the database or databases comprising a searchable medium for occurrences of the topics of information. Other embodiments provide a technique comprising patterns being identified in the array in which they are stored. These patterns are used to extract more topics from the database and the process can be repeated for new topics. Information can be extracted from a database efficiently and accurately with little or no human interaction. Disclosed embodiments further provide a computer implemented method of extracting information from a database. Other features and advantages of disclosed embodiments would become readily apparent upon review of the following description in association with the accompanying drawings.

The preceding Brief Summary is intended to serve as a brief introduction to various features of some exemplary embodiments. Other embodiments may be implemented in other specific forms without departing from the spirit of the disclosure.

### BRIEF DESCRIPTION OF THE DRAWINGS

The novel features of the disclosure are set forth in the appended claims. However, for purpose of explanation, several embodiments are illustrated in the following drawings.

FIG. 1 illustrates an exemplary embodiment of a centralized transportation vehicle in a server system for communications and includes a cache engine, an indexer, and another server that is configured with software for a network;

FIG. 2 illustrates an exemplary embodiment of a system for the network environment, comprising web-enabled devices in communication with the centralized transportation vehicle;

FIG. 3 illustrates an exemplary embodiment of the network comprising multiple computer systems configured for Internet applications, further including a decision engine, a wireless device and a server system for the network;

FIG. 4 illustrates a flow chart showing the exemplary process of extracting science, engineering, and transportation topics of information from a database;

FIG. 5 illustrates an exemplary embodiment of the network in communication with the search engine for routing information in the network and for extracting information from the database;

FIG. 6 illustrates an embodiment comprising the process of identifying a pattern from topics of information that have been found in a database;

FIG. 7 illustrates an embodiment of a table of initial topics of information to be searched from the database and the process of verifying that a topic of information has been found in the network;

FIG. 8 illustrates an exemplary embodiment of the communication apparatus in a network environment;

FIG. 9 illustrates further exemplary embodiments of the communication apparatus in a structured environment;

FIG. 10 illustrates an exemplary embodiment of the communication apparatus in a network environment;

FIG. 11 illustrates an embodiment of a mobile phone with a touch screen panel operable for communications, interactive gaming, music applications, and a slider operable for accessing multimedia buttons;

FIG. 12 illustrates a mobile phone with numeric keypads operable to provide voice over texting applications, a slide out keyboard, and resistive touch screen character recognition;

FIG. 12A illustrates a communication apparatus;

FIG. 12B illustrates an exemplary embodiment of a human hand holding the communication apparatus;

FIG. 12C illustrates an exemplary embodiment of human hand interaction;

FIG. 13 illustrates a nanotechnology application of CMOS multiple antennas on a chip and nano-wires for transporting energy;

FIG. 14 illustrates an exemplary embodiment of an antenna apparatus and an energy transport medium;

FIG. 15 illustrates CMOS multiple antennas on a chip comprising substrate microfiber embedded with meta-material;

FIG. 16 illustrates exemplary embodiments of a communication device comprising an energy platform;

FIG. 17 illustrates an exemplary embodiment of a charge transport comprising microfiber material being configured with silicon substrate;

FIG. 18 illustrates a communication environment comprising a monitoring station. Agencies, and a government building;

FIG. 19 illustrates a further embodiment of a monitoring station comprising a fiber tower network;

FIG. 20 illustrates a transmitter being configured with an energy apparatus comprising a battery cell which may be charged wirelessly;

FIG. 21 illustrates a transmitter and a receiver being configured with an energy apparatus comprising a battery cell which may be charged wirelessly;

FIG. 22 illustrates an embodiment comprising the circuit diagram of a communication apparatus, including a privacy indicator;

FIG. 23 illustrates a further exemplary embodiment of a communication apparatus comprising an input device, including a keyboard; and

FIG. 24 illustrates a further exemplary embodiment of a communication apparatus comprising a storage medium, and a processing unit in communication with a memory device.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various inventive features are described below that can each be used independently of one another or in combination with other features. Broadly, some embodiments generally provide a centralized transportation communication vehicle comprising a platform for advancing science, transportation and engineering knowledge, including a social network for enabling scientists, engineers and transportation industries to communicate with one another. Certain embodiments provide an engine for extracting science, engineering and transportation topics of information from a centralized transportation database having information relating to different topics and subjects. Some embodiments provide the engine comprising a computer apparatus configured for enabling communication with different systems and responsive to different platforms. Other embodiments provide a communication apparatus in communication with a centralized transportation searchable vehicle operable for enabling Internet and web-based searches for topics of information relating specifically to engineering, science and transportation topics.

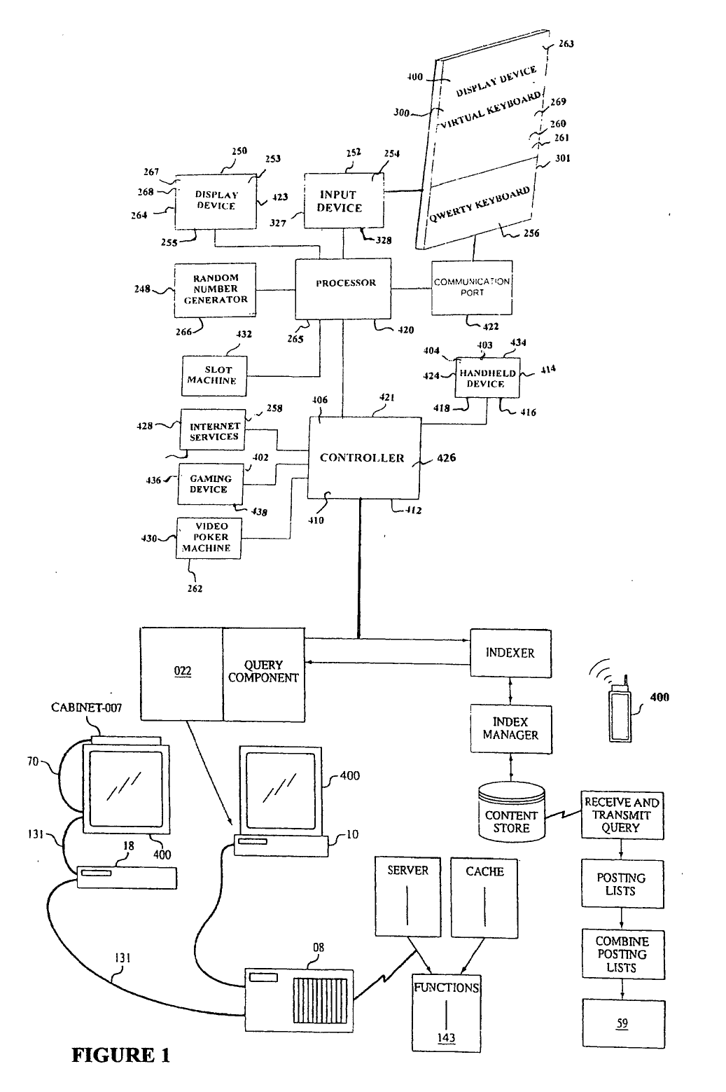

FIG. 1 illustrates an exemplary embodiment of a centralized transportation vehicle in a server system for communications and includes a cache engine, an indexer, and another server that is configured with software for a network. The communication apparatus may include a cell phone 400. The communication apparatus further comprises at least an input device 252, including a keyboard 254. The keyboard 254 may consist of a virtual keyboard 255 and/or QWERTY keyboard 256 in further communication with a random number generator 248. The communication apparatus further comprises a centralized transportation search engine comprising science, transportation and engineering topics data processing system operable on a social platform 258 operatively configured for multicast virtual private network for advancing science, transportation and engineering knowledge. The social platform 258 comprises a social network application in communication with the processor 420.

Disclosed embodiments further provide the keyboard disposed on an LCD display screen 260 being configured with sensors 327 operable for object recognition. Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265, and camera 263. Disclosed embodiments further provide the communication apparatus further comprising at least one of: a mobile communication device 400, a gaming device 402, a media device 403, and an interface device 404. The communication apparatus further comprises a computer apparatus 400 comprising a computer recordable medium 10 being operable on a computer readable program being recorded to cause at least one computer device to receive plurality of science, transportation and engineering reference documents.

The computer apparatus comprises a database comprising topics of information relating to science topics, transportation topics and/or engineering topics. The computer apparatus is further operable for storing a frequency through which a module generates content when queried and is further operable for determining keyword compatibility based on the frequency. Disclosed embodiments provide the interface device comprising at least an integrated phone/PDA 400 being configured with integrated connectivity apparatus 406 operable to provide global roaming for communications and for accessing science, engineering, and transportation topics of information. At least a communication port 422 is provided with the communication apparatus 400. Certain embodiments of the disclosure provide the communication apparatus comprising a GSM phone 400 being operable on plurality microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video, social network, and phone book.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still, other embodiments provide a communication apparatus comprising of carbon fiber 408 and/or silicon substrate microfiber consisting of resistive touch screen 260 and/or character recognition 269 and/or a communication board 300. Certain embodiments provide housing 301 for the communication apparatus 400 comprising a carbon fiber 408 and/or a silicon microfiber.

Disclosed embodiments further provide a communication apparatus being configured with at least a WAP browser 410 and/or an integrated GPS device 412 and/or an MP3 music device 414 and/or a camera apparatus 416 in communication with an interactive interface apparatus. The interactive interface apparatus operatively configured with at least a multi-protocol label switching comprising a label switched path operable on at least a support system operatively configured for mapping desired communications and to execute at least a process to at least a reference document. Disclosed embodiments further provide a communication apparatus further configured with an internal antenna apparatus 418 being configured with a controller 421 in communication with a predictive text messaging applications 423. Disclosed embodiments further provide the support system communicatively connected to at least a dedicated processing element being operable for providing carrier based multicasting virtual private networks.

Certain embodiments provide the communication apparatus 400 being configured with at least one of: infrared sensor 326, calendar 268, FM radio 424, Bluetooth technology 426, and GPRS Internet services 428. Disclosed embodiments further provide the communication apparatus 400 comprising a video poker machine 430, a slot machine 432, a handheld device 434, a gaming device 436. and/or a play station 438 in communication with communication port 422. Preferred embodiments provide the communication apparatus 400 comprising a search engine for routing science, engineering, and transportation topics of information. Some embodiments provide the network 20 comprising distributed collection of nodes interconnected by communication links 131 and segments for transporting reference document data between end nodes.

Other embodiments provide the end notes comprising computer devices and workstations. Disclosed embodiments provide the network comprising local area networks (LANs) and wide area networks (WANs). The communication apparatus 400 further comprises a circuit board comprising electronic system applications being configured for an embedded network for at least one of: a wired communications device, a wireless communications device, a cell phone, a handheld communication device, laptop computer, desktop computer, telemetry device, a switching device, MP3 player, a router, a repeater, a codec, a LAN, a WLAN, a Bluetooth enabled device, a digital camera, a digital audio player, a digital video recorder, a computer, a monitor, a television set, a satellite set top box, a cable modem, a digital automotive control system, a control module, a communication module, a digitally-controlled home appliance, a printer, a copier, a digital audio or video receiver, an RF transceiver, a personal digital assistant (PDA). a digital game playing device, a digital testing and/or measuring device, a digital avionics device, a media device, a medical device, and/or digitally-controlled medical equipment.

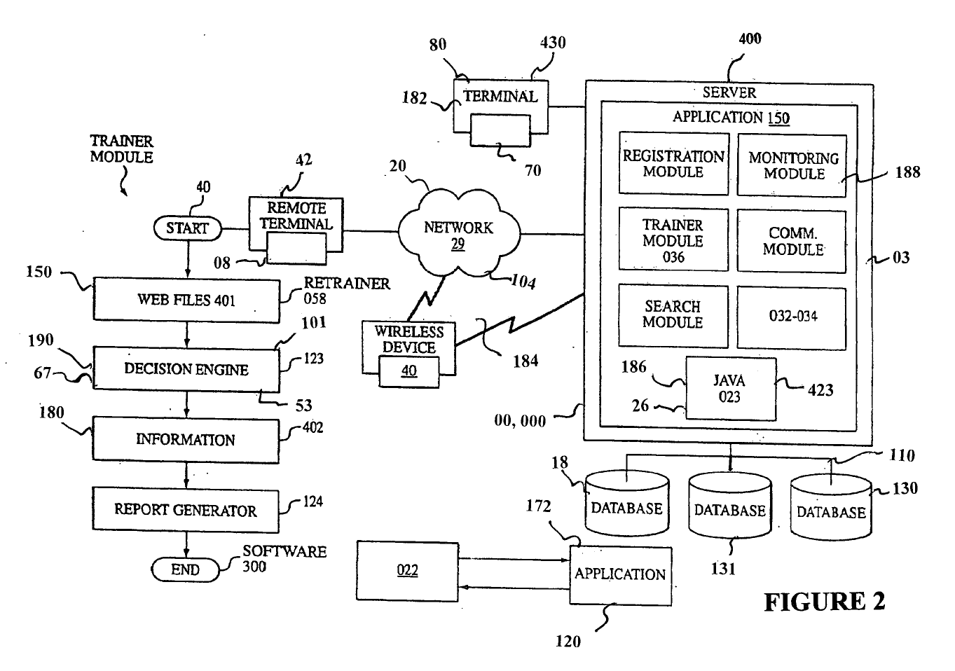

FIG. 2 illustrates an exemplary embodiment of a system for the network environment, comprising web-enabled devices in communication with the centralized transportation vehicle, which may include a communication apparatus 400 in communication with an output device 70 operable for outputting science, engineering, and transportation topics of information. Disclosed embodiments provide the communication apparatus 400 further comprising at least a computer apparatus 430 configured with software 300 further comprising an operating system. Certain embodiments provide the computer apparatus 430 comprising at least a server 00, 000 in communication with a client module 120 for determining that at least a key word maps to science, engineering, and transportation object identifiers. The communication apparatus 400 is communicatively connected to the client interactive interface module 172 in communication with network 20 comprising a link to a profile being configured for providing network services for science, transportation and engineering topics.

The communication apparatus 400 further comprises at least a software program 300, wherein at least one software program is configured with at least a memory device 180 in communication with search module 190 comprising values being accessible to the dedicated processing elements 423. The communication apparatus further comprises at least a hardware means comprising the dedicated processing elements being configured with an input array 182, an output array 184, and/or a query array 186. The computer apparatus 430 further comprises at least a database comprising an application module 130 configured for providing information relating to science, engineering, and transportation topics and/or other topics of information. Certain embodiments provide a monitoring module 188 operable for monitoring and storing the frequency through which each module generates content when queried. Some embodiments provide a communication module 192 in communication with registration module 194 operable for determining keyword compatibility based on the frequency. The client interactive interface module 172 is communicatively connected to at least one computer apparatus 430. further comprising at least a decision engine 123 disposed with a data bus comprising a platform for writing input into at least a data memory for at least one array.

Other embodiments further provide the decision engine 123 operatively configured with a report generator 124 in communications with network connection keys. The network connection keys in communication with files, forms, documents, industrial files 18, network files 110, a graphic user interface 101, sensors 104, web files 401, an/or a system memory 53. Certain embodiments provide the communication apparatus being further configured with system bus architecture 67 in communication with an input device 80. Disclosed embodiments provide report generator 124 in communication with an instruction program 26. Certain embodiments provide the instruction program 26 configured with trainer module 036 and retrainer module 058. The trainer module 036 and retrainer module 058 are configured with CPU 03. The CPU 03 is in communication with a java class 023. a clickn Vest Servlet class 032. and a Servletrunner application 034.

Disclosed embodiments provide the files, forms, and documents further comprising data relating to science, engineering, and transportation topics of information. The communication apparatus further comprises a wireless device 40 comprising applications operable for optimizing and/or for sharing transportation and/or engineering topics of information. Certain embodiments provide the communication apparatus comprising a remote terminal and/or a network terminal 022. The communication apparatus many be further configured with a readout tool 08 in communication with an address book 131 communicatively connected to a content store. Disclosed embodiments provide the computer apparatus 430 further comprising a module for determining that at least a key word maps to an object identifier for science, engineering, and transportation topics of information. The network terminal 022 is provided in communication with a query component.

Certain embodiments provide the communication apparatus 400 in a network environment 29 comprising at least a server application 150. The server application 150 further includes at least one of: a registration module 194, a monitoring module 188, a trainer module 036, a communication module 192, a search module 190, and/or java application software 023. Certain embodiments provide the java application software 023 in communication with a database server 000. Disclosed embodiments provide the communication apparatus 400 further comprising ports and/or terminals comprising a network terminal 022 in communication with the application module 130. Certain embodiments provide the communication apparatus being turned on by at least a start button in communication with at least a control device. Other embodiments provide the control device comprising a wireless device 40 communicatively configured for communications with remote terminals 42. Disclosed embodiments further provide a communication apparatus comprising at least one of: report generator module 124, information module 402, retrainer module 058, web-files module 401, a clickn Vest Servlet class 032, a Servletrunner application 034, and/or a decision engine.

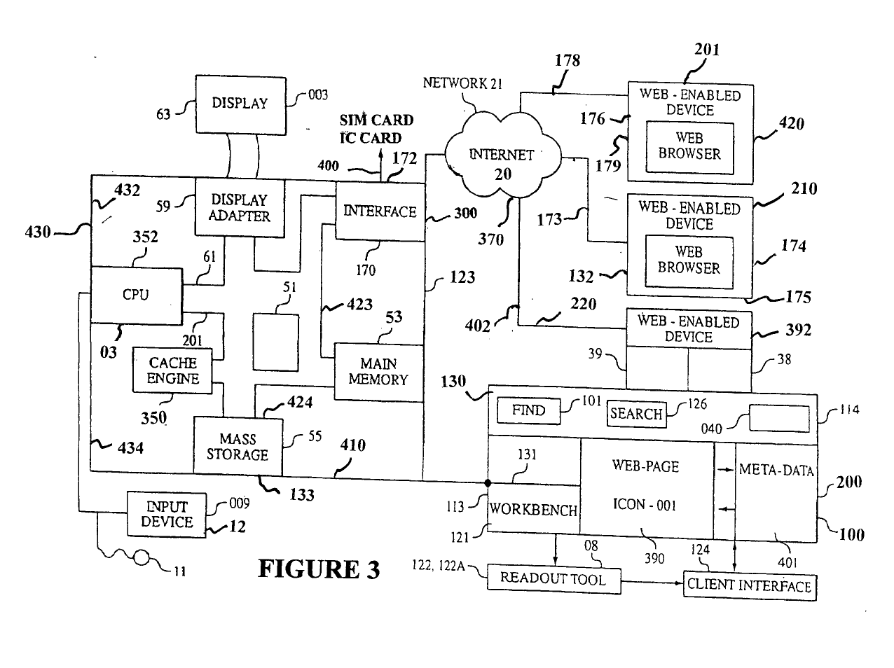

FIG. 3 illustrates an exemplary embodiment of the network comprising multiple computer systems configured for Internet applications, further including a decision engine, a wireless device and a server system for the network. A network environment 21 may comprise a communication apparatus 400 in communication with a computer system comprising a display device 003, a sound card 61, speakers 63, a cache engine 350, a network interface 170, a display adapter 59, intelligence logic 352, a media device 201, and/or a central processor 51. The communication apparatus further includes an input device 009 comprising at least a keyboard 11 and a mouse 12. The communication apparatus further includes an IC card and a SIM card in communication with network interface 170. The CPU 03 is operable with the intelligence logic 352 to process commands and applications in communication with memory 53, decision engine 123 and web-enabled devices. Disclosed embodiments further provide the web enabled devices comprising a browser 040. The network 21 is responsive to communications through the Internet. Certain embodiments provide a communication apparatus being configured with the browser 040, a server search report 39, and client search programs 38.

Disclosed embodiments further provide a communication apparatus configured with graphic user interface 101. a search program manager 126, a browser 040, an ICON 001, and a storage medium comprising at least meta-data 114. A web-page manager 392 is provided comprising addresses 131, corporations 200, industries 100, schools and warehouses 121 and a workbench 113. The computer system further comprises an affinity analyzer 122, a data analyzer 122A, a readout tool 08, a web-page 390, a report generator 124, web file module 401, and client interface being operable with software application 300. The communication apparatus 400 comprises science. transportation and engineering topics of information. Disclosed embodiments provide the communication apparatus 400 comprising a data processing system 410 operable on a social platform 420. The social platform 420 comprises a social network environment operatively configured for multicast virtual private networks. Disclosed embodiments provide the virtual private network 178 comprising apparatus operable for transmitting same data to multiple receivers in a network.

Certain embodiments provide the multicast virtual private network 178 comprising at least a multicast packet 176 configured for replication with at least a router 179. The multicast private network comprises a network interface 170 for advancing science, transportation and engineering knowledge. The network interface 170 further comprises: at least a computer apparatus 430 comprising a computer recordable medium 432 being operable on a computer readable program 434. The computer readable program 434 may be configured to cause at least one computer device to receive a plurality of science, transportation and engineering reference documents in communication with client interactive interface module 172 operatively configured with at least a multi-protocol label switching 173 being operable on at least a support system 210 operatively configured for mapping desired communications.

Disclosed embodiments further provide the multicast-protocol label switching 173 comprising an apparatus configured to direct data from network note 20 to network note 21 in communication with a virtual link. Certain embodiments provide the multiprotocol label switching comprising an apparatus configured for carrying data from network note 20 to network note 21 in communication with a virtual link. At least one support system 210 is configured with the social platform 420 and communicatively connected to at least a dedicated processing element 423. The multi-protocol label switching 173 is further configured to speed up network traffic flow to effectively manage structured reference documents comprising science, engineering, and transportation topics of information. Other embodiments provide the virtual private network 178 further comprising the router 179 in communication with the multiprotocol label switching network 173. The router 179 configured for the distribution of science, engineering, and transportation topics of information across a shared multiprotocol label switching network.

Further embodiments provide the router further including Internet protocol addresses for establishing multiple switched paths with the multiprotocol label switching network. Other embodiments provide the multiple switched paths comprising plurality point to point path assignments for science, engineering, and transportation social networks. Some embodiments provide the router 179 further configured for maintaining communications with the database 130 containing science, engineering, and transportation reference documents for the topics of information.

Other embodiments provide the database further comprising prefix of the topics of information that matches science, engineering, and transportation topics' addresses in the packet's network destinations address field. Disclosed embodiments further provide the Internet protocol configured to determine at least a direction for the packet transmission from the router to at least a remote computer system. In the disclosure. the packets further include Internet protocol data-gram comprising network addresses for remote destinations. The dedicated processing elements 423 may be operable for providing carrier based multicast virtual private networks 178. Some embodiments provide multi-protocol label switching 173 consisting of labels 175 comprising packets 176 to forward decisions made on the contents of the labels.

Disclosed embodiments provide the communication apparatus 400 further operable for categorizing transportation and engineering files referenced by initial search results, comprising implementing at least a method for receiving at least a query that maps to objects identifier for transportation and engineering topics. The virtual network further comprises interactive collaboration within a secure science, engineering, and transportation reference document. The virtual network further comprises a server-based social network operable for community distribution of knowledge. The network is configured with a document management system comprising a server database that includes at least a professional functionality and a plurality of interactive functionalities.

Scientists, engineers, and transportation personnel may assemble into the network through the social platform. Interactive functionalities include allowing networks of scientists, engineers, students, universities, and transportation personnel to share knowledge and documents in a remote secured environment. Disclosed embodiments provide the communication apparatus 400 configured with software applications 300, further operable to remotely create, delete, edit and manage science, engineering, and transportation documents and view information about the documents in a plurality of customized locations. Certain embodiments provide the communication apparatus 400 further comprising at least a neural network 220 in communications with at least a cache engine 350 being operable for responding to at least a transportation and engineering topic request using server response data that is cached at a network operable with at least a programmable architecture 424.

Disclosed embodiments provide the programmable architecture 424 being configured with at least one dedicated processing element 423. Certain embodiments further provide the cache engine 350 in communication with cache database 133. Some embodiments provide the search engine 402 in communication with the cache engine 350 configured for applications that include internet 370. Other embodiments provide the search engine 402 in communication with at least a crawler 174 and an index database 132. Disclosed embodiments further provide the communication apparatus 400 comprising a display adaptor 59 operable for communications with fleet STEMS, corporations 200, transportation industries 100, web file modules 401, and client interface 172.

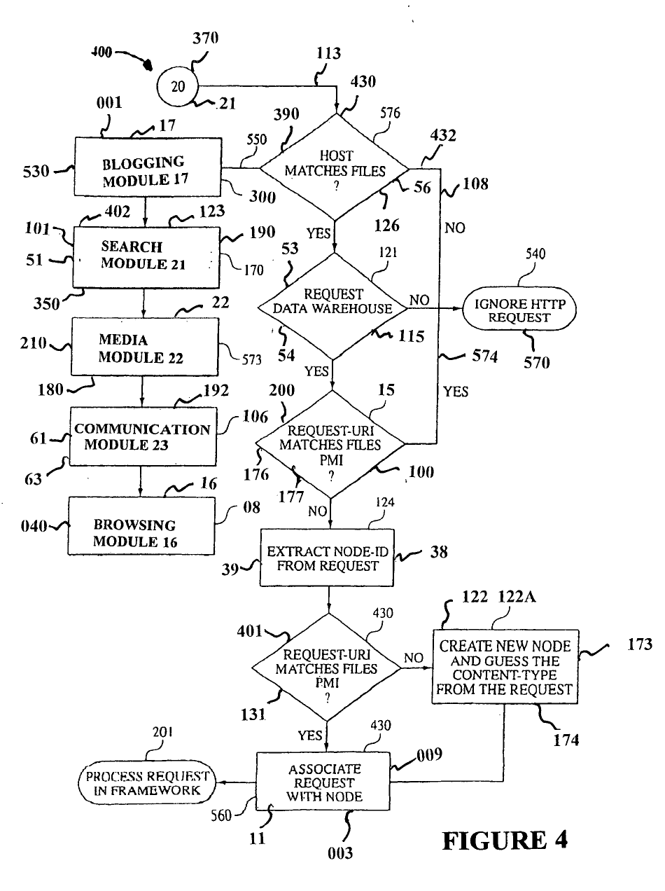

FIG. 4 illustrates a flow chart showing the exemplary process of extracting science, engineering, and transportation topics of information from a database, including communication apparatus 400, comprising a blogging module 17 configured with application session layer 550, software 300, a search module 190 in communication with network interface 170, a media module 22 configured with signal booster chip 573, a communication module 192 in communication with signal booster chip 573 and antenna circuit 106, and a browser module 16 in communication with a readout tool 08. At least a file memory device 53 is provided in communication with the software 300. Disclosed embodiments provide the communication apparatus 400 comprising a data warehouse 121 communicatively connected to the search module 190 configured with a primary memory interface “PMI” 54, in communication with primary programs 15.

Certain embodiments provide the communication apparatus configured with a client identification node “ID NODE” in communication with affinity analyzer 122 and data analyzer 122A. The media module 22 is communicatively connected to media device 201, and the search module is communicatively connected to HTTP report generator 124 in communication with presentation layer 540. Some embodiments provide a computer apparatus 430 configured with a default gateway 432 in communication with a transport layer 560. Certain embodiments provide the communication apparatus being operable on a platform 576 operable for processing mileage, fuel consumption, host files, and science/engineering information. The PMI 54 further comprises at least a content file in communication with at least a subscription identifier 56 being programmable for providing at least a hash table network 176.

Disclosed embodiments provide the hash table network 176 further comprising a decentralized distribution of the structured reference documents consisting of science, engineering, and transportation topics of information. The distribution hash table 177 is operable for providing a lookup network service, providing connections and records including peer to peer network communications for scientists, engineers, and transportation personnel. At least one cache engine 350 is operatively configured with at least one array operable for implementing steps for intercepting science, engineering, and transportation topics at network element comprising one or more science, transportation and/or engineering data packets that at least a client application addressed to a server application.

The search engine may comprise a markup language configured with at least one array for determining at least an application layer message that is contained in at least one portion of at least one data packet for specifying a particular request necessary for entering searchable science, transportation and/or engineering topics of information. The search engine 402 further comprises at least one of: a spider 173, a crawler 174, at least one being operable for disseminating science, transportation and/or engineering topics of information. Embodiments further provide network environment 20 comprising a communication apparatus 400 configured for processing requests in framework, in communication with remote computer systems configured for providing mileage readings and fuel consumptions. The communication apparatus 400 is further configured with search columns 21 and file columns 22.

Certain embodiments provide the communication apparatus 400 configured with column 23 comprising forms 16, preventive maintenance programs “PMI” 15, and host files. Some embodiments provide the communication apparatus 400 configured with an indexer 108 in communication with data warehouse 121, social platform layer 574, and report generator 124. Other embodiments provide the communication apparatus 400 operable for data warehouse requests. The communication apparatus is further configured to associate requests with notes and create new notes if a queried note with an associated name does not exist. In the disclosure, request to URI is compared for matches to files and ignoring an HTTP request may be enabled.

Embodiments may provide an apparatus operable for extracting notes that contain Identifications from request. The network environment comprises the communication apparatus 400 in communication with a computer system comprising a display device 003, a sound card 61, speakers 63, a cache engine 350, a network interface 170, a display adapter 59, intelligence logic, a media device 201, and a central processor 51. The communication apparatus may include an input device comprising at least a keyboard 009 and a mouse 11. The communication apparatus may further include an IC card, SIM card, and interface. The CPU is operable with the intelligence logic to process commands and applications. in communication with memory 53, decision engine 123 and web-enabled devices. The network 21 is responsive to communications through the Internet. Certain embodiments provide a communication apparatus configured with a browser, a server search report 39, and client search programs 38.

Disclosed embodiments further provide a communication apparatus configured with graphic user interface 101 comprising an interactive interface apparatus, a search program manager 126, a browser 040, an ICON 001, and storage medium comprising at least a meta-data and/or a database server 115. At least a web-page manager is provided comprising addresses 131, corporations 200, industries 100, schools and ware houses 121 and a workbench 113 containing science, engineering, and transportation topics of information. The computer system further comprises an affinity analyzer 122, a data analyzer 122A, a readout tool 08, a web-page 390, a report generator 124, files 401, and a client interface being operable with software application 300. At least one application layer 530 message is a java message consisting of transportation and/or engineering topics of information configured for Web based applications.

The search engine 402 further comprises a structured science, transportation and engineering network environment 20 communicatively connected to at least one support system 210 comprising a social platform 573 configured with at least an index and/or a catalog comprising science, transportation and/or engineering data. The data further includes at least one of: parts purchasing, standard maintenance solution, preventive maintenance scheduling. preventive maintenance forms, fuel consumption log, mileage log, solutions to failed components, equipment sales, parts graphics, marketing, name search, sounds, text content files, terrorist name monitoring, video, Internet protocol television 180 comprising a communication system, engineering and/or science materials and/or tools, and at least an advertisement.

Disclosed embodiments provide the communication apparatus 400 comprising at least one software program 300 further configured for communications with at least one support system 210 being responsive to a structured directory of science, transportation and/or engineering topics and providing communications relating to at least science, transportation and/or engineering topics of information in a network infrastructure. At least one support system 210 is further responsive to global communication via Internet 370 for routing the occurrences of science, transportation and/or engineering topics of information. Certain embodiments provide the computer apparatus 430 operatively configured with the software program 300. Some embodiments provide the software program 300 comprising at least a protocol programmed for providing directory approaches to routing science, transportation and/or engineering tonics of information and for analyzing at least an occurrence of the information.

Other embodiments provide the information further comprises keywords that are communicable to prioritize keywords in a list that frequently occur in a set of science, transportation and engineering topics documents. Disclosed embodiments provide the Internet protocol television 180 comprising apparatus for delivering Internet television services consisting of structured science, engineering, and transportation topics of information. At least one protocol is operable for accessing and/or for delivering structured data containing science, transportation and/or engineering topics of information over the Internet 370. At least one computer apparatus 430 is configured to cause a computer device in communication with the cache engine 350, operable to apply integral reference content rate for each science, transportation and engineering topics in at least a set of annotation types. The cache engine 350 is operable for caching data operations being requested from at least one computer apparatus 430.

The computer apparatus 430 is further operatively configured with at least one network data storage medium in communication with at least a network client. The network storage medium comprises a cache memory for caching structural functions and further operable for requesting data structures comprising science, engineering, and transportation topics of information by network clients through the network environment 20. At least one software program is operatively configured with at least one support system 210, further comprising at least a mapping circuit comprising a lookup table which is indexed by a pattern ID value for providing at least one science, transportation and/or engineering topics of information using at least a pattern responsive to at least a potential query of the topics.

Disclosed embodiments further provide the communication apparatus 400 comprising a support system 210 configured with at least a chat function for topics of information comprising at least one of: engineering social network, science and/or engineering project sharing and/or project development, transportation preventive maintenance, transportation services. transportation failure analysis, transportation solution to failed components. transportation fuel consumption, transportation mileage classifications, and transportation vendor's classifications and/or information, transportation equipment sales, parts graphics, marketing, a name search, sounds, text, content file, video, Internet protocol television communication systems, engineering tools, and an advertisement.

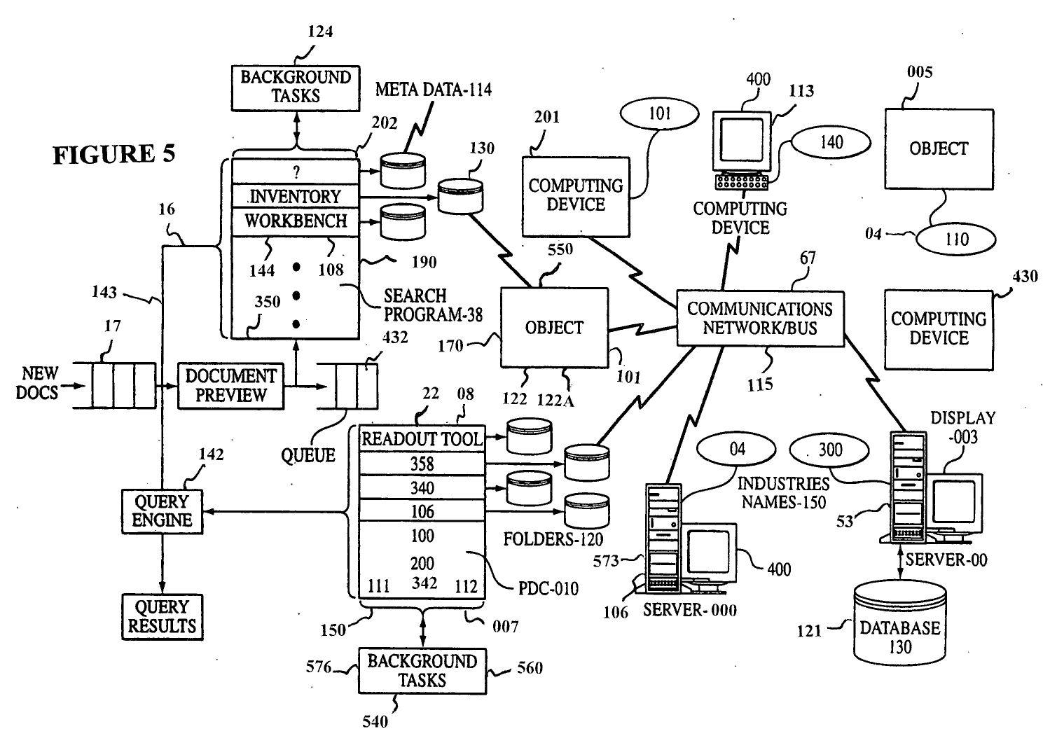

FIG. 5 illustrates an exemplary embodiment of the network in communication with the search engine for routing information in the network and for extracting information from the database, including apparatus 400 comprising a query component configured with an indexer 108 in communication with an index manager 202. Embodiments further provide a network environment comprising a server 000, 000 and a cache engine 350 in communication with functions 143 configured for operations with software 300. The functions 143 further include social platform 573 comprising a social network environment being operable to receive and transmit communications to at least one of: a memory 53, a cabinet 007 comprising a content store for science, engineering, and transportation topics of information.

Disclosed embodiments provide a centralized science, engineering, and transportation network system configured with server 00 and 000 comprising adaptors to maximize productivity and end client longevity. Certain embodiments provide the server adaptor configured to allow end client to end client communication through STESN search engines. Certain embodiments provide communication network systems comprising a bus 67 further configured to periodically provide maintenance in communication with a URL. The URL may be modified at random times by web masters. The communication network bus 67 may be configured to produce a single link that point to a STESN website or its modified website by continuously finding, indexing, and cataloging the web pages. Some embodiments provide password module 140 in communication with the server adaptor software configured to automatically reroute traffic signals when a server port experiences a failure or is disconnected.

Other embodiments provide a query engine 142 in communication with files and forms modules being monitored to allow access to multiple server files containing client data to enable prevention of any loss of information when the hardware experiences a failure. Disclosed embodiments further provide the query engine 142 configured for communications with multiple file storage system being centralized for maximum protection and for providing real time query results. Certain embodiments provide the query engine 142 in communication with communication apparatus 400 further comprising computer apparatus 430 configured with user interface 101 operable for centralized science, engineering, and transportation network systems. Some embodiments provide the communication apparatus further comprises a PDC 010 configured with a switch to connect client systems and servers together to create a client server network within the system and a social environment for communications.

Some embodiments provide the communication apparatus comprising application module 130 in communication with data warehouse 121, folders 120, readout tool 08, search program 38, and document parser 144. The document parser further includes new documents. Disclosed embodiments provide the search program 38 further comprising background tasks. The background tasks may include types of transportation 340, failed components 342, industries 100, corporations 200, industries names 150, government agencies 111, and garages 112. Some embodiments provide the backup storage software being operable for providing backup file scheduling such as tape backups and server file storage backups. The backup storage further allows the centralized science, engineering, and transportation system access to remotely recover any lost file.

Other embodiments provide the communication network bus 67 operable to eliminate single point failure. In the disclosed embodiments, indexer 108 is provided for storing of links pointing to information resources including some or all of the data associated with the information resource, including workbench 113, inventory 114, and term center 115. The query engine 142 further provides objects 110 being stored in graphical hardware 04. The objects are displayable on display devices 003. Certain embodiments provide the communication apparatus comprising a memory consisting of the content store in communication with input devices. Some embodiments provide the content store comprising databases containing topics of information for advancing science, engineering, and transportation knowledge.

The input device is further operable to receive and transmit query, and in communication with listings and/or postings relating to science, engineering, and transportation topics of information. At least a display adaptor may be communicatively connected to the posting and/or the listings. Certain embodiments provide the network environment comprising the communication apparatus 400 further configured with intelligence logic comprising a blogging module 17 configured with the session layer 550 and software 300. Disclosed embodiments provide the communication apparatus 400 further comprising a search module 190 in communication with network interface 170, a media module 22 configured with signal booster chip 573, a communication module 23 in communication with signal booster chip 573 and antenna circuit 106, and a browser module 16 in communication with a readout tool 08. At least a file memory is provided in communication with the software 300. The data warehouse 121 further comprises a database server communicatively connected to the search module 190. The search module 190 is configured with a primary memory interface “PMI” in communication with primary programs 15.

Disclosed embodiments may provide a communication apparatus configured with a client identification node “ID NODE” in communication with affinity analyzer 122 and data analyzer 122A. The media module is communicatively connected to the media device 201. and the search module is communicatively connected to HTTP report generator 124 in communication with presentation layer 540. Some embodiments provide a communication apparatus configured with a default gateway 432 in communication with a transport layer 560. Certain embodiments provide the communication apparatus being operable with means 576 for categorizing science, transportation and engineering files referenced by initial search results. Certain embodiments provide the means 576 for categorizing files further comprising implementing a method for receiving at least a query that maps to object identifiers for science, transportation, and engineering topics.

Some embodiments further provide the means 576 configured with at least a neural network in communications with at least a cache engine operable for responding to science, transportation and engineering topic requests using server response data that is cached at a network. Disclosed embodiments provide the network comprising network elements operable with at least a programmable architecture configured with dedicated processing elements. Certain embodiments provide the communication apparatus communicatively connected to the interactive interface apparatus in communication with a link to a profile being configured for providing network services relating to science, transportation and engineering topics of information.

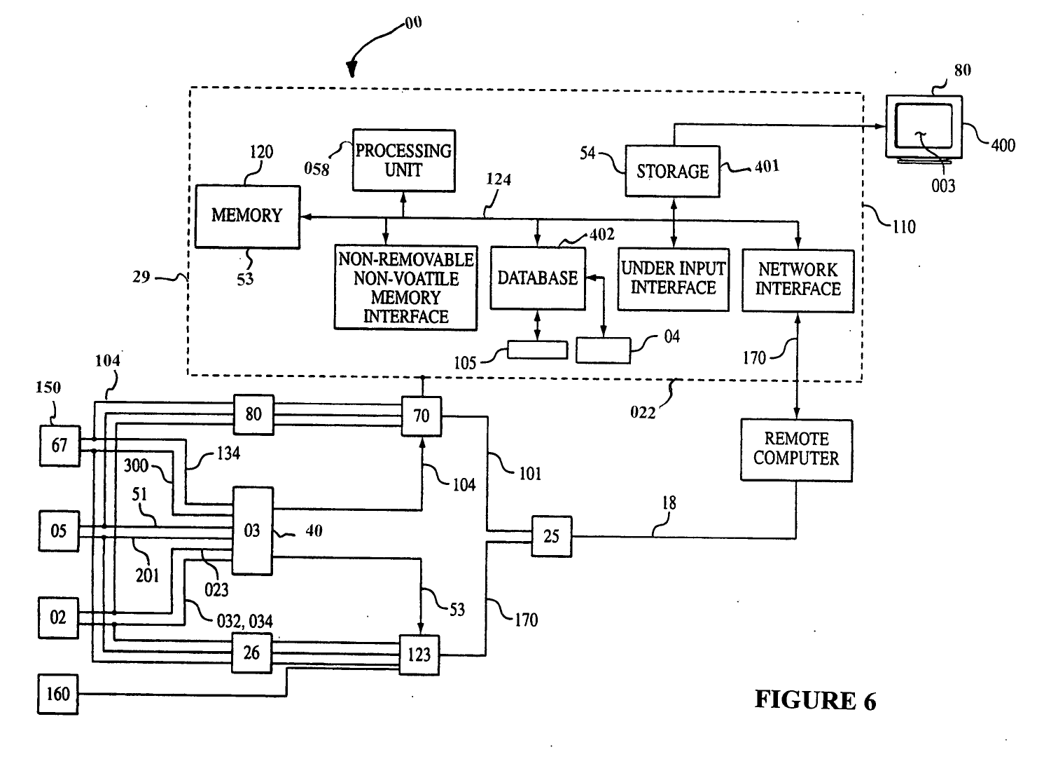

FIG. 6 illustrates an embodiment comprising the process of identifying a pattern from topics of information that have been found in a database, including communication apparatus 400 comprising storage medium 54, central processor 51, and analyzer 122 in communication with memory device 120. Disclosed embodiments further provide a non-removable non-volatile memory interface, a database, input interface and network interface 170. Certain embodiments provide a communication apparatus comprising hardware 105, a graspable hardware/browser 04, and a display device 003. Other embodiments provide the communication apparatus 400 further comprising software 300, central processor 51, a RAM 05, a ROM 02, a network adaptor 160, a router 179 and a media device 201.

Disclosed embodiments further provide a communication apparatus 400 comprising at least an output device 70, a remote computer in communication with a connection key 25. The connection key is further in communication with industrial files 18, network files 110, decision engine 123, graphic user interface 101, sensors 104, and system memory 53. Certain embodiments provide a communication apparatus being further configured with system bus architecture 67 in communication with an input device 80. Some embodiments provide the output device 70 further comprises a report generator 124 in communication with an instruction program 26. At least a CPU 03 is provided in communication with a java class 023, a clickn Vest Servlet class 032, and a Servletrunner application 034. Disclosed embodiments provide the files, forms, and documents further comprising data relating to science, engineering, and transportation topics of information.

The communication apparatus 400 is in a network environment 29, comprising at least a server application 150. The server application 150 further includes at least one of: a registration module, a monitoring module, a trainer module, a communication module, a search module, and/or java application software 023. Certain embodiments provide the java application software 023 in communication with a database server. Disclosed embodiments provide the communication apparatus further comprises ports and/or terminals comprising a network terminal 022 in communication with at least an application. Certain embodiments provide the communication apparatus 400 being turned on by at least a start button in communication with at least a control device 40. Other embodiments provide the control device 40 comprising a wireless device communicatively configured for communications with remote terminals.

Disclosed embodiments further provide a communication apparatus 400 comprising at least one of: report generator module 124, information module 402, retrainer module 058, web-files module 401, a clickn Vest Servlet class 032, a Servletrunner application 034. and/or a decision engine. Certain embodiments provide the communication apparatus further comprises hardware means comprising at least one dedicated processing element configured with an input array, an output array, and a query array. The communication apparatus 400 comprises an interactive interface apparatus communicatively connected to the computer apparatus. The computer apparatus further comprises a data bus comprising a platform for writing input into at least a data memory in communication with the query array.

The communication apparatus further comprises plurality server 00 responsible for some portion of the database server workload. The database server may comprise science, engineering, and transportation files, forms, and documents stored in a distributed file system. Certain embodiments provide the distributed system comprising partitions, providing each individual component of the workload elements of science, engineering, and transportation topics of information being allocated to specific servers. Some embodiments provide a mechanism for copying contents of the application to each of the servers operable for independent applications. Other embodiments provide the contents of each individual component of the server for retrieving and for modifying data relating to science, engineering, and transportation topics.

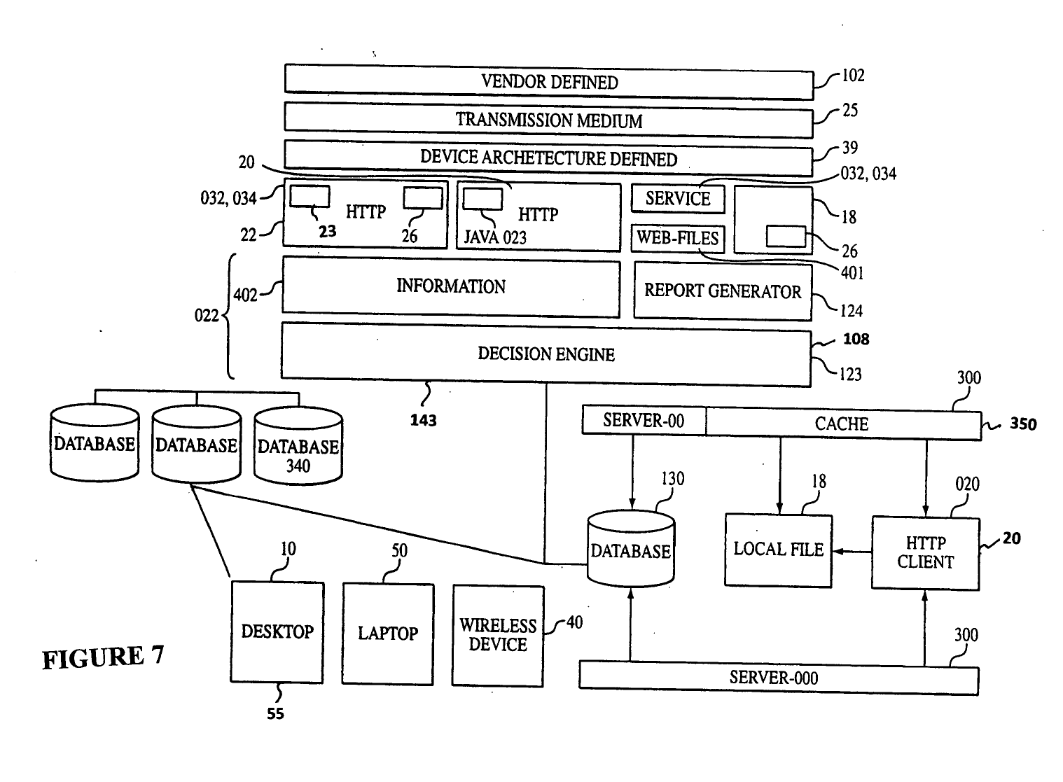

FIG. 7 illustrates a table of initial topics of information to be searched from a database and the process of verifying that a topic of information has been found in the network, including a communication apparatus 400 configured with software 300 in communication with a vendor device 102, operable for outputting topics of information relating to science, engineering, and transportation. The communication apparatus may comprise a transmission medium 25, a computer system 10, a lap top device 50, and a wireless device 40. A decision engine 123 may be provided for adding self-organizing maps for defining the various science, engineering, and transportation topics. The decision engine 123 is configured with Java classes, the JSTAR class 023 and the ClicknVestServlet class 032. The JSTAR Class 023 is a Java class that is also called a JSTAR Java servlet. The JSTAR class 023 is an object-oriented, Java language based application. The communication apparatus may comprise a module for determining that at least a key word maps to an object identifier for science, engineering, and transportation topics of information.

Disclosed embodiments further provide a communication apparatus 400 comprising at least one of: report generator module 124, information module 402, device architecture 39, web-files module 401, a clicknVest Servlet class 032, Servletrunner application 034, and/or a decision engine 123. A network 20 includes network terminal 022 being provided in communication with a query component 23. The query component is configured with an indexer 108 in communication with an index manager 22. Embodiments further provide a network environment comprising a server 00, 000 and a cache engine 350 in associations with functions 143 in communication with software 300. The functions 143 further include a social network environment being operable to receive and transmit communications to at least database 340, 130 and local file 18.

Certain embodiments provide the communication apparatus comprising a memory consisting of the content store in communication with an input device. Some embodiments provide an instruction program 26 in communication with the content store comprising databases containing topics of information for advancing science, engineering, and transportation knowledge. The input device is operable to receive and transmit queries, and in communication with listings and/or postings relating to science, engineering, and transportation topics of information. At least a display adaptor is communicatively connected to the postings and/or the listings. Disclosed embodiments further provide the communication apparatus 400 comprising a desktop computer 10, a network computer 20, a hand held computer 30, wireless devices 40, a laptop computer 50, a gaming device 55, and a server 00. The communication apparatus is provided for network with HTTP client 020.

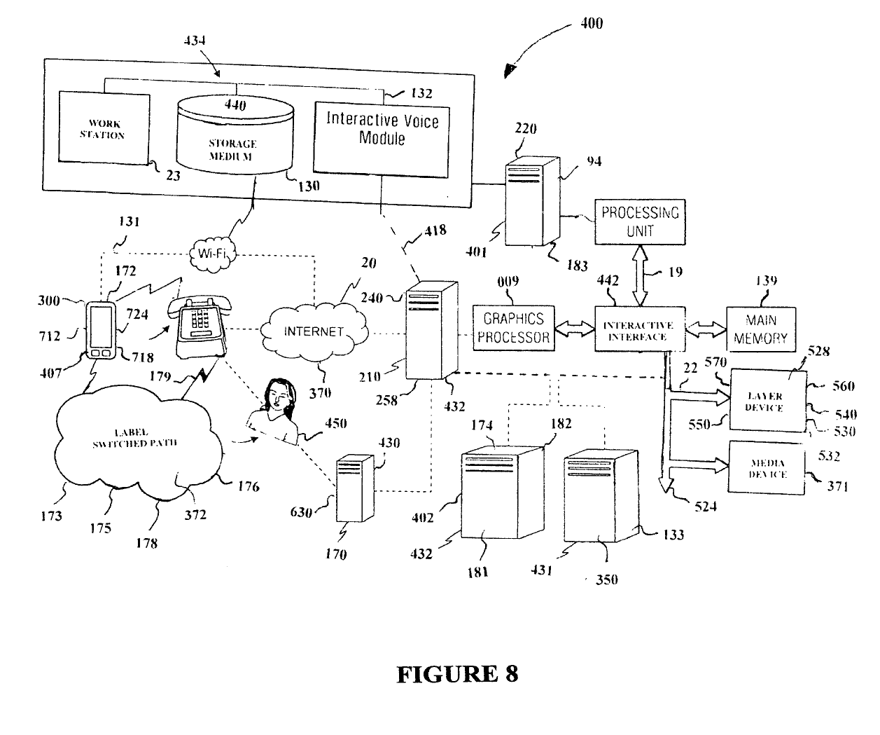

FIG. 8 illustrates a communication apparatus in a network environment, including communication apparatus 400, and client applications 120 coupled to a network 20. The network 20 comprises science, engineering, and transportation network known for effectuation knowledge and communications through the various devices. The network 20 can be a local area network (LAN), a wide area network (WAN), or a combination thereof. It is contemplated that the network 20 may be configured as a public network. such as the Internet, and/or a private network, and may include various topologies and protocols operatively configured for distribution of science, engineering, and transportation topics of information. In accordance with one embodiment, the communication apparatus 400 may be configured with at least one application 130, such as a multi-player online game over the network 20. Furthermore, the applications 130 may be distributed among several servers 00, 000 coupled to the network 20. Thus, the same application 130 is provided to clients 120 by multiple servers 00, 000.

Embodiments may be configured for distributing the applications 130 among servers 00,000 to provide computational workload from clients 120 of science, engineering, and transportation environments to be shared topics of information. Disclosed embodiments provide a communication apparatus 400 operable to adjust the number of servers 00, 000 that a distributed application 130 uses, depending upon the variation in the application's load. Disclosed embodiments may further be employed to control the distribution of science, engineering, and transportation topics workload among the varying set of servers 00, 000 over which the applications 130 are distributed.

Certain embodiments provide the communication apparatus 400 further configured for communications with wireless devices 40. Disclosed embodiments are configured for utilizing key entry as queries to communicate with applications 130 further configured for retrieving the topics of information from the database. At least a client registration module is provided in communication with a client monitoring module. The document management comprises a tool configured to allow scientists, engineers, and transportation personnel to simultaneously view a window having folders for the topics of information and a window having an open document. The open document is shared with a first network 20 and not shared with at least one member who is not a member of the first network. The member may be capable of clicking and dragging an open reference document into one of the folders containing desired communications such that the open referenced document is shared with members of network 21 and is not shared with at least one member who is not a member of the first network 20 or the second network 21. At least one member of the second network 21 is not a member of the first network 20 in the social platform environment. Network 20 and 21 may comprise one or more data links that enable the science, engineering, and transportation reference documents, including desired electronic data between computer systems and other electronic devices.

When information is transferred or provided over the network 20 and/or another communications connection such as hardwired, wireless, or a combination of hardwired or wireless connections to the communication apparatus 400, the communication apparatus 400 properly views the connection as a transmission medium. Transmission media can include the network 20 and/or data links which can be used to carry or transport desired communications codes in the form of computer-executable instructions or data structures and which can be accessed by a general purpose or special purpose remote computer system. The monitoring module responsive to query keys is operable for communication with the communication module.

The communication module may be configured with the research module operable for routing science, engineering, and transportation topics of information from the database to the clients 120. The trainer module 036 is operable to configure to the pattern in which the query key is enabled. Each individual key corresponds to some element of the application workload for science, engineering, and transportation topics relating to searchable topics of information 402 consisting of the aggregations of all possible science, engineering, and transportation topics. Query keys are grouped into key groups or clusters of potentially varying sizes of the topics being handled by server 00 and 000. Disclosed embodiments further provide a communication apparatus 400 comprising at least one of: report generator module 124, information module 402, retrainer module 058, web-files module 401, a clickn Vest Servlet class 032, a Servletrunner application 034, and/or a decision engine 123.

Certain embodiments provide the communication apparatus further comprising hardware means comprising at least one dedicated processing element configured with an input array, an output array, and a query array. The communication apparatus further comprises a decision engine 123 in communication with an interactive interface operable for presenting topics of information, products and/or services for science, engineering and transportation. A decision wizard is provided, comprising a comparative product chart. The decision engine 123 may provide information about the various products or services. The decision engine 123 may present a series of questions to the clients 120 about various science, engineering, and transportation maintenance rundowns and scheduling. Predictive networks and artificial intelligence may be used in the decision engine 123. The decision engine 123 is configured with a report generator 124 in communication with software 300. Disclosed embodiments further provide the communication apparatus 400 in communication with network terminals 022 and/or remote terminals. The server can perform load shedding in accordance with disclosed embodiments by simply modifying one or more groups that it currently manages.

The communication apparatus 400 may comprise virtual private networks 21 configured to deliver broadcasting communications data via Internet Protocol Television edge routers 371 operable on a multi-protocol label switching environment 372. Disclosed embodiments provide the multi-protocol label switching environment 372 operable for sharing multicast state science, transportation and engineering data through a delivery tree comprising at least a server tool 009 in communication with other electronic devices via Internet 370 and/or broadcast channels. The computer apparatus 430 is configured with software program 300 comprising computer instructions in communication with at least an application tool comprising a module 130 operatively configured for delivering broadcast channels via Internet Protocol Television edge routers 371 in communication with the multicast virtual private networks 21. Certain embodiments provide the virtual private network 178 operable for sharing and/or permitting at least a client to access a database 132 comprising structured science, transportation and/or engineering topics of information.

Some embodiments provide the communication apparatus comprising computer readable storage medium 440. The computer readable storage medium 440 comprises computer instructions being further operable for sharing the same multicast state and multicast delivering tree through a centralized transportation engine comprising a search engine 402 being operable for centralizing at least one remote computer apparatus 430 through at least a cable and/or wireless connection. The communication apparatus 400 is further configured for providing at least a physical connection for at least a network infrastructure operable for managing at least one computer device at a remote location. Disclosed embodiments provide at least one interface module 170 operatively configured for network connectivity in communication with network infrastructure 20. At least one network connectivity further comprises communications with at least a remote computer system and the network infrastructure 20 being further operable for disposing at least one of: network management, remote network operation, network client authentication, security, identifications, permissions and/or rights, and for locating a physical address of at least one remote computer within the network 20.

Disclosed embodiments further provide the communication apparatus 400 comprising at least a layer device 530. The layer device 528 may comprise at least one of: a model layer 532 comprising computer instructions operable in multicast virtual private network for providing structured science, transportation and/or engineering network communications, an application layer 530 comprising computer instructions operable in at least a multicast domain tree for providing structured science, transportation and/or engineering application services, a presentation layer 540 comprising a private edge router operable for providing coding to structured science, transportation and/or engineering data, a session layer 550 comprising at least one module operatively configured with at least one interface module 170 operable for broadcasting and/or channeling at least a single communication signal configured for delivering structured science, transportation and/or engineering data to at least an end client, a network layer 570 comprising at least a call signal transmission processing module operable for providing structured science, transportation and/or engineering topics of information via at least an Internet protocol 370, and a transport layer 560 comprising an apparatus operable for providing structured science, transportation and/or engineering topics of information for communication between at least a computer apparatus 430 and at least a gateway/default gateway 432. Certain embodiments provide the communication apparatus 400 further comprising an apparatus for updating connectivity and/or for providing structured science, transportation and/or engineering technical support.

In one embodiment. the network interface module 170 functions at a low level of abstraction to control or respond to I/O devices of the wireless communication device 30 as directed by the client interface module 172 in communication with the central processing unit 51. The network interface module 170 may receive client input such as an input signal resulting from a client using communication apparatus 400, browser 040, or keyboards 11. The network interface module 170 may be configured to convert input to an appropriate signal that may be interpreted by the client interface module 172. The network interface module 170 may also receive signals from the client interface module 172 that specify a particular decision to be rendered on screen 003 and may generate appropriate signals to effectuate the desired science, transportation, and engineering topics decision being displayed.

In another embodiment, the network interface module 170 may assume a larger role and work concurrently with the client interface module 172 for sharing data relating to science, engineering, and transportation topics of information. In yet another embodiment, the client interface module 172 may be merged with the network interface module 170 through a common network 20, including the Internet 370. Disclosed embodiments further provide a central communication vehicle comprising Internet search engine 402 being provided for communications with personal communicators, wireless communication devices, lap tops, media devices, gaming devices, television set apparatus, desk tops, and mobile devices.

Certain embodiments provide the wireless communication device 30 being implemented as part of a personal computer device. Some embodiments provide the application layer 530 being configured with keyboard 11 and/or voice auditory applications. Some embodiments provide servers 00 and 000 further comprising wired and/or wireless communication device and/or a remote server. Disclosed embodiments provide the client interface module 172 further comprising mobile devices. Certain embodiments provide the network interface module 170 being configured to create, select, arrange, and administer to the screen the topics of information in collaboration with client interface module 172 comprising sharing of tasks to render results relating to searches for science, engineering, and transportation topics of information. Each search result corresponding to science, engineering, and transportation topics may be translated to electronic documents such as web pages, and advertisements responsive to queries relevant to science, engineering, and transportation topics of information.

Disclosed embodiments provide the communication apparatus 400 comprising a browser 040 configured with a variety of algorithms for choosing a candidate key group of science, engineering, and transportation topics. In one embodiment, the server keeps track of the science, engineering, and transportation topics associated with each individual key group that is managed. Certain embodiments provide counters and/or monitors comprising a display 003 being operable for independently tracking the application activity in each of the key groups. Some embodiments provide the servers 00 and 000 operable for selecting the key group that is contributing the maximum science. engineering. and transportation topics load.

The communication apparatus 400 may be configured to provide client interface 170 for a mobile device 30. The communication apparatus 400 further includes a cellular telephone 30 for communicating between the servers 00 and 000 and client 120. The client 120 further comprises a PDA, a personal computer, and a personal communication device. Certain embodiments provide a display screen that can be programmed to display any appropriate information to client 120 in communication with the communication apparatus 400. Some embodiments provide the communication apparatus 400 operable for displaying information related to Internet 370 searching applications that consist of science, engineering, and transportation topics of information. Certain embodiments provide a support system 210 comprising a social platform 420. The social platform 420 is configured with a search button for searching science, engineering, and transportation topics.

Some embodiments provide the social platform 420 comprising a social network for sharing knowledge and for searching science, engineering, and transportation topics of information. At least a search engine 402 is provided for searching science, engineering, and transportation topics. The search engine 402 may be communicatively connected to at least a cellular tower. The query keys comprise data entry keys used to enter information such as alphanumeric characters, and may take the form of a standard telephone keypad. J

Other disclosed embodiments provide the communication apparatus 400 configured for alphanumeric information and voice recognition operation. The communication apparatus 400 further comprises a data processing system comprising a central processor 51, servers 00 and 000, and a network 20. The client 120 is connected to the data processing system through the servers 00 and 000 each coupled to the network 20. The client 120 may communicate wirelessly with the network 20, such as over a cellular telephone network. The network 20 further comprises a local area network (LAN) or a wide area network (WAN), including the Internet 370. The servers 00 and 000 may include content servers that store collections of documents such as web pages, advertisement servers, and science, engineering, and transportation services such as text-only ads, image ads, graphical ads, audio clips, and video ad-clips.

The servers may include e-mail servers that provide email functionality to client devices 120 and embedded information, including machine-executable code or links to other documents. The servers 00 and 000 may store electronic content in electronic documents written in EHTML (Extensible Hypertext Markup Language), HTML (Hypertext Markup Language), WML (Wireless Markup Language), CHTML (compact HTML), or in any other appropriate format. The data processing system may take any applicable form and may receive information requests from client 120. Disclosed embodiments provide the data processing system configured for locating suitable information corresponding to a query request.

Certain embodiments provide the data processing system operable for formatting the information received for presentation on the display 003 and may convey the formatted information to the client 120. The data processing system further comprises interactive interface module 172 operable to permit communications in a variety of ways. Some embodiments provide the data processing system in communication with the servers 00 and 000 over the network 20. In the disclosure, embodiments provide the data processing system further operable to access and process electronic content that is stored on the servers 00 and 000. The data processing system is further configured for communications with the client 120 via the network 20, including the cellular phone network or a combination of networks. A report generator 134 may receive and process a request from the client 120, such as a network search request. The network search request may include one or more search query terms entered by a client 120 in search input device 80.

A search engine 402 may then receive the search request from the report generator 134 and may search a searchable indexer 108 for electronic content appropriate for or corresponding to the search request. The indexer 108 may include an index database 130 in communication with a cache engine 350 in communication with a cached information database. The index database 130 may contain data representing searchable information available to the CPU 51. The CPU 51 may scan the Internet 370 or various intranets for content science, engineering, and transportation topics, web sites, workgroup discussions, technical books, electronic books, etc. The CPU 51 may extract key words, phrases, or other objects from the content, and may organize the information in the index database 130, or partition the database 130 in a manner that allows ready searching.

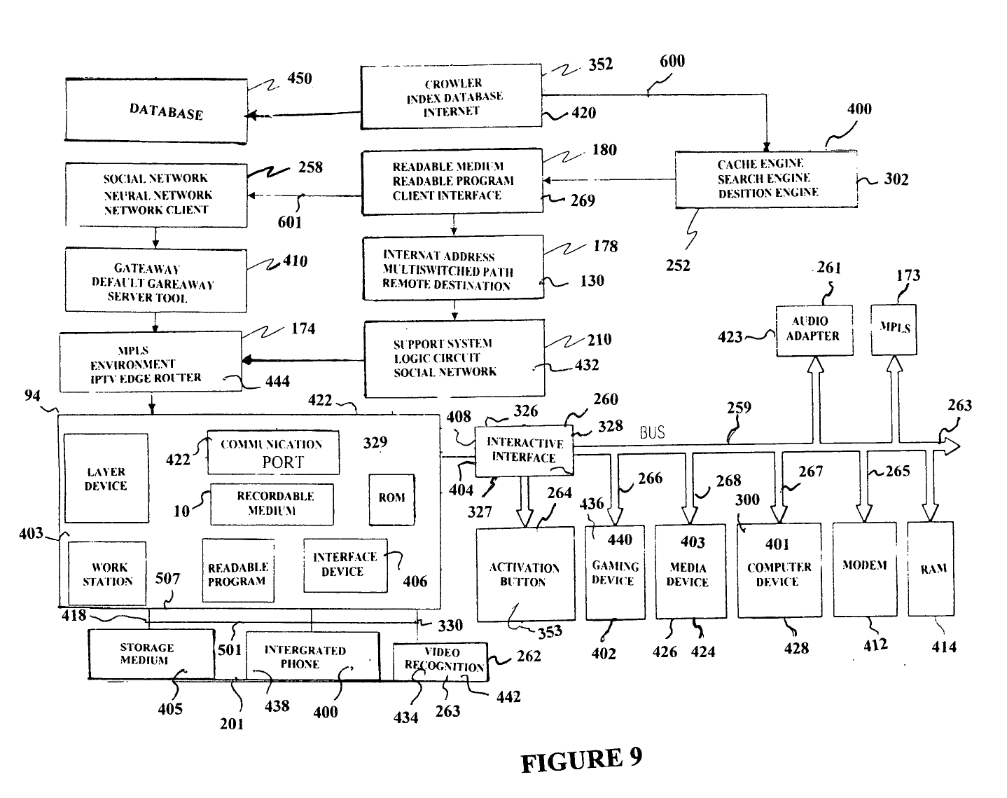

FIG. 9 illustrates the communication apparatus in a structured environment, including communication apparatus 400 comprising an input device 252, and including a keyboard 254. The keyboard 254 may consist of a virtual keyboard 255 and/or QWERTY keyboard 256 in further communication with a random number generator 248. At least a social network application 258 is configured with the keyboard and in communication with the processor 420. Disclosed embodiments further provide the keyboard being disposed on an LCD display screen 260 being configured with sensors 327 operable for object recognition. Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265 and camera 263.

Disclosed embodiments provide the communication apparatus further comprising at least one of: a mobile communication device 400, a gaming device 402, a media device 403 and an interface device 404. Disclosed embodiments provide the interface device comprising at least an integrated phone/PDA 400 being configured with integrated connectivity apparatus 406 operable to provide global roaming. At least a communication port 422 is provided with the communication apparatus 400. Certain embodiments of the disclosure provide the communication apparatus comprising a GSM phone 400 being operable on plurality microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video, and phone book.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still. other embodiments provide a communication apparatus comprising of carbon fiber 408 and/or silicon substrate microfiber consisting of resistive touch screen 260 and/or character recognition 269 and/or a communication board 300. Certain embodiments provide housing 301 for the communication apparatus 400 comprising a carbon fiber 408 and/or a silicon microfiber.

Disclosed embodiments further provide a communication apparatus being configured with at least a WAP browser 410 and/or an integrated GPS device 412 and/or an MP3 music device 414 and/or a camera apparatus 416 and/or an internal antenna apparatus 418 being configured with a controller 421 in communication with a predictive text messaging application 423. Certain embodiments provide the communication apparatus 400 being configured with at least one of: infrared sensor 326, calendar 268, F.M. radio 424, Bluetooth technology 426, and GPRS Internet services 428. Disclosed embodiments further provide the communication apparatus 400 comprising a video poker machine 430 and/or a slot machine 432 and/or a handheld device 434 and/or a gaming device 436 and/or a play station 438 in communication with communication port 422.

Some embodiments provide the cache engine 350 further comprising at least a data structure pointer generator circuit 352 operable for generating information that correspond to at least a matching trigger pattern being communicable for providing at least communication patterns for science, transportation and/or engineering topics, comprising at least a structured science, transportation and/or engineering expressions. At least one science, transportation, and/or engineering expression is configured with computable functions. At least one communication pattern comprises at least one of: a context free grammar, at least a text expression comprising at least a make and/or at least a model of a transportation vehicle, at least a text expression comprising desired science, transportation and/or engineering topics, and at least a text expression comprising science, transportation and/or engineering topics of information.

The communication apparatus 400 may be configured for verifying if additional science, transportation and/or engineering topics of information match a predetermined number of patterns, wherein the predetermined number of patterns is greater than at least 1, and wherein the additional topics are rejected if they do not match the predetermined number of patterns. Disclosed embodiments provide the communication apparatus 400 comprising at least one coordinated set of programs each functionally structured for communications with the computer readable medium 440 operable for delivering science, transportation and engineering topics through at least a broadcast channel comprising Internet Protocol Television edge routers 370 being further operable for providing continuous distribution of science, transportation and/or engineering knowledge and/or for providing national security applications.

Certain embodiments provide the communication apparatus further comprising at least one cache memory 354 being operatively configured with at least one computer readable program 434. Some embodiments provide the cache memory 354 comprising a computer code consisting of science, transportation and/or engineering topics of information. Some embodiments provide the communication apparatus 400 comprising a communication engine 402 configured with each cache memory 354 and responsive to queries. The queries may comprise at least one of: science and engineering topics, a transportation and/or engineering vendor, a transportation and/or engineering provider, a person, a transportation and/or engineering company, a transportation make, a transportation model, a motor carrier contents, at least an educational institution program and/or curriculum, at least an engineering network, at least a support system comprising a social platform for communicating science, engineering, and transportation topics, and at least a network client location.

Disclosed embodiments further provide a communication apparatus configured for categorizing science, transportation and/or engineering files referenced by initial search results. The communication apparatus may comprise at least a data modeling tool 100 responsive to categorization. Certain embodiments provide the data modeling tool 100 configured for manipulating icons within at least a graphic interface module 170 being executable on at least a structured science, transportation and/or engineering network infrastructure. Some embodiments provide a neural network 220 configured with the data modeling tool 100 and operable for deleting and/or updating at least a structured science, transportation and/or engineering database. At least one data modeling tool is communicatively connected to at least one array operable for Web browsing. At least one neural network 220 further configured with a decision engine 123 responsive to science, transportation and/or engineering topics of information. Disclosed embodiments provide the neural network 220 further configured with at least one cache engine 350, further responsive to at least a downloadable science, transportation and/or engineering context.

Certain embodiments provide the computer readable program 434 in communication with the neutral networks 220. The at least one computer readable program 434 further comprising at least a software 300 operable with computer instructions programmed for at least one of: delivering broadcast channel through Internet Protocol Television edge routers, using multicast virtual private networks for at least a broadcast channels, applying at least a multicast label switching protocol to at least one virtual private networks, sharing the same multicast state and providing at least one broadcast channels in communication with each virtual private networks, training each neural network 220 for adjusting at least a correlation of science, engineering, and transportation topics as a function of an activity consisting of at least a topic and/or a product of science, transportation and/or engineering content.

The communication apparatus 400 may comprise a computer apparatus 430 comprising a search engine 402 communicatively connected to at least one remote communication apparatus operatively configured with at least one support system 210. At least one neural network 220 in communication with the search engine 402 and operable for providing services relating to science, transportation and/or engineering in a social network platform 102. The social network platform is operable on at least a social platform 420 comprising at least a button configured for providing a social network environment for at least one of: educational institutions, transportation companies and/or agencies, and science/engineering institutions and/or companies in association with each other. At least one support system 210 comprises at least one social platform 573 being provided for connecting science and engineering students and/or engineering professionals via a centralized network environment such as the Internet.

Disclosed embodiments further provide the support system 210 operatively configured for project postings responsive to university courses for science and engineering students and/or responsive to jobs and/or project postings from at least an engineering company and/or science/engineering professional environment. The science and engineering professional environment further comprises an environment for students and/or engineering professionals to be socially and/or educationally engaged in research projects in association with at least one of plurality universities and/or remote location, whereby at least a centralized communication is provided through the support system 210. The support system 210 is operatively configured for science, engineering, and transportation social networks, and further comprises at least a chat function 104 responsive to at least the social communication environment 106.

Other embodiments provide centralized transportation vehicle in communication with computer devices operable to receive specific science, engineering, and transportation topics, services and/or functions. Certain embodiments are directed towards a distributed server-based application model comprising varying set of server applications configured for individual client application for communications with client devices being communicatively connected to the communication apparatus to receive and/or share science, engineering, and transportation data over a conventional communications infrastructure such as the web. Embodiments provide the communication apparatus comprising servers communicatively configured to provide one or more computer-related services relating to science, engineering, and transportation topics of information.

Disclosed embodiments provide a mechanism for distributing science, engineering, and transportation topics and knowledge using protocol to negotiate with database servers containing the science, engineering and transportation topics of information. The communication apparatus 400 further comprises applications being characterized by rapidly varying changing components of a database server 121 comprising topics of information warehouse. Disclosed embodiments further provide the database server 121 comprising components of the science, engineering, and transportation content being stored, and logically configured for predictions of the client query or loads. The interactive device may include a data bus 200 comprising a platform for writing input into a data memory for at least one array to enable enhancement of continued proliferation of powerful and suitable science, engineering, and transportation topics operation.

Certain embodiments provide the interactive device configured for allowing computational devices to talk to each other through the use of networks connections. The computational devices include computers and other portable devices such as wireless telephones, mega telecommunications, personal digital assistants, automobile-based computers, electronic devices, and portable devices. The networks connecting computational devices for the instant invention include wireless and wired networks which are formed using land lines such as copper wire or fiber optic cable and wireless networks which employ earth and/or satellite-based wireless transmission links and a combination of wired and wireless network portions. These networks are organized using a client/server architecture 110 in which server computational devices manage science, engineering, and transportation operational resources such as preventive maintenance files, solutions to failed transportation component, fuel consumption per vehicle in a fleet, computational transportation devices processing power which could be requested by client computational devices such as clients of the network.

In this regard other computational devices not operated directly by an end client such as at least proxy servers, which act on behalf of other machines could represent either clients or servers. Disclosed embodiments provide a computer apparatus 430 comprising techniques for extracting science, engineering. and transportation topics of information through search patterns from a database such as the Web. Certain embodiments provide the techniques comprising one or more topics of information that act as the initial seed for the search. Some embodiments provide the database or databases comprising a searchable medium for occurrences of the topics of information.

Other embodiments provide the technique comprising of patterns being identified in the array in which they are stored. These patterns are used to extract more topics from the database and the process can be repeated for new topics. Information can be extracted from a database efficiently and accurately with little or no human interaction. Disclosed embodiments further provide a computer implemented method of extracting information from a database. Certain embodiments provide the database being searched for occurrences of at least one topic of information. Some embodiments provide the occurrence of topics of information comprises the information that was found is analyzed to identify a pattern in which a similar topic of information was stored. Other embodiments provide the topics of information being extracted from the database utilizing the pattern. In some embodiments, the process is repeated until a predetermined number of topics are found or until no new patterns are identified.

Disclosed embodiments provide a computer implemented method of extracting science, engineering and transportation topics of information from a database. The database is searched for occurrences of topics of information. Occurrences of the topics of information found are analyzed to identify a pattern in which the topics of information were stored. Certain embodiments provide the pattern comprising prefix text, a middle text and suffix text, where the prefix text precedes desired information in the science, engineering and transportation topics of information and the middle text is between desired information in the topics of information and the suffix text follows desired information in the topics of information.

Additional topics of information are extracted from the database utilizing the pattern and the process is repeated for additional topics of information. The terminal 022 may be connected between clients 120 and distributed for communications with servers 00 and 000 through a location-based distributed system. Servers 00 and 000 are configured with key to encode a particular location in a hierarchical grid comprising science, engineering and transportation topics.

The topics are distributed among the constituent database servers on the basis of the location regions that each server manages. The database servers are partitioned for science, engineering, and transportation topics for communications among the constituent servers. Each server is configured to manage different science, engineering and transportation topics and/or partitions for distribution efficiency. At least larger clusters are broken down into smaller clusters comprising smaller key groups of science, engineering, and transportation topics of information for logical representation of splitting process through binary tree.

Disclosed embodiments further provide the servers 00 and 000 configured for receiving a topic request specifying a particular key group combination that determines if a query should be processed. Certain embodiments provide logical steps needed to respond to the query in case the server 00 and 000 determines that the key group combination is incorrect or that the query should be communicated to an alternate server. The communication apparatus 400 is disposed for detailing the steps a client is seeking to determine the appropriate server for a particular key group.

The communication apparatus 400 may be configured for adaptive load distribution techniques based on the representation of science, engineering and transportation topics with a distributed hash table. The document management tool may comprise an information processing apparatus communicatively connected to the memory device 59 for storing digital broadcast content of the reference document for which a number of copies can be made, and include a writing device for writing the content on external recording medium in communication with an IC medium reader/writer for reading an IC medium and recording the number of copies that can be made of the content on the IC medium in association with the document identifier.

The communication apparatus 400 is further configured for determining whether an identifier of the content is recorded on the IC medium when the content is copied to the external recording medium and when it is determined that the identifier is recorded, the hash table controls the writing device to write the content on external recording medium and to update the number of copies that can be made of the content and a hash value is recorded in the memory. In the disclosed embodiments, key groups of science, engineering and transportation topics are associated with a variable depth of topics of information based on a virtual network. The network is provided for directing identifiers containing queried science, engineering, and transportation topics to a particular key group server comprising target servers 00 and 000. The servers 00 and 000 may be operable to exchange local signaling messages to determine the particular topics of information that are being queried in relation to science, engineering, and transportation topics.

Disclosed embodiments provide servers 00 and 000 comprising a child server configured for exchanging load information from a communication apparatus 400 operable for managing an active key group of science, engineering, and transportation topics. Certain embodiments provide a parent server 00 and 000 comprising a communication apparatus 400 operable to split larger key groups of science, engineering and transportation topics into smaller clusters. Some embodiments provide the parent server 00 and 000 comprising a communication apparatus configured for instructing the child servers for communications with clients 120 and the parent server.

It is contemplated that the mapping of science, engineering and transportation topics include partitions responsive to query keys in accordance with disclosed embodiments. Science, engineering, and transportation topics partitioning are represented by the allocation of variable-sized key groups to individual servers 00 and 000. The affinity analyzer 122 could represent an encoding of one or more application-specific science, engineering and transportation attributes on the basis of which the science, engineering and transportation topics are partitioned. It is further contemplated that affinity analyzer 122 could represent an arbitrary mapping that has a relation to any semantically relevant science, engineering, and transportation attributes. Disclosed embodiments may be applied to any form of encoding relating to science, engineering, and transportation topics for communications with the affinity analyzer 122. Disclosed embodiments further provide optional data analyzer 122A configured for operation with computer language consisting of binary keys. Certain embodiments provide the binary keys comprising the smallest unit of application of science, engineering, and transportation topics to be presented for distributions.

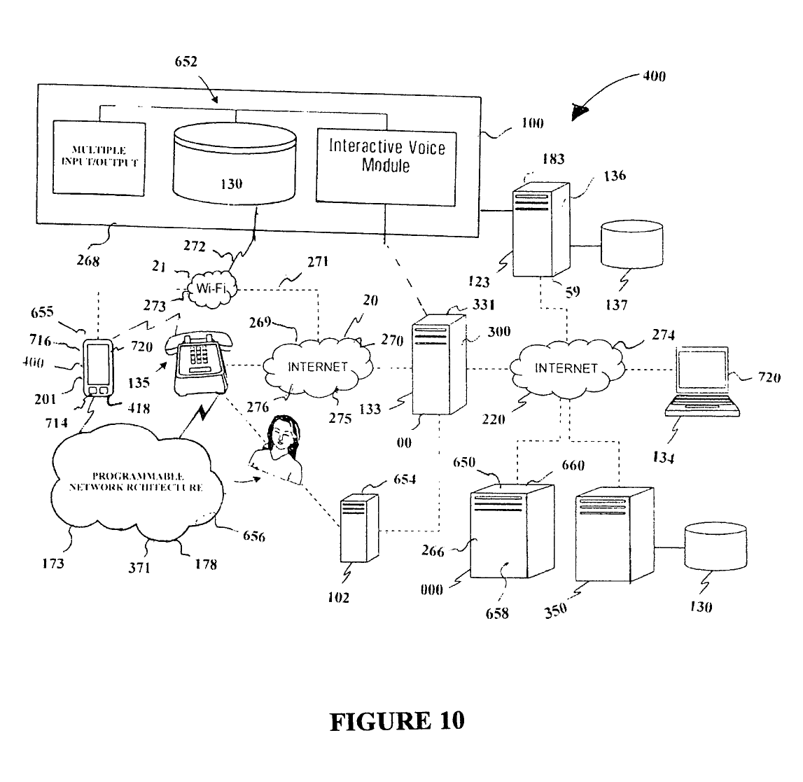

FIG. 10 illustrates a communication apparatus in a network environment, including communication apparatus 400 configured for optimizing and for sharing science, engineering, and transportation topics of information. Certain embodiments provide the communication apparatus 400 comprising at least a cache engine 350 operatively configured with at least one array 182, 184 and 186. The cache engine 350 further comprises at least a markup language configured with at least one array 182, 184 and 186 for entering searchable science, engineering and transportation topics of information. Some embodiments provide the computer apparatus 430 further comprising a spider 173, and/or a crawler 174, each configured for disseminating science, engineering and transportation topics of information. Disclosed embodiments further provide a web configured for disseminating science, transportation and/or engineering topics of information.

Certain embodiments provide the centralized transportation search vehicle further comprising a structured science, transportation and engineering network environment communicatively connected to at least one support system 210. The support system 210 is further configured with at least the indexer 108 and/or a catalog 201 comprising science, transportation and/or engineering data. Some embodiments provide the data further includes at least one of: parts purchasing, science and engineering assignments, science and engineering research environment, standard maintenance solution, preventive maintenance scheduling, preventive maintenance forms, fuel consumption logs, mileage logs, solutions to failed components, equipment sales, parts graphics, marketing, name searches, sounds, text, video, engineering and/or science topics of information, engineering materials and/or tools, and at least an advertisement.

Disclosed embodiments further provide a centralized transportation vehicle comprising a search engine system 402 that includes entity extractor 112, a categorizer 114, and a query generator 116 for managing and sharing science, engineering, and transportation activities such that when a topic on science, engineering and transportation information is queried, responses are retrieved to enrich knowledge, transportation preventive maintenance scheduling, generating solutions to a queried transportation component failure, extracting names of terrorists desiring a rental car, and analyzing failed transportation components through a centralized database server 121. The search engine system 402 further comprises a communication apparatus comprising at least a hardware device 04. Some embodiments provide the hardware device 04 comprising at least one dedicated processing elements 118 configured with at least an input array 182, at least an output array 184 and/or at least a query array 186.

Certain embodiments provide the entity extractor 112, configured to identify a set of entities as described in the engineering, science and transportation topic of information through selected files, forms or document content for enabling searching the information related thereto using an information retrieval system 185. Disclosed embodiments further provide the categorizer 114 operable to define an organized classification of the science, engineering and transportation files, forms, or document content with each class in the organization of component content having associated therewith a classification label 187. In the disclosure, the classification label 187 corresponds to a category of topics of science, engineering and transportation information in the information retrieval system 185. The categorizer 114 is further configured to assign the selected science, engineering, and transportation files, forms or document content a classification label 187 from the organized classification of science, engineering and transportation component content.

Some embodiments provide the query generator 116 being operatively configured to automatically formulate a query that restricts a search for science, engineering and transportation topics of information. The search could be restricted at the information retrieval system for the particular information concerning the set of entities to the category of science, engineering and transportation topics of information in the information retrieval system 185 being identified by the assigned classification label 187. The classification label 187 is configured to enable speedy responses to information from the centralized transportation vehicle. The centralized transportation vehicle is in communication with a computer apparatus 430 comprising at least a database 340 consisting of at least information for science, engineering and transportation topics.

Disclosed embodiments further relates to science and engineering topics management and sharing of science, engineering and transportation topics of information through networks of computational devices, and more particularly to database system 340 operable for generating requests of science, engineering and transportation information, providing at least one topic of information as an example of information associated with at least a terrorist name in a local existing system 432 desiring a rental car, engineering topics, and transportation topics, and retrieving responses in association with the name, the engineering topics, and the transportation topics of information such that enhancement of identification of relevant topics of information relating to the terrorist person 434 is made accessible using such the network 20. The network 20 is further utilized for repeating the searching and analyzing and extracting data for additional topics of information that are desired in association with the terrorist person 434. The desired topics of information are further provided for tracking the last rental company and/or transportation information by the named terrorist person 434 within the centralized communication system 400. Certain embodiments provide the centralized transportation communication vehicle 400 further comprising Standard Transportation Engineering Social Network “STESN.”

Other embodiments provide the centralized transportation vehicle comprising interactive interface device 170 communicatively connected to at least the computer apparatus 430. The interactive interface device 170 further comprises at least a data bus 200 comprising a platform for writing input into at least a data memory 440 for at least an array 182, 184 and 186 to enable enhancement of continued proliferation of powerful and suitable science, engineering, and transportation topics operation. Certain embodiments provide the interactive device 170 configured for allowing computational devices to talk to each other through the use of network connections 131.

Some embodiments provide the communication apparatus 400 comprising computational devices, including computers and other portable devices such as wireless telephones, mega telecommunication, personal digital assistants, automobile-based computers, electronic devices and portable devices. The networks connecting computational devices for disclosed embodiments include wireless and wired networks which are formed using land lines such as copper wire or fiber optic cable and wireless networks which employ earth and/or satellite-based wireless transmission links and a combination of wired and wireless network portions 20 and 21.

These networks are organized using a client/server architecture in which server computational devices manage science, engineering and transportation operational resources such as science topics, engineering topics, preventive maintenance files, solutions to failed transportation components, fuel consumption per vehicle in a fleet, computational transportation devices processing power which could be requested by client computational devices such as clients of the network (i.e., other computational devices not operated directly by an end client such as at least proxy servers, which act on behalf of other machines, and could represent either clients or servers).

The centralized transportation communication vehicle comprises a platform for advancing science; transportation and engineering knowledge, including a social network for enabling scientists, engineers and transportation industries, garages, transportation maintenance fleets, government agencies, police departments, fire departments, and Homeland security departments to talk to each other seamlessly in real time through a centralized system. Certain embodiments provide the search engine 402 configured for extracting science, engineering and transportation topics of information from a centralized transportation database having information relating to science topics, engineering topics and different makes and models of transport vehicles. Some embodiments provide the search engine comprising a computer apparatus 430 configured for enabling communication with different systems and responsive to different platforms.

Other embodiments provide the communication apparatus 400 operable for enabling Internet and web-based searches for topics of information relating specifically to science and engineering topics and any make and model of transportation equipment, including identifying preventive maintenance and repair patterns of particular equipment in which the topics were stored so that additional topics can be extracted from the database 340 for social network, knowledge sharing, and for aiding file sharing within various science/engineering companies, transportation companies, and for mining terrorist data within the centralized transportation database 340. The disclosure further provide a neural network 220 that integrates seamlessly with all existing science and engineering industries, and transportation industries, including car rental companies and garages through existing systems 432 and enabling these existing systems to talk to each other and communicate better in real time interaction, real responsive, real resourceful and real responsible to transportation system analysis, preventive maintenance scheduling and reprogramming, and monitoring of a terrorist person's activities through at least a name search.

STESN may comprise a science and engineering social network and web-service application consisting of virtual science, engineering and transportation business analytical tool 08. The tool includes portfolios for science, engineering and transportation company's preventive maintenance programs and further comprises an online market place for transportation parts and research distributions. Engineering professionals may utilize this network to assign research projects, assist on projects, and post jobs. STESN websites may comprise virtual science, engineering, and transportation businesses. The web plan includes search engines comprising computers, devices, communication apparatus, and browsers. The system is configured with a support system 210 for engineering social network, making it easier for people to meet for personal science and engineering topics benefits.

Disclosed embodiments provide the support system 210 communicatively connected to computer devices. The computer devices are operatively configured with communication apparatus, which include Internet 370 and gateway 433. The communication apparatus is communicatively connected to an interface comprising network I/O 252. Software 300, comprising an operating system is configured with the communication apparatus. The computer device further comprises databases comprising science, engineering and transportation topics of information. The browser 040 is communicatively connected to the operating system, which is communicatively connected to the network I/O 252 which connects to the gateway 433.

Certain embodiments provide a cache engine 350 communicatively connected to the communication apparatus 400. Some embodiments provide the cache engine comprising a query engine 142 in association with a makeup language for searching science and engineering topics of information. The query engine further comprises apparatus for searching and/or entering science, engineering and transportation topics of information. The spider 173 and crawler 174 are further provided for disseminating the topics of information. The support system 210 is configured for social networks and further comprises structured functions, including chat functions 104. The computer device further comprises server 00 and 000 configured with the software 300 for enabling a server tool to communicate with other electronic devices through the Internet 370. Certain embodiments provide application tool 130 operable for permitting a client to access the database 340.

Some embodiments provide a model layer 532 operable for enabling network communications, and a presentation layer 540 for coding data. Science, engineering, and transportation files are requested from server computers 00 and 000 or “web servers 24”. The transmission of the files over the web comprises additional Internet protocol 371 called hypertext transfer protocol (HTTP). Disclosed embodiments provide the communication apparatus comprising the Internet 370 substantially free of central organization.

Certain embodiments provide the server 00 and 000 further configured for hosting web page 25 for the centralized transportation system comprising of science, engineering and transportation topics. Some embodiments provide the web page 25 being connected to the Internet 370 and the science, engineering and transportation topics of information being routed by the search engine 402 to the database server 121 for retrieval of information specific to the queried topics of information from the database 340.

The centralized transportation system may be configured to enable decentralization of science, engineering and transportation topics of information and also to allow extremely wide access and an ever-increasing variety of science and engineering topics and availability of information relating to various transportation vehicles by identifying and locating specific pieces of information on a specific topic such as vehicle component failure on a particular brand of vehicle that can be extremely difficult to diagnose.

Generally, a database system 340 is developed for communication with search engines 402 and other directories operable for routing science, engineering and transportation topics of information to and from the server 121 containing the database 340 developed to aid clients 120 in finding specific types of information unique to science, engineering and transportation vehicles. The database system typically contains entry for web pages in association with science, engineering and transportation files, forms or documents. The database 340 is searchable relatively quickly without any intervention or the need to retrieve actual web pages in order to perform a search.

The communication apparatus 400 is further configured with an entry 26 for retrieval of information from the database 340. The entry 26 further includes a network address 27 of the end client page consisting of one or more keywords associated with the page content. The network address 27 may further include a brief summary of the topic of information to be searched. The search engine 402 is further configured to describe any database system to distinguish itself from directory. The search engine would route science, engineering and transportation topics of information from the Internet 370 to the database server 121, collecting science, engineering, and transportation topics of information automatically and using programs such as spiders 173, crawlers 174, and/or robots 175. The robots 175, spiders 173, and/or crawlers 174 are configured to visit web pages 25 and collect the needed data by downloading files 110 in relation to the queried topics of information and also process the files.

The centralized transportation vehicle is a process-driven search engine for routing science, engineering and transportation topics and for managing data relating to science codes, engineering code, and transportation codes and modules. The science, engineering and transportation management system includes a server repository platform 28 operable for storing science information, engineering information, and also vehicle information. At least one of the information is a plane having components each describing respective science codes, engineering codes and mechanical failure codes.

In the disclosure, embodiments provide the communication apparatus comprising means for employees of science, engineering and transportation industries to share files and data resources through a centralized science, engineering and transportation network system 20 and 21. The shared network will enable communication with transportation industries, garages, and commercial transportation companies, engineering companies, and science companies seamlessly through a resourceful time sharing via shared Internet access. The centralized transportation system further includes server-based networks to enable reliability of solutions to local and distanced science, engineering and transportation industries.

The server networks 20 and 21 may be operable to connect industrial employees through a local social network environment to include topics of information resourceful to their business operations, maintenance programs and preventive maintenance, providing step by step repair procedures for a failed vehicle component. The database 340 may be accessed through desktop computers, notebooks, wireless devices, and megatel devices from any state in the U.S. and any part of the world. The decision engine 123 is further configured to format a response to a request in a manner usable and readable by client 120. Disclosed embodiments provide the decision engine 123 further operable for converting science, engineering and transportation topics of information to at least one of: Wireless Application Protocol (WAP) format, HTML document, XML document, Voice XML result, HTML, EHTML, Java, Java script, including any other format that the client device may be capable of interpreting.

Internal communications within the central processing unit “CPU” 51 may be disposed with high speed and high bandwidth networks. The CPU 51 is configured for communications with other appropriate protocol operable for permitting the communication apparatus 400 to respond to large number of distinct requests simultaneously, or near simultaneously. Certain embodiments provide the communication apparatus 400 further configured with the CPU 51 and operable for allowing scalability. Some embodiments provide the CPU 51 comprising a split system for allowing scalability. Other embodiments provide the CPU 51 communicatively connected to the communication apparatus 400 for providing operations for network 20 and 21.

Disclosed embodiments provide the wireless communication device 30 further operable for generating requests and for receiving and using information being generated in response to the requests. The wireless communication device 30 is configured to receive and transmit information wirelessly using transmitters 70. The transmitter 70 further comprises output device in communication with a read out tool OS. The read out tool 08 further comprises digital signal processor (DSP) circuitry. Normal voice communication is routed to or from the media device 201 in communication with a speaker/microphone 63.

Certain embodiments provide the media device 201 in communication with network interface module 170. Network interface module 170 is further configured to handle all communication with the client, including voice, visual, and data entry communications. Visual presentation of science, engineering and transportation topics of information may be provided via a display screen 003. General data entry is provided through the keyboard 11 and/or voice recognition or by voice data 12. The communication apparatus 400 is further configured with appropriate control keys 13 for performing necessary control functions configured for invoking science, engineering and transportation topics. Disclosed embodiments provide the control keys 13 comprising push-buttons, joysticks and touch-sensitive panels.

Some embodiments provide multiple interface modules 172. The wireless communication device 30 is configured with computer network applications, including browsers 040, input devices 80 and output devices 70, such as games, applications to assist in dialing numbers, and applications to permit web browsing, including the entry of data as part of the web browsing. The applications may be stored in ROM 02, RAM 05, EPROM 03, Flash memory 04, MRAM, EEPROM 06, or otherwise as appropriate, and may also be accessed by the wireless communication device 30.

Other embodiments provide a dialing module 108 configured for providing standard dialing functionality and for receiving entered dialing digits or voice dialing instructions in communication with interface module 170. The interface module 170 further comprises a network interface module being further operable for providing audio/visual signals. The network interface module 170 is further configured for communications with output devices 70. The application layer 530 is configured to receive data other than dialing instructions. Disclosed embodiments provide the dialing instructions comprising search data 126 being entered into the search column 21 of the communication apparatus 400 or a wireless communication device 30. The application layer 530 is further configured to provide the entered data to the servers 00 and 000.

The Web context may be configured based on queries, such that when a client submits a query containing science, engineering and transportation topics of information, the search engine 402 may respond with a list of links pointing to information resources for the web page hosting being derived from matching entries on science, engineering and transportation topics of information in the database 340. Disclosed embodiments provide the term “link” comprising any representation or symbol representing at least an address that points to the location of an information resource, such as the web page 25.

Typically, a link on a Web is a pointer found in one file which references another file. The link on the Web commonly refers to a Uniform Resource Locator (URL) comprising the global address for science engineering, and transportation files, forms, or documents and other resources commonly accessible on the Web. The centralized science, engineering and transportation network system comprises direct attached storage medium coupled to the server hard drive configured with a network attached storage to consolidate files stored for sharing. The server software 300 is further configured to periodically dump files into a backup server for future use.

Disclosed embodiments provide the server repository platform 28 comprising sets of tools for performing innovative renovation of science, engineering and transportation components, including analytical breakdown of possible solutions for the topics information. Certain embodiments provide science, engineering and transformation social network system comprising a process-based interface with science, engineering and transportation topics of information on the web. The web is accessible by end clients and includes a social platform 420 configured for advancing science, engineering and/or transportation knowledge. Some embodiments provide the interface module configured with the support system 210 operable for mapping desired communications using Protocols, Processes and Plans.

Some embodiments further provide Protocols comprising constructs of stored scripts for invoking a respective scripted tool to execute a particular function. Some embodiments provide Protocols comprising a software module being operable as input parameters for retrieving relevant science, engineering, and transportation information. Other embodiments provide the Protocol comprising apparatus for generating an output parameter of the function invocation specified as variables being supplied at the execution time of the topics. In other disclosures, embodiments provide the search engines 402 in communication with computer applications, including spiders 173 and/or robots 175 configured for indexing the different elements of websites on the Internet 370 and for gathering content information for database 340. The search engine robot is configured to index information resources in the Internet 370. The robot is further configured for updating links to the database 340 in a queried dependency manner so that science, engineering and transportation topics of information are shared effectively.

In a typical searching sequence, communication is established over the network between at least a client and communication apparatus 400. Some embodiments provide the establishment comprising communication environment that includes a web browser program on the client machine. Other embodiments provide a search criteria being entered by a client of the client machine, and being transmitted to the search engine server 402. The search engine server is operable for searching the information available on the network consisting of science, engineering and transportation topics of information. The client may, for example, access particular web pages that are included in the results directly over network environment as desired by the client.

Disclosed embodiments provide processes comprising constructs that store science, engineering, and transportation topics definitions comprising descriptions of particular tasks to be performed. The task to be performed is described using one or more protocols and/or one or more other processes. In the preferred embodiment, the Protocols, Processes, and Plans are each stored as vehicle/engine in the science, engineering and transportation management system repository for updating connectivity to the database, for updating the range of the assignments when a connection is disabled or enabled, and for processing signal connectivity to updating execution of prescribed functions corresponding to updating functions in response to the operational set mode signals for generating matching solutions to defined science topics, engineering topics and transportation failed components.

This vehicle, which comprises science, engineering, and Centralized transportation System Components, is stored in a manner that is similar to the way in which the Asset components describing the software modules are stored. Furthermore, the associations between Protocols, Processes, and Plans are stored as relationships between the respective centralized transportation vehicles in a manner that is similar to the way relationships between the software modules are represented science, engineering and transportation topics.

In another preferred embodiment, the definition of the Centralized Transportation Vehicle further comprises a centrally driven engine for routing science, engineering and transportation topics of information to end clients, providing a centralized network system for science and engineering schools, universities, professional environments and transportation industries. Each of the engines for the Centralized Transportation Vehicle comprises System Components, as well as the relationships that may exist between the components, being created using a pre-defined element type of the topics information or relationship type definition that is also stored within the repository.

In one disclosure, embodiments provide a computer implemented method of extracting and sharing science, engineering and transportation topics of information from a database. The database is made searchable for occurrences of at least one topic of information. An occurrence of a topic of information that was found is analyzed to identify a pattern in which the topic of information was stored. Additional topics of information are extracted from the database utilizing the pattern. In some embodiments, the process is repeated until a predetermined number of topics are found or until no new patterns are identified. The model definition simplifies the system design and makes operation more robust because the various tools in the system is configured to be synchronized with the element and relationship type definitions instead of having to be aware of special-case and particularized element descriptions.

Additionally, modifications to the components can be more readily accomplished because a whole class of element definitions can be modified by making a single change to an element type definition. The type definitions further allows the automated Plan development tool to efficiently query the client for process and other Asset element selections. The collection of search result includes a web file module 401 and a solution address 131 of science, engineering, and transportation topics of information. The web file module 401 includes a web browser that serves as a label for the search results.

In this example, the web browser is configured with the web file module 401. Science, engineering and transportation topics are entered in the web browser and presented to indicate the required query word being searched to ensure that results matches the search term that was originally entered by the client when specifying network search parameters. The search engine 402 would search the indexer 108 for instances of science, engineering, and transportation topics identified from the appropriate index entries. The indexer 108 would then provide the client interface module 172 with the relevant information pertaining to the identified entries.

Searching the indexer 108 may employ matching algorithms to search on the identified search term and may further include identifying terms related to the search term or terms likely to be selected by the client in the future. Selected future topics are similarly searched in the indexer 108 on the terms relating to science, engineering and transportation topics of information. The web file module 401 is further configured for communications with the decision engine 123 being operable with the search program 39 configured for web browsing. A client may reference the web browser 040 and the decision engine 123 to make a determination responsive to science, engineering and transportation topics of information.

The decision engine 123 may represent a portion of a web page, stored files, e-mails, telephone numbers, electronic books, science and engineering text, and other relevant topics of information. The solution address 131 is configured to specify the location of the associated content relating to the topics being queried. Disclosed embodiments provide the solution address 131 being operable with an address designator 020 comprising URL. Certain embodiments provide the address designator 020 being operable for identifying servers 00 and 000 that houses the content identified by the search engine 402. In this manner, display 003 comprises an area being conserved for search result to be presented.

Disclosed embodiments provide cached database comprising copies or partial copies of content that the CPU 51 has identified. In one embodiment, the cached database may contain web pages or portions of web pages comprising textual content, non-video content, audio content, visual content, and video content. The cached database is further configured to connect client 120 to the communication apparatus 400 to request copies of the content rather than remote copies, which may otherwise require making direct contact with the content provider. The communication apparatus 400 provides information for various Internet applications 370, including system parameters, and information about registered clients. Disclosed embodiments provide the support system 210 further comprises a media control device. A communication search program 39 is configured to manage the operation of the CPU 51, and includes the search engine 402 and media control device 201 and the client interface module 172.

The search engine 402 and media control device 201 include a crawler 174 communicatively configured with network 20 for requesting electronic documents from the servers 00 and 000. Content from crawler 174 is stored in the index database 132 or cache database 133 for further searches or retrieval. Contents from crawler 174 are classified according to the electronic format being provided for various applications such as mobile device applications, desktop applications, or wireless device applications. The search engine 402 and media control device 201 are logically configured for communications with the indexer 108. The client interface module 172 is further configured to prepare electronic content for presentation on the display device 003 responsive to client input.

In one embodiment, the client interface module 172 may prepare search result elements for presentation to a client in response to a client's tendered search query request. The client interface module 172 may determine the appropriate science, engineering and transportation topics format, layout, arrangement, selection, quantity, graphic type, and grouping of the topics for presentation via display device 003 of the client 120. The client interface module 172 is further configured for determining whether to include additional science, engineering and transportation topics of information relating to the client search result. The client interface module 172 is further operable for routing client input data or for routing any selections from the client 120. Selections may be retrieved with the mobile device 30. Alternatively, the client interface module 172 could reside on the client 120 rather than within the central processing unit 51. The software 300 is further configured to allow the server tools to communicate with each other for effecting permits users to perform search task.

The tools are in communication with the ROM to provide security and reliability on the industrial files and folders. The file or folders are in association with the database being coupled with a primary domain controller “PDC” or another set of file/folder servers for keeping records. The PDC centralizes network computer apparatus, enabling a centralized communication vehicle for allowing scientists, engineers, and transportation industries, garages, transportation maintenance fleet STESN, government agencies, police departments, fire departments, and homeland security agencies to talk to each other seamlessly through a centralized system and for extracting transportation topics of information from a centralized transportation database. Detected data referencing at least a terrorist desiring at least a transportation topic of information is made available to the government and/or homeland security agencies, enabling these agencies to thwart transportation and other activities involving terrorists.

The database may provide data monitored by at least a cache engine. The cache engine enables finding other patterns in which the terrorist carries other activities. The network adapters provide the physical connection to the network 20 and 21, locating the physical addresses of industrial computers or other devices. The PDC is configured to receive the industry's names and passwords at the initial logon screen. Disclosed embodiments provide the PDC being further operable to create security identification that will set the permission and rights for clients of the network and industrial services. Connectivity to the network is allowed through protocol communication, permitting data to be sent through the network adapters into cables or other wireless means.

The network interface 170 may be configured to pull out or put into network adapters the queried data through the cables without any internal protocol. The communication process from one network computer to the server 00 and 000 operable for retrieving data passes through model layers that are assigned specific task to the layers. The application layer supports files, application services, print services, message services, and database services before they are sent to the presentation layer 540. The transport layer 560 is operable for delivering the queried data to the end user. The network layer 570 is in communications with routers configured for moving data through the Internet 370. The Internet protocol layer is configured to encapsulate the search packages into data-gram that will run through its algorithms into the database problem and solution addresses.

Server 000 and 00 are operatively configured with a cache engine 350 and communicatively connected to a query engine. The cache engine provides easier and faster means of delivering the desired science, engineering and transportation contents of the topics of information. The cache engine identifies science, engineering and transportation topics from the user selections within the network 20 and 21. The cache engine further downloads content that matches user defined preferences and enables communication with the servers 000 and 00 for data transmission. The servers are embodied in the system through which at least a background task is enabled to allow a posting for allowable task to be performed by at least a registered user. Server 000 and 00 are further configured with a registration module, a monitoring module, a search module and a communication module communicatively connected to database 340. The network 20 and 21 further includes the Internet being connected to at least a web-enabled device having at least a browser operatively configured with the cache engine in communication with a client.

Server 000 and 00 and the query engine are further configured with filters which are connected to nodes which are coupled to the Affinity Analyzer to determine which components are involved in the processing performed to accomplish a particular function or task associated with science, engineering and transportation topics of information. The Affinity Analyzer further provides graphic display representing the various components and element relationships for code and data components provided by the database platform. The graphical displays are capable of illustrating complex element of science, engineering and transportation component drawings through networks 20 and 21.

Certain embodiments provide the graphical display being used for advanced impact analysis of the science, engineering and transportation topics of information, providing solutions for queried data. The system allows code modification and before a particular code module is modified, the relationships existing between the associated elements that models that code module and other components may be used to determine which other code or data components need to be modified to maintain system's compatibility and efficiency so that all other end users would communicate through the centralized transportation system seamlessly and in real time. These relationships may be graphically depicted using the Affinity Analyzer 122, which allows software analysts to interrogate and visually mine single or disparate sets of components without having to understand the details of the components or relationships involved.

Referring back to FIG. 7, the centralized transportation comprises the Element Locator 125. This tool uses Natural Language Understanding (NLU) technology to locate science and engineering topics and also to provide potential solutions for the failed components. This makes the transportation topics of information stored in the memory more accessible to other user environments because the details of the stored information or the structure of the information has to be known outside the centralized system. The Element Locator 125 is operatively configured with the component inventory 102 and communicatively connected to the Affinity Analyzer 122 to enable performing a very efficient concept such as search, using application domain mappings stored in the system's database shelves 70. The Process Manager 126 is a rules-based tool that allows a user to define the centralized science, engineering and transportation vehicle or protocols and enable various processes that are in the database shelves 70.

In the preferred embodiment, the server 00 and 000 is a web-based system having a “web-like” interface, although other types of interfaces, graphical or non-graphical, could be utilized. Disclosed embodiments provide a communication vehicle for users to invoke scripted tools by specifying a desired outcome instead of by specifying particular tool sequences. Thus the complexity associated with locating, transforming, processing and managing the code and data modules of various transportation fleet departments files are largely hidden from the user. However, any resulting program(s) having computer-readable program code may be embodied within the communication apparatus 400. The memory devices for the centralized transportation system include, but are not limited to, fixed hard disk drives, floppy disks, or zip diskettes, optical disks, magnetic tape, semiconductor memories such as RAM, ROM, Proms, etc.

Transmitting devices for the centralized transportation system include, but are not limited to, the Internet, intranets, electronic bulletin board and message/note exchanges, telephone/modem based network communication, hard-wired/cabled communication network, cellular communication, radio wave communication, satellite communication and other stationary or mobile network system communication links. A machine embodying the centralized transportation system may involve one or more processing system including a CPU, memory and storage devices, communication links, communication and transmitting devices, servers, I/O devices, and/or any subcomponents or individual parts of one or more processing systems, further including software, firmware, hardware, or any combination and/or a sub-combination thereof, which embody the centralized transportation system and the centralized transportation vehicle for routing science, engineering and transportation topics of information.

Moreover, because protocol and processes are defined and managed as part of the transportation vehicle, the impact-analysis operations that are performed when tools, code modules or data modules are modified or deleted are largely simplified to make complex task more simplified. Included in the Workbench are functions that allow the user to manage, view, and report all the components and element relationships existing within the transportation industries. These tools include Transportation Discovery Functions 143. Transportation discovery refers to the process of initially creating components and their relationships among other components in the transportation fleet management system.

Generally, a Transportation Discovery Function will analyze a target group of transportation software and data constructs and the interrelationships between these constructs. The Transportation Discovery Function is configured to automatically create components associated with the code and data constructs. If the servers are model driven, the Transportation Discovery Functions 143 will utilize the various element type definitions stored within the model, such as a program or database to create the components. Each of these components may include meta-data 114 that describes the location and function of the associated code or data element. This meta-data further describes the relationships that an element of the transportation vehicle has with other components, wherein each element relationship models the relationship between the associated code or data construct and other code or data constructs represented by the related components.

The Transportation Discovery Function 143 may be configured to sort or create a group of components that may be stored within the Server Database shelves, and which may become available as part of the system knowledge base to manage the associated code and data components. More specifically, the embodiments provide the communication apparatus is described in reference to utilizing topics of information to identify patterns in which the topics are stored so that additional topics can be found. However, embodiments are not limited to any particular science, engineering or transportation applications or specific implementation. Therefore, all descriptions of disclosed embodiments are for purposes of illustrations and not limitations.

Embodiments provide the vehicle of choice for solving science, engineering and transportation problems over the web and for advancing online destination services where other science, engineering and transportation businesses will take advantage of the growing variety of the centralized services which are important to knowledge distributions, industrial efficiency, profitability, resourcefulness, and science, engineering, and transportation success. Including homeland security distributions of knowledge, embodiments further provide process integration with Internet Technologies to enable transportation problem solving. by providing a centralized digital workplace configured to offer the next level of transportation solutions to queried topics. Search results are produced through the social interaction between plurality tools.

Some embodiments provide transportation files, forms or documents or files described in the initial results may be retrieved by the client from network servers 00 and 000 through transmission medium 27. The search engine 402 may include one or more of the following: a Network interface 170, a transportation decision engine 123 operatively configured with the affinity/data analyzer 122, databases 130 and 340, a report generator 124, and a payment module 104. The Network interface 170 connects the search engine servers 00 and 000 to the network 20 and 21, preferably a computer network, such as the Internet. The Network interface 170 is further configured to connect with networks such as wireless networks, television networks, telephone networks, satellite networks, local area networks, and other networks.

The decision engine may comprise neural network-based algorithms that are effective in several applications including: diagnosis or pattern recognition such as speech and image processing, because the neural network algorithm is further configured for adjusting to patterns in data transmissions. The neural network is further configured to deduce relationships between the different data variables (e.g., estimation or prediction applications even when difficulties exist in completely specifying the rules for science and engineering topics, including vehicle makes and models). The neural network is further configured to assess interrelationships between science and engineering factors and predict outcomes with significant accuracy. The neural network is further configured for processing large amounts of data in real-time. Once the training set for the neural network is developed, the learning algorithm trains the neural network by creating a network of associations between possible aspects of input relating to science, engineering, and transportation topics of information to enable responses thereon. The neural network is more flexible than traditional programming methods used in prior art devices because the neural network is scalable and can be reused for solving other science, engineering and transportation problem domains.

Disclosed embodiments provide decision engine 123 further comprising components of: a Java storage and retrieval (JSTAR) Class 023, a ClicknVestServlet class 032, a servletrunner application 034, a Trainer Module 036, and a Retrainer Module 038. The network 20 and 21 comprise any distributed computer network such as a local area network (LAN), a wide area network (WAN), or other connection services and network variations such as the Internet, the World Wide Web, computer network terminal devices, such as personal computers, workstations, servers, secondary-computers, primary-frame computers, laptop computers, mobile computers, palm top computers, hand held computers, set top boxes for a TV. or a combination thereof, a touch screen, a keyboard, a mouse, output devices, a value-added network. etc.

Embodiments provide communication apparatus 400 for the network communications by providing specific transportation science, engineering and transportation topics of information sought by a user. Typically a user seeks to access specific science, engineering and/or transportation data stored in one or several content servers. However, often the situation arises where the user does not know which content server or even where within a specific content server the data resides. To identify the location of the desired data, the user will usually request a search engine server to identify a set of links that are relevant to the user's desired information. To accomplish this, the user utilizes a network terminal to establish a communication session with the search engine server via the network 20 and/or 21.

Having established this communication session, the user may input a query into a browser 040 for communication with network terminal, which transmits the query to the search engine server 00 and 000. The search engine server processes the query according to any one of a number of well-known algorithms and transmits to the user a list of links pointing to information resources such as science and/or engineering topics, and/or transportation files, forms, or documents on the database 340 and 130 that may be relevant to the user's query. The links are usually retrieved from a database stored in, or at least accessible through the search engine server. From the list provided by the search engine server, the user then selects at least one link that appears pertinent to the desired science, engineering and/or transportation topics of information.

When the user selects the link, the network terminal makes a request to the content server associated with the selected link to transmit the science, engineering and/or transportation files, forms, or documents from the database. A controller is provided and configured to coordinate the functionality of the link to the database, the indexer, the robot, and the queue. The controller may comprise any commercially available processor, such as a Pentium Pro. At least a memory is communicatively connected to the processor, and may be in the form of a cache memory for rapid access to the cached or stored information or other type of memory, such as a dedicated hard disk or a combination of both. The robot is a software module that is configured for accessing science, engineering and transportation files, forms, or documents stored in the content servers 00 and 000, and identified by the links stored either in the database or the queue. The Robot gathers the data stored in the files, forms or documents and forwards it to the indexer. Software modules such as robot are well known in the relevant technology, but not for the services of the disclosed embodiments.

Robot is also known in the relevant technology by the names spider, crawler, wanderer, or gatherer. However, in one embodiment of the instant invention, the queue contains a list of links such as a subset of the links stored in the link database which the robot uses for updating purposes. The queue may be at least a file which is preferably stored in the memory of the search engine server 402. The indexer is configured to receive data such as web pages retrieved by the robot, and extracts some portion of that data that is used to associate a given link with the information on the file to which the link refers. That is, usually the indexer identifies individual words from the text of a file or in the case of a web page, the indexer retrieves the text stored in the keywords or the description fields of the webpage. The indexer, for each transportation file, form, or document, associates the link with the extracted data and stores them in the link database 130. Indexing programs that perform the functions of the indexer are well known in the pertinent technology such as the Ultra seek Server, TM, indexer produced by Infoseek Corporation.

In one embodiment, the robot uses the links stored either in the link database or in the queue to access the files, forms or documents stored in the content servers and optimize the freshness of the links being displayed in response to a user query. The robot then forwards some or all of the data associated with the files, forms or documents to the indexer. From this data, the indexer would extract any data it needs for association with the respective link that identifies the files, forms or document. The indexer is further configured to store the associated data and link in the link database 130. In one embodiment, the indexer may compare the data already stored in the link database 130 against the new data gathered by the robot. If there are any discrepancies in the data, the indexer would store the appropriate updates in the link database 130.

Certain embodiments provide the indexer configured for communications with the webmaster to prevent data modification in association with the files, forms, or documents. The indexer does not modify the contents of the link database. In another embodiment, however, the indexer may simply inspect that the link is still valid. That is, the indexer only verifies that the robot was able to access any data by using the respective link pointing to given files, forms, or documents. Thus, in this manner the robot, the queue, and the indexer collaborate to refresh the contents of the link database. The decision engine operation may be executed on a Microsoft Windows 95.RTM.-based personal computer or other Java compatible platform, including a Microsoft NT.RTM. server, a Sun Station.RTM., an IBM RS/6000.RTM. or other platform.

The decision engine may be incorporated into a kiosk system. The decision engine recognizes patterns and relationships within a set of input data or responses of topics of information and estimates and/or predicts outcomes. The transportation decision engine may also process a large number of variables such as queries and responses and be able to deduce the interactions between the different variables. The relationships between numerous variables are enhanced to formally define automobiles, trucks, planes, marine vehicles, etc. in linear relationships. The decision engine may be trained to handle the numerous variables and can self-adapt and sort through data to produce an understanding of the factors affecting these data.

The transportation decision engine 123 may incorporate a scalable, robust, customizable, quick, simple, flexible and efficient architecture for large scale memory, retrieval and classification problems. The transportation decision engine 123 is scalable by adding more self-organizing maps defining the various science, engineering and transportation variables and the associate variables to the training set and re-training the science, engineering and transportation neural network. Unlike traditional programming techniques, the transportation decision engine's programming code need not be changed. With re-training, the decision engine 123 provides greater flexibility without reprogramming. The science, engineering and transportation decision engine 123 can infer new behavior and deduce patterns and relationships in the database. The decision engine 123 includes two Java classes: the JSTAR class 023 and the ClicknVestServlet class 032. The JSTAR Class 023 is a Java class that is also called a JSTAR Java servlet. The JSTAR class 023 is an object-oriented, Java language based application.

Browser program 040 may be a web browser which allows a user to retrieve and view files on the WWW, or a program which performs a similar function on some other network. In some embodiments, client functions involved in implementation of the methods described herein are included in browser 040. For example, browser 040 preferably provides a framework for communication between server-side search program 39 and client-side search program 38, typically by calling an appropriate additional program. Browser 040 or a program called by the browser may include user-settable options as to whether additional client-side searching is done real-time or at a later time, or whether it is done at all. Other options could include whether the additional searching is done automatically by the program or at least in part manually by the user. Such functions, and/or other functions of the client computing device, may also be implemented in separate program instructions such as program instructions 26 or client-side search program 38.

Disclosed embodiments provide the communication apparatus 400 comprising files 18 comprising various files stored on the client computational device, including files downloaded from information content servers 00. Files 18 may also include other files suitable for use in communicating across the network or in identifying stored information accessible using the network. For example, a file including initial search results sent from server 000 may be included in files 18, as may a file containing data associated with additional search results be produced using client-side search program 38. Client is typically associated with an output device 70 and input device 80, particularly in embodiments for which the client computational device is operated by a user of system 10, 20, 30, 40, and 50. Output device 70 may include a display screen 003 and/or a printer. Input device 80 may include, for example, a keyboard 009 and/or a pointing device such as a mouse 11.

The trainer module 036 trains the neural network. Training of the neural network is described below. The optional trainer module 036 may be an integral component of the science, engineering and transportation decision engine 123 or it may be a separate component. The decision engine 123 may also be trained without a training module 036.

The optional re-trainer module 038 may use the queries, responses, confidence values and/or other factors to fine-tune the decision engine 123. The re-trainer module 038 may be an integral component of the decision engine 123 or it may be a separate component.

The databases 130 may include vendor data, market data, and buyer data. The databases 130 may be partitioned into one or more databases, such as a vendor database 136, a user database 137, a market database 138, and transportation model and make database 139. The vendor database 136 may include information about the vendor, the products that the vendor carries, vendor specific pricing and options, and the vendor's Internet site address. The vendor database 136 may also include detailed information about the products and services offered, including price, features, brand names, delivery methods and including on-line, store front, or via distributors, availability dates and other information.

The user database 137 may include information collected about the users. For example, the user database 137 may include information about the user such as company, business type, years in business, age, income level, gender, address (home and/or office), and planned purchase timeframe. After the user has used the Centralized transportation search engine server 000 to compare products or services, the user database 137 may include the user's preferences entered in the selection process and the user's down-selected list. The preferences of multiple users may be used to develop trend information that is stored in database 139. For example, the trend information may show that 80% of users want on-line centralized transportation parts shopping or ware house, and 50% of users want interest bearing checking accounts purchase orders. After the user has purchased a product or service via the Centralized transportation search engine server 000, the user database 137 may include information about the user's prior purchases. The user database 137 may also contain other user information such as the user's purchasing preferences obtained from other sources.

The market database 138 may include information about trends in the market place. For example, the market database 138 may include information about a trend among centralized transportation parts shopping or ware house features. The databases may include market intelligence database syndication, distribution and licensing of buyer data, vendor data, product data and market data. Data mining techniques may be used on the databases to develop market trend data, competitive analysis, vendor profiles and Centralized profiles.

The optional report generator 134 provides reports including vendor reports that indicate activities between users and vendors, user reports that indicate user activities with the Centralized transportation search engine server 000 and/or the vendors, preference reports that indicate trends in Centralized preferences, ad hoc reports, and others. The optional data analyzer 122a may provide customizable data analysis tools. For example, the affinity analyzer 122 may provide customized or ad hoc data analysis that the server 00 or the server 123 can use to fine-tune the marketing of the product or services.

The payment module calculates the fees charged to the vendors. Such fees may include periodic fees, banner fees, performance-based fees, and results-based fees. The results-based fees include fees based on the activities between users and vendors when the users are referred to the vendor by the Centralized transportation search engine server 000. A user is referred to a vendor when the Centralized transportation search engine server 000 provides the user information about a vendor or a product or service offered by the vendor. User activities may include accessing the vendor's network site, opening a new account with the vendor, purchasing a product, or other activity. The fees may include fees charged to vendors other than the user's preferred vendors when the user opens an account with the non-preferred vendor. The non-preferred vendor fee may be less than the preferred vendor fee. The amount of the fee may be based on various factors, for example, the number of activities the user performed prior to at least a purchase, the user's profile or the type of activity.

The network 21 provides communication between multiple computer systems. In a wide area network such as the Internet some computer systems are servers or hosts and provide access to resources such as information or services to client computer systems communicatively connected with the network 21. With respect to the Web, there are thousands of server computer systems that store the web pages that make up the Web. The web pages typically include links in the form of uniform resource locators (URLs) that are a link to another web page, whether it is on the same server or a different one. As described above, the Web is a distributed network of web pages. Networks of hyperlinked transportation files, forms, or documents can also be present in local area networks such as the intranets. The operation of these intranets is very similar to the Internet except that it is not uncommon for all or a majority of the hyperlinked transportation files, forms or documents of an intranet to be stored on a single server computer system.

FIG. 11 illustrates a mobile phone with a touch screen panel operable for communications, interactive gaming, music applications, and a slider operable for accessing multimedia buttons. As shown, communication apparatus 400 comprises a mobile phone with a touch screen panel operable for communications, interactive gaming, music applications, and a virtual slider operable for accessing multimedia buttons. Disclosed embodiments provide communication apparatus 400 comprising at least one of: at least a variable gain module 434, a mobile device 435, internal peripheral devices 436, and external peripheral devices 437. Certain embodiments provide communication apparatus 400 comprising at least one of: cell phones, smart phones, laptops, handheld communication devices, handheld computing devices, satellite radios, global positioning systems, and PDAs.

Some embodiments provide internal peripheral devices being disposed in the mobile device. Other embodiments provide communication apparatus 400 further comprising a Bluetooth radio, wireless local area network (WLAN) radio, and/or a wireless wide area network (WWAN) radio. The external peripheral device further comprises a camera, printer, card reader, scanner, radio connection, and/or wireless device connection. Embodiments further provide communication apparatus 400 configured with speakers 405 and microphones 408. Certain embodiments provide the communication apparatus further comprising a display/input device 404 being operated by a human hand 600. The display/input device 404 comprises a touch screen 412 being further operable on a detection platform 706.

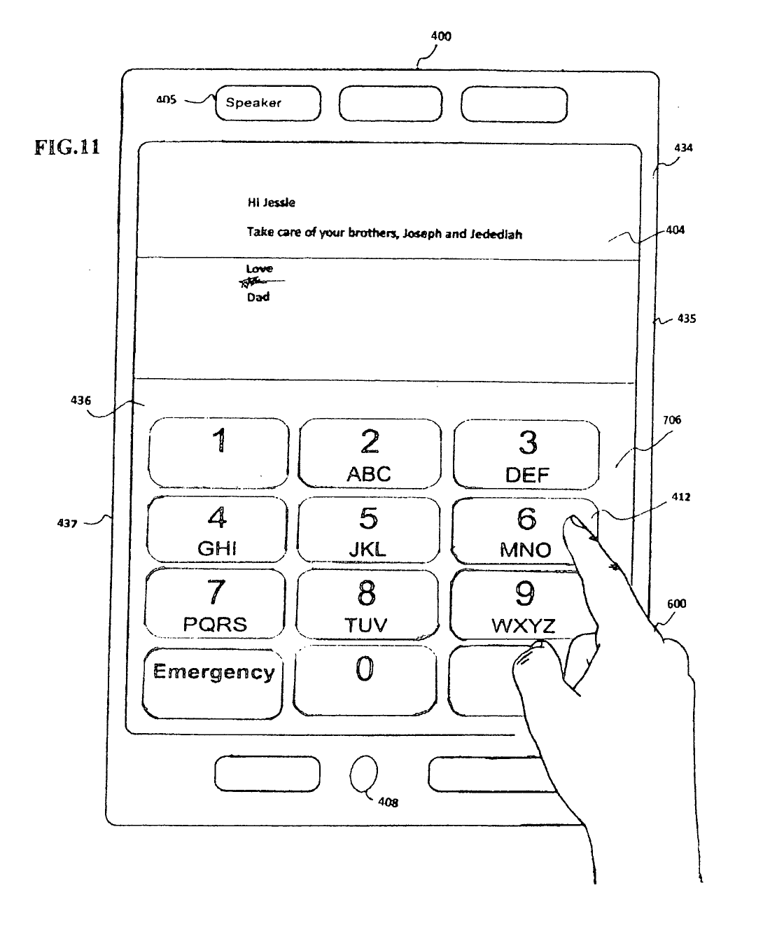

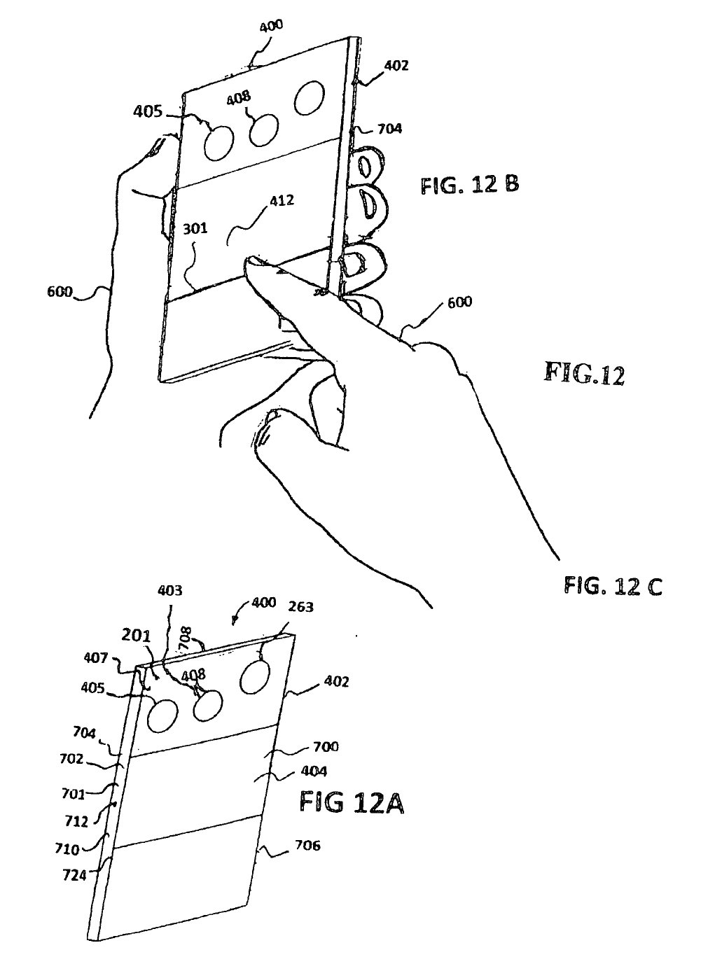

FIG. 12 illustrates a mobile phone with numeric keypads operable to provide voice over texting applications, a slide out keyboard, and resistive touch screen character recognition. As shown, communication apparatus 400 comprises a mobile phone with numeric keypads operable to provide voice over texting applications, a slide out keyboard, and resistive touch screen character recognition in accordance with one embodiment of the invention. Referring to FIG. 12A, the communication apparatus 400 comprises a housing 402 comprising a sensory platform 700 consisting of a nanotechnology application. Some embodiments provide the housing 402 comprising of at least a cell phone housing and/or belt clip. The sensory platform further includes strain gauges 701 embedded in load cells 702.

Disclosed embodiment further provide nano-technology applications comprising nano-sensors 704 being embedded in silicon substrate 712 and fused/etched in microfiber material 710, providing a silicon microfiber 724. The sensory platform 700 being operable to provide a detection platform 706 being further operable for communications and/or for converting at least a form of energy into electrical energy. Disclosed embodiments further provide the sensory platform 700 further comprising a display/input device 404 being disposed with the housing 402. Certain embodiments provide the housing 402 further consisting of speakers 405, microphones 408, embedded antenna apparatus 201, in communication with at least a signal booster comprising a chip 403, in communication with a logic circuit 407. The communication apparatus 400 further comprises the detection platform 706 comprising sensors 708 being operable for detecting objects proximity to at least the display/input 404. The communication apparatus 400 may comprise at least one of: cellular telephone, telephonic, media device, PDA device, cellular telephone, GPS device, entertainment device and/or an information device being operable for road and traffic communications, including road side advertisement.

Embodiments further provide communication apparatus 400 configured with speakers 405, and microphones 408. Certain embodiments provide the communication apparatus 400 comprising a display/input device 404. The display/input device 404 comprises a touch screen 412 being further operable on a detection platform 706. Disclosed embodiments provide a device being configured for input/output on a substrate comprising a piezoelectric sensor formed on the substrate. The device further comprises a display/input formed on the substrate. The piezoelectric sensor is formed on the substrate in communication with at least a processor being further operable to calculate applied force and activate a force response based on the calculated value. Disclosed embodiments provide communication apparatus comprising a device configured for monitoring resistance associated with one or more piezoelectric sensors to detect changes in a force applied to a display/input device. The display/input device is further configured for detecting change in resistance associated with the one or more piezoelectric sensors being further configured with electrical crystals operable for measuring force applied to the display/input device based on the detected change in resistance.

FIG. 12B illustrates an exemplary embodiment of a human hand 600 holding communication apparatus 400. The communication apparatus is disposed in a housing 402 configured with nano-sensors 704, a display/input device 404, a speaker 405, and a microphone 408. The display/input device 404 further comprises a touch screen 412 being further configured with an interface device 301. The communication apparatus 400 further comprises a media device further consisting of input and output devices. Disclosed embodiments provide the communication apparatus 400 including at least a housing 402.

The communication apparatus 400 further comprises a cellular telephone, a game device, a media player and a PDA. The communication apparatus 400 is portable and may fit within the hand of adults and children. In one embodiment, the display/input device 404 may include at least one of multi-point interactive touch screen input device 412, and an LCD display. Disclosed embodiments provide a display/input device 404 comprising a liquid crystal display (LCD), a touch screen display or another type of display operable for providing information. Certain embodiments provide a display/input device being further operable for providing information regarding incoming or outgoing telephone calls and/or incoming or outgoing electronic mail (email), instant messages, short message services, multi-media message services, calendar applications, text message applications, the current time display, video game applications, downloaded content display, and media applications. In one embodiment, the multipoint interactive touch screen is a capacitive sensing medium configured to detect multiple touches, including blobs on the display from a user's face or multiple fingers touching or nearly touching the display.

FIG. 12C illustrates an exemplary embodiment of the disclosure comprising human hand interaction 600. Certain embodiments provide the communication apparatus 400 comprising a hand held device, further comprising a display/input device 404 as seen further in FIG. 12B.

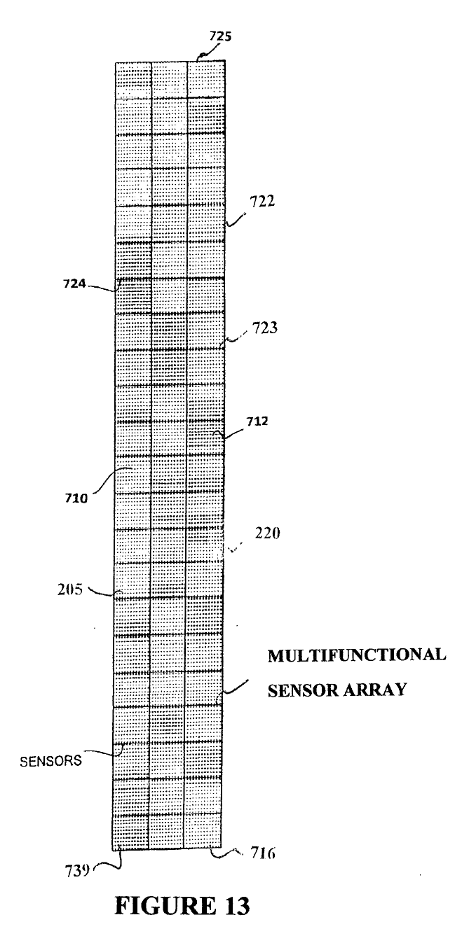

FIG. 13 illustrates exemplary embodiments of nanotechnology applications of CMOS multiple antennas on a chip to realize at least a 60 GHz frequency. The CMOS multiple antennas 724 comprise miniaturized alloyed material comprising a meta-material structured surface cavity 722 embedded/coupled in silicon-substrate-microfiber platform 723. Disclosed embodiments provide the platform 722 comprising CMOS multiple antenna apparatus 724 configured for communication apparatus 400. The platform 722 further comprises methods and systems for generating electrical energy. The communication apparatus comprises microfiber material 710 further configured with sensors on silicon substrate 712. The sensor comprises an electrode and/or temperature sensor 716.

Certain embodiments provide the substrate-microfiber 724 comprising miniaturized nonferrous materials 734 being embedded in the silicon substrate 712. Some embodiments provide the substrate-microfiber 724 comprising energy transport platform 725. Certain embodiments provide the CMOS multiple antenna apparatus 724 coupled to the silicon substrate 712, further comprising at least glass 739 comprising a gallium nitride high electron mobility transistor (GaN-HEMT) to improve communication signal amplification, faster data transport speed, and reduce energy consumption for the communication apparatus 400. Some embodiments provide the communication apparatus being configured with a silicon to silicon bonding and/or silicon to ceramic wafer bonding to further provide a detection platform and for generating electrical energy. The silicon is further provided with ceramic wafer bonding responsive to solar energy. The silicon to ceramic wafer bonding may include at least silicon to glass bonding, forming single crystal silicon to improve the micro-acoustics and micro optics in the nanotechnology applications to further reduce energy consumption and produce electrical energy.

Disclosed embodiments provide optical properties of thin films being operable for the advancement of the integrated circuit for converting solar energy into electrical energy. Certain embodiments provide optical properties of thin films being operable for the advancement of the integrated circuit for converting solar energy into electrical energy. Some embodiments provide energy platforms consisting of at least surface acoustic wave line, paste, MEMS, thin film depositions, and a multifunctional sensor array 205 embedded in the silicon substrate 712 and etched/fused in a micro-fibered material 220. The application of ceramic materials further provides many features, including high hardness, physical stability, extreme heat resistance and chemical inertness. Certain embodiments provide highly resistant material to aggressive chemicals, melting, bending, stretching, and corrosion.

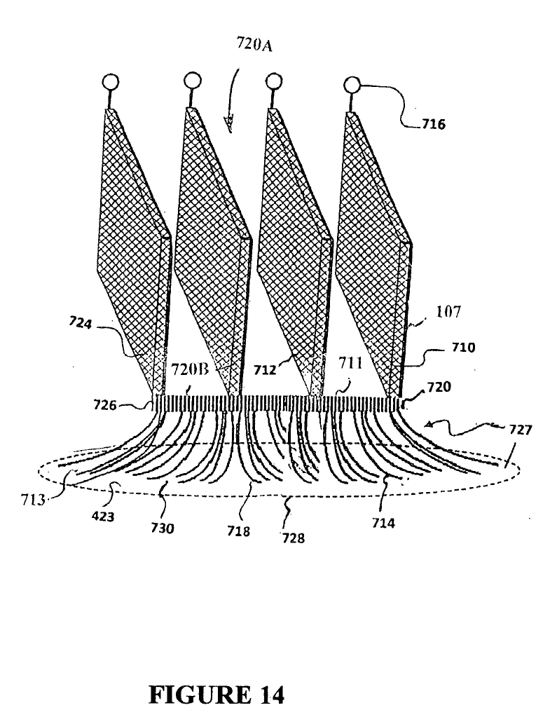

FIG. 14 illustrates an antenna apparatus and an energy transport medium. Disclosed embodiments further provide communication apparatus comprising methods and systems for generating and storing electrical energy. Certain embodiments comprise nano-materials 710 comprising microfiber material. Disclosed embodiments further provide the microfiber material 710 comprising materials with excellent electrical properties being disposed with substrate 712 being alloyed with meta-material structure and etched/fused in a microfiber material to enable energy cell platform and remove radiation pattern back lobe. The microfiber material 710 includes material components with nanometer dimensions in which at least one dimension is less than 100 nanometers.

Some embodiments provide the microfiber materials being further configured with nano-wires/tubes 714. The nano-wires/tubes 714 may be embedded in the silicon substrate 712. Certain embodiments provide a communication apparatus comprising the substrate 712 being configured with electrodes 716 at the opened end of the CMOS multiple antennas network in communication with the nano-wires/tubes 714. Some embodiments provide nano-sensors on silicon microfiber comprising nano-fibers formed on the microfiber. Other embodiments provide the electrode 716 further comprising at least a temperature sensor. Disclosed embodiments provide a microfiber membrane configured to provide structural communication and data transmission integrity.

Certain embodiments provide the nano-fibers being formed using electro-spray deposition. Other embodiments provide the nano-wires/tubes 714 comprising at least one component of: carbon char, carbon black, metal sulfides, metal oxides and other organic materials being alloyed with the microfiber material 712. Disclosed embodiments further provide communication apparatus being disposed with alloyed material comprising apparatus 718 being configured for exhibiting unique electrical and electrochemical properties to provide efficient transportation of energy properties. The apparatus 18, in some embodiments, comprises multiple CMOS antennas on a chip operable for intra-chip wireless communication network 727. Embodiments provide a combination of the silicon substrate and metal oxide and/or thin film or miniaturized metallic material in communication with signal booster chip, providing an energy platform comprising a battery cell for the communication apparatus.

Disclosed embodiments further provide a communication apparatus consisting of a detection platform comprising touch screen display device configured with a processor means comprising a pattern recognition technique for producing “Sensing,” a controlled data/communication signal and communicating sensed detection to a wireless modem or control module being operable to provide wireless communication. Certain embodiments provide the carbon char being configured with silicon substrate and microfiber material to further provide an energy platform. Embodiments described herein include multiple antenna apparatus fabricated on relatively low resistivity CMOS-grade silicon substrate microfiber with reasonable radiation efficiency. The communication apparatus is reconfigured with integrated sensor elements on at least a circuit board operable for energy harvesting.

Some embodiments provide the sensor elements comprising at least a sensing mode configured with nano-sensors operable to measure environmental characteristics by generating electromagnetic charge and outputs a time-encoded signal indicative of the measurement, at least a platform comprising of energy harvesting mode to harvest energy from solar energy, wave energy, electromagnetic energy and ambient energy sources. Certain embodiments provide a switchable circuit board configured to switch from the sensing mode to the energy harvesting mode responsive to at least a predetermined threshold.

Disclosed embodiments further provide communication apparatus comprising methods and systems for producing energy properties from the presence of high surface areas and charge transport mechanism. Certain embodiments provide the charge transport mechanism being further derived from the flow of pressured fluid 423. Certain embodiments of the pressure fluid 423 comprise sound waves, solar energy, vibration and wind. Disclosed embodiments further provide apparatus for thermal expansion of fluid in communication with the nano-wires/tubes 714. Embodiments provide silicon-microfibers and nano-wires/tubes 714 being further provided with methods for converting thermal energy into electrical energy. Certain embodiments of the thermal expansion of the fluid comprise sound waves, solar energy, vibration and wind and/or material pyrolysis.

Some embodiments provide energy medium, including apparatus 720 comprising means through which electron transfer occurs at the electrode 716 through the release of chemical energy to create a voltage through oxidation/reduction reactions 722. Certain embodiments further provide the apparatus 720 comprising at least an energy cell platform. Some embodiments provide the apparatus 720 further comprising CMOS multiple antennas configured with meta-material surface cavity. Disclosed embodiments provide the apparatus 720 comprising a CMOS multiple antennas platform comprising opened ends 720A and shorted ends 720B. The oxidation and reduction reactions 722 is being separated through the electron 716. The electrode 716 is being configured with CMOS substrate-microfiber 724 embedded with multiple antennas comprising intra-chip network re-enforcements to external electric circuit communication and data transmission efficiency. Certain embodiments provide at least a storage medium, comprising internal transport voltages at electrodes configured for providing useful energy transport stream to batteries 724 and/or capacitors 726. Disclosed embodiments provide silicon microfiber further comprising of Si-substrate consisting of a patterned isolation layer.

Certain embodiments provide the Si-substrate being etched/fused through openings of the patterned isolation layer to form a plurality of electric-conducting platform. At least the electric conducting platform further comprises electric-conducting wires and/or at least heat-conducting wires in communication with an opto-electronic device. The opto-electronic device further comprises opto-isolation apparatus being configured with at least a LED. Disclosed embodiments provide silicon microfiber further comprising a remote sensor assembly comprising multiple antennas being configured with a plurality of micro electromechanical system (MEMS) embedded on the silicon substrate.

The silicon substrate further comprises a wireless communication circuit being configured with a processing device operable to obtain data, such as measurement values from at least one of plurality of MEMS sensors. Certain embodiments provide the silicon substrate further configured to perform at least a filtering operation on at least one of: communication signals, data transmissions, and measurement values. Disclosed embodiments further provide silicon microfiber further comprising apparatus for coupling light between input and output waveguides comprising structures having higher portions or lower portions being arranged at a fine pitch equal to or shorter than a wavelength of visible light on base surface responsive to plurality of arc track rows.

Disclosed embodiments provide the CMOS multiple antennas 724 further comprising at least a chip configured with integrated circuits comprising nano wires 714 embedded in silicon substrate microfiber 712 being alloyed with meta material structure comprising a surface cavity. The CMOS multiple antennas further comprise radio frequency applications operable to provide intra-chip antenna network, enabling GHz frequencies for Bluetooth, WiFi wireless networks, and mobile phones.

In the disclosure, the chip is further configured with power amplifiers operable to provide communications and data transmissions over short and long ranges. At least a metal oxide semiconductor is configured with silicon substrate microfiber to provide better power efficiency, achieve better communication clarity, and achieve extended power life. The CMOS multiple antennas on chip with embedded amplifiers are operable to realize high operating frequencies to enable high data rate communications and to prevent atmospheric absorption. Nano wires 714 are operatively configured with the CMOS antennas 724 in some embodiments to provide multicast protocol label switching network for wireless communication. The CMOS antennas 724 are operable to realize a wireless network region better than at least 600 Hz for wireless communications, military application, high speed data transmission applications, and homeland security intelligence applications. Certain embodiments provide the nano wires 714 configured to provide a platform to protect against oxygen absorptions, avoid interference from other networks, and protect against human health concerns. Some embodiments provide a communication apparatus configured to provide desirable high definition television “HDTV” signals with high data rate communications being operable at the realized transmission frequencies.

Disclosed embodiments provide the realized transmission frequencies comprising providing better communications for wireless personal area network “WPAN,” local area network “WLAN,” and allowing communications for wireless Gigabit Ethernet, mobile devices synchronizations, wireless fire wire and USB display. Embodiments provide the high rate WPAN further includes point to point transport for bulk data transfer, multimedia streaming and streaming HD multimedia contents. Some embodiments provide the CMOS multiple antennas operable on a chip comprising silicon substrate microfiber being alloyed with meta-material for integrated circuit. Other embodiments provide the integrated circuit being configured for low power consumption. Disclosed embodiments further provide the integrated circuit further comprising digital signal processing “DSP” for higher frequencies.

Certain embodiments provide the chip comprising at least a single chip circuit or a module operable for converting digital signal into at least a 60 GHz modulated radio wave. Other embodiments provide the module further operable for converting radio wave signals into at least 60 GHz digital signals. Further embodiments provide the silicon substrate microfiber providing additional output power gain and long term data transmission reliability. Disclosed embodiments provide the meta-material comprising die-electric materials operable to provide at least a metal gate electrode 716.

Other embodiments provide the antennas 724 comprising a chip configured with at least a software program. The chip is disposed on a logic circuit configured with transistorized switches to provide on chip multiple antennas arrays that are programmable for boosting signal reception and/or for changing signal transmission directions. The CMOS multiple antennas 724 are opened at one end 716 and shorted at the other end 720. The shorted end 720 is integrated with power supply circuitry 726, 728, and 730 to reduce/eliminate critical signal loses. Disclosed embodiments further provide the nano wires operatively configured for restraining internal noise and for providing stable communication operations.

Disclosed embodiments further provide the antenna apparatus 201, 418 comprising at least a field programmable gate array “FPGA.” Certain embodiments provide the FPGA disposed with meta material coupled to semiconductor substrate in communications with nano wires 714. The nano wires comprise signal interconnect lines in communication with the shorted end of the FPGA meta material structured surface 712. The first antenna portion 201 is connected to the second antenna portion 418 at the shorted end 720. The shorted end further contains thin conductor layers portion characterized as having a plurality of thin, fine-pitch nano-wires conductors 720.

The nano-wires may be configured to convert electromagnetic wave energy into electrical energy to provide further additional operating power platform for the communication apparatus 400. The opened end contains conductive material configured to absorb electromagnetic wave energy in communication with the shorted end 720 consisting of the FPGA meta material structured surface. Plurality portions of three dimensional antennas are joined at the shorted end comprising MEMS wafer leveled surfaces within flatness at the top and nano wires protruding at the bottom of the flat surface. The nano wire portions are fused and/or etched.

Disclosed embodiments provide CMOS multiple antennas 201 and 418 disposed on a semiconductor chip 403. Certain embodiments provide the chip consisting of an integrated transceiver. In the disclosed embodiments, the antennas 201 and 418 are further configured to transmit and to receive, comprising a transmitter and a receiver. The transceiver is formed on a semiconductor substrate comprising silicon substrate alloyed with meta material 712. At least one semiconductor substrate is configured with microfiber material 710 to provide electrical connection between the transceiver 724 and the semiconductor substrate 712.

The antenna may be formed with a dielectric layer 711 being connected to the transceiver 724. At least the meta material structured surface 712 further comprises a reflective plate 713 connected to the substrate. The separation between the reflective plate 713 and the antennas 201 and 418 are about a quarter wavelength of millimeter waves, which enhances radiation efficiency of the antennas. Some embodiments provide an array of silicon substrate microfiber 712 being formed and filled with the dielectric material 711 to reduce the effective dielectric constant of the material between the antennas 201 and 418 and the reflector plate 713, thereby reducing the wavelength of the millimeter wave and enhance the radiation efficiency. Other embodiments provide the antenna apparatus 201, 418 being fabricated on a low resistivity CMOS-grade silicon substrate microfiber. The antennas are configured to resonate at least at 6 GHz.

Embodiments relate generally to wireless communication systems that employ micro machined antennas 201 and 418 fabrication on a field programmable gate array, comprising a removal of silicon substrate underneath the antenna structure to increasing the overall radiation efficiency. Disclosed embodiments provide CMOS multiple embedded antennas that include a feeding portion, radiating portion, grounding portion and short portion. The feeding portion is operable to feed electromagnetic signals through an opened end 716. The radiating portion 724 is connected to the feeding portion 716 to radiate the electromagnetic signals. The radiating portion includes a first radiator 201 and a second radiator 418. The first radiator is “L” shape, with a first end electrically connected to the feeding portion. The second radiator is formed by a plurality of connected radiating sections. The second end of the first radiator and the second end of the second radiator are connected to the radiator shorted end 720. The first end of the shorted portion 720 is connected to a common node 726 of the first radiator 201 and the second radiator 418, and a second end of the shorted portion 720 is connected to the grounding portion consisting of nano wires 714.

Disclosed embodiments provide CMOS multiple antennas in a chip and could include employing an antenna that resonates at least at 5.8 GHz. Another disclosed embodiment includes a differential feed operationally coupled to CMOS multiple antennas. In one disclosed embodiment, the antennas are fabricated on relatively low resistivity CMOS-grade silicon substrates. In one such exemplary non-limiting embodiment, CMOS multiple antennas and a photo-resist form an antenna approximately 400 um in thickness, is 12 mm long and 2.8 mm wide. In another embodiment, at least one CMOS antenna is provided, the CMOS multiple antennas portion is separated from the CMOS antenna and a photo-resist material connects the first and second CMOS portions.

The antenna 201 may include at least one CMOS antenna 418 and the CMOS multiple antennas portion 724. A photo resist material 711 is coupled or connected to the CMOS portions 418 and 724. The antennas 201 and 418 can be fabricated on a silicon substrate microfiber with a thickness of at least 10 um and/or between 10 um and 700 um. Disclosed embodiments provide the communication apparatus 400 further comprising the CMOS multiple antennas 201 and 418 being disposed on the chip 403 operable for digital signal processing “DSP.” The chip 403 is further coupled to an application specific integrated circuit 107. Certain embodiments provide the antennas further comprising meta material structured surface cavity for enabling high data transmission. Some embodiments provide the meta material structured surface comprising at least a reflective element operable for wireless interconnections and for transmitting data wirelessly at a much faster speed.

Other embodiments further provide a silicon wafer comprising folded dipole antennas configured with meta material structured surface on at least a dielectric micro-fibered material to provide better conductor gain at a resistivity of at least 5 cm, with a thickness of at least 10 um, and impedance of at least 100 being fed through at least the nano wires consisting of lengths of at least 1.5 mm. Disclosed embodiments are not limited to the dimensions herein. Certain embodiments further provide exemplary embodiments of the antenna being constructed of conducting nano wires 714 being coupled with a size of at least a 2.50 mm by 4.3 mm at a height of at least 525 um.

In the embodiments, the antenna further comprises at least silicon substrate microfiber disposed with the meta material structured surface configured for low resistivity and better conductor gain to enable a broader bandwidth. The CMOS multiple antenna is further disposed on flat surfaces consisting of at least a vertical slot being narrowed with at least a wavelength of at least a quarter deep. The antenna 201 and 418 are further configured for surface wave propagation to at least the shorted end 720B. In some disclosed embodiments, impedance is higher at the opened end 720A. In other disclosed embodiments, at least a corrugated meta slap is coupled to at least a vertical wall to modify radiation patterns to increase antenna gain. Disclosed embodiments provide the radiation pattern further includes a radiation pattern back lobe comprising nano wires being etched/fused at the shorted end 720B with the meta material surface configured to provide higher gains.

The antenna 201 can be derived from a dipole antenna in one exemplary generalized non-limiting antenna embodiment. The antenna can be a differential-fed antenna and can be easily integrated into active circuits. Disclosed embodiments provide a complementary metal-oxide-semiconductor (CMOS) consisting of integrated multiple antennas circuits 724 being disposed in at least a chip, comprising at least one of: microprocessors, digital logic circuits, static RAM, and microcontrollers. Certain embodiments provide the multiple antennas 201 and 418 comprising CMOS configured with silicon substrate microfiber being alloyed with meta material structured surface 712 to provide wide variety of analog circuits such as image sensors and data converters. Some embodiments provide highly integrated transceivers 724 configured for variety of communications, including military applications.

Disclosed embodiments provide the CMOS further comprising complementary and symmetrical pairs of p-type and n-type metal-oxide-semiconductor field-effect transistors (MOSFETs) operable for logic functions. Certain embodiments provide the CMOS further comprising a structured material with relatively low resistivity and relatively inexpensive. Certain embodiments provide a CMOS multiple antennas apparatus comprising means for radiating or for receiving electromagnetic energy and operable to accepts power from a source and radiates the power into the shorted end. The received energy is radiated to the source or dissipated to a resistive load. The ratio of the power radiated into the ground nano wires to the power received from the source is the radiation. Radiation efficiency is defined as “the ratio of the total power radiated at the shorted end by the multiple antennas to the net power accepted by the antennas from the opened end” (Pradiated/Pinput=nefficiency).

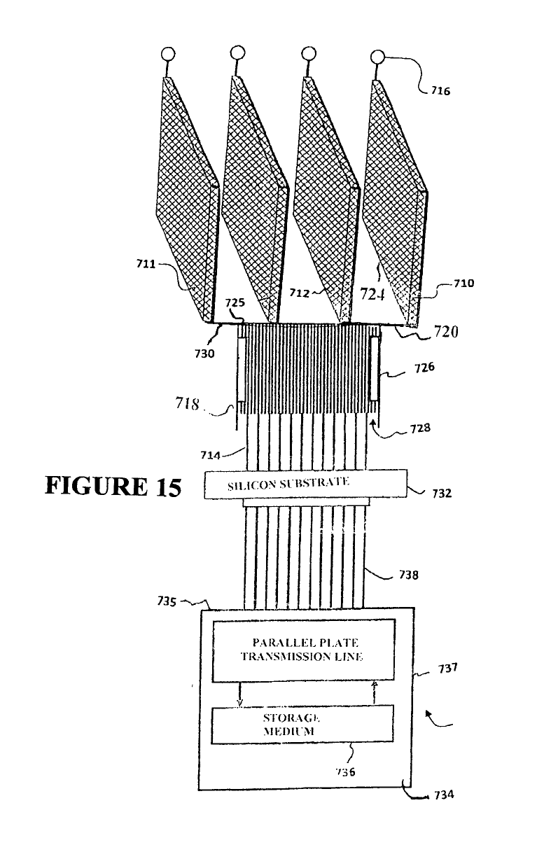

FIG. 15 illustrates CMOS multiple antennas on a chip comprising substrate microfiber embedded with meta-material. As shown, CMOS multiple antennas 724 on a chip comprise substrate microfiber embedded with meta-material for communications and for an energy medium. The CMOS multiple antennas 724 are opened on one end configured with electrode and temperature sensor 716, and shorted on the other end 720, being configured with nano wires for antenna network communications, in communication with the energy storage medium further comprising energy storage apparatus coupled to the shorted end 720. Disclosed embodiments provide methods and systems for realizing frequencies of at least 60 GHz and for generating electrical energy. Certain embodiments provide apparatus for generating electric energy from the energy released by at least a reaction, such as pressure, thermal transport, heat, force, motion and vibration.

Certain embodiments provide microfiber material 710 being configured silicon substrate for converting pressure, vibration, heat, thermal transport, wind, and/or force into electrical energy. Some embodiments of the energy being generated comprise electrical energy 730. Other embodiments of the energy being converted comprise thermal energy 732. The thermal energy, in other embodiments, is being transported through the nanowires/tubes 714 in communication with the silicon-microfiber material and/or the electrode. Certain embodiments provide the nano wires/tubes further configured to provide a platform for each shorted CMOS antenna to engage in antenna network to achieve at least a 600 Hz frequency. The microfiber material 710 further comprises plurality meta-material comprising textile fibers 711, being alloyed with zinc oxide (ZnO) nano-wires 734 to form at least a metamaterial structured surface cavity.

Disclosed embodiments provide the zinc oxide nano-wire 734 further configured with piezoelectric crystals for generating electrical energy 728 and at least a coil for communicating and/or transporting the electrical energy being generated to at least a capacitor. Disclosed embodiments further provide the piezoelectric further comprising an electromagnetic composite meta-material including an electromagnetic medium.

Certain embodiments of the piezoelectric comprising plurality of spaced electromechanical resonators disposed in the electromagnetic medium configured to control electromagnetic wave propagation properties in the electromagnetic composite meta-material. Certain embodiments provide a communication apparatus being configured with signal booster chip in communication with an antenna apparatus being operable to allow current flow 730 from plurality fiber pairs 736.

Other embodiments provide the fiber pairs being configured for converting at least one of: vibration, pressure, blood flow, sound, waves, force, thermal energy, and other electrical properties into electrical energy 730. Some embodiments provide a device for generating pressure, thermal energy and force and producing electrical energy 730. Certain embodiments of the device may produce electrical energy 730 further comprising radiation apparatus. Other embodiments of the radiation apparatus comprise a radiator device being configured with silicon substrate microfiber and at least an electrode.

Disclosed embodiments provide the radiator device comprising a device that emits radiant energy. Disclosed embodiments provide nanotechnology applications comprising nano sensors and MEMS embedded on a silicon substrate and etched/fused in a micro fiber material, preferably fabricating together a unified process with supporting integrated circuit (IC) on the same semiconductor substrate comprising integrated silicon platform comprising a chip configured with CMOS multiple antennas 724. Certain embodiments provide the integrated silicon platform in at least a single chip to greatly reduce the size, weight and power consumption of the communication apparatus 400 and enhance the performance of all applications for the communication apparatus. Disclosed embodiments provide the energy platform comprising a cell platform 720 being further configured for medical device applications.

Other embodiments of the cell platform comprise CMOS multiple antennas configured for intra-chip antenna network for effective communication applications. Disclosed embodiments further provide the cell platform comprising at least a nickel-cadmium (NiCd) configured with nickel oxide hydroxide and metallic cadmium for energy capture. Disclosed embodiments provide the nickel oxide and metallic cadmium further consisting electrodes 716 being configured for deep discharge applications. Other embodiments provide methods and systems for storing electrical energy, comprising the cell platform 720. The cell platform includes battery cells and/or capacitors configured for withstanding higher numbers of charge/discharge cycles and faster charge and discharge rates. Certain embodiments of the cell platform further comprise an electrode device comprising at least electrically conductive nano wires/tubes 714 being coated with at least one electrically isolating layer. The nano wire/tubes may comprise silicon nano wire operable to display biological analysis results such as electrical responses to either pH changes or receptor-ligand interactions of at least one of: protein disease, viruses and DNA hybridization in real-time.

Embodiments further provide communication apparatus comprising apparatus for generating pressure, thermal energy and force, and for converting the pressure, thermal energy and force into electrical energy. Disclosed embodiments further provide methods and systems for converting wind force into electrical energy. Some embodiments provide microfiber material 710 comprising zinc oxide (ZnO) being configured for converting pressure and force into electrical energy 730. Some embodiments of the microfiber material 710 further comprise meta-material structured surface cavity comprising nanotechnology applications. Disclosed embodiments provide a method of selectively etching a solid sacrificial sensory layer, comprising wet etching and/or dry etching.

Other embodiments provide methods and systems of generating renewable electrical energy through nanotechnology applications. The nanotechnology applications comprise at least a single layer microfiber 736. Other embodiments of the microfiber 710 further comprise miniaturized meta-material arrays comprising nano-wire 734 being configured for applications in hybrid communication applications to increase data transmission speed, including HDTV applications, further comprising generator assembly 738 in communication with the energy platform. Certain embodiments provide the generator assembly 738 comprising at least semiconductor properties consisting of nonferrous material arrays. The nonferrous material array comprises vertically-aligned zinc oxide (ZnO) nano-wires 734. The zinc oxide nano-wire 734 is being configured to exhibit flexible electrode 716.

Certain embodiments provide the flexible electrode 716 comprising complementary metal oxide semiconductor. Some embodiments provide the flexible electrode further comprising conductive platinum tips 735 comprising of CMOS-MEMS. The CMOS MEMS further comprises probes switches operable to actuate down onto a specific programmable addressable location and deliver a current Phase change (PC). The CMOS MEMS is embedded within a reconfigurable circuitry to provide a low or high resistance state. When the reconfiguration is complete, the heaters in the probe are turned off and electrical and/or mechanical contacts are broken. The application provides the reconfiguration of radio-frequency circuits further configured for repeatable contact resistance.

Other embodiments provide the microfiber material 710 further comprising plurality fibers being operable for characterizing excellent electrical properties. The microfiber material is coupled with meta-material structured surface cavity and/or coated with polymer and/or with zinc oxide layer 734 to realize at least 600 Hz frequency and to provide energy transport platform 725. Certain embodiments provide the nano-wires 734 configured to provide antenna network platform 718. Some embodiments further provide the nano-wires 734 being coated with gold 737, and fused or etched on the energy transport platform 725. Other embodiments provide the nano-wires 714 further configured for harnessing energy from at least a medium, comprising at least one of: vibration, pressure, blood flow, sound, waves, thermal source, wind, motion and force.

Further embodiments provide the CMOS multiple antenna apparatus 724 further comprising zinc oxide (ZnO) 734 being embedded in a silicon substrate configured with at least polymer. Disclosed embodiments further provide a single crystal silicon to improve the fabrication of micro-acoustics and micro optics and to provide an energy platform for converting solar energy, sound wave, vibration, pressure force and wind force into electrical energy.

The micro-acoustics and micro-optics are further fabricated in a micro-electromechanical system and thin film technique to enable the integration of microelectronics circuit and multifunctional sensor into the detection platform for the communication apparatus. Wafer bonding in single crystal silicon is applicable to significantly lower acoustic losses and improve optical properties and energy production. Disclosed embodiments further provide silicon on insulator bonding method having a silicon layer formed on a silicon microfiber oxide film as an insulator film comprising parasitic capacitance being configured for high radiation-proof ability. At least a layer in the substrate surface layer portion comprise a region electrically isolated from the inside of the substrate via oxide film layer to eliminate effects such as a high speed/low power consumption operation and/or prevention of low signal transmission. The substrate further includes single-crystal silicon substrates comprising at least a single-crystal silicon substrate that becomes an SOI layer and/or a bond wafer.

Certain embodiments provide the silicon substrate comprising a single-crystal silicon substrate that becomes a support substrate being configured with an oxide film on the surface of at least one silicon substrate microfiber. The single-crystal silicon substrates may be bonded to each other via the oxide film there-between and heat treated to increase bonding strength. Then, a film thickness of the bond wafer is reduced to obtain an SOI substrate.

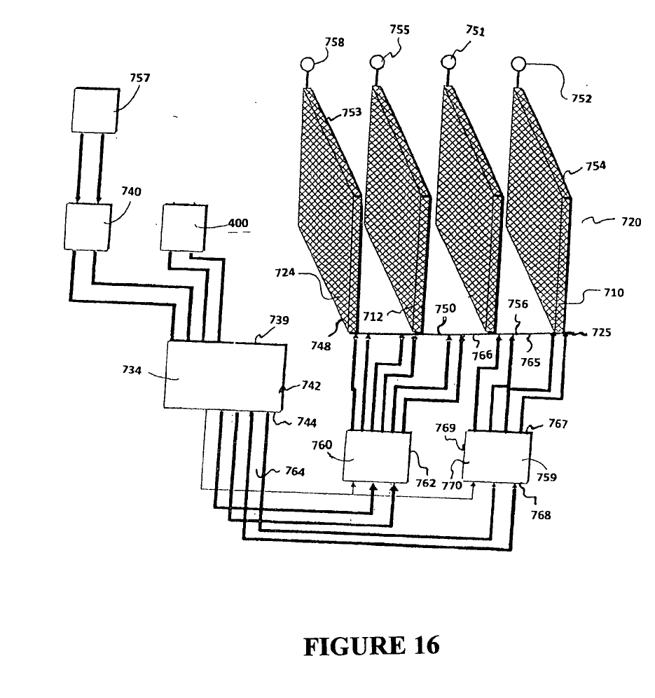

FIG. 16 illustrates a communication device comprising an energy platform, including an energy medium comprising energy platform. Embodiments further provide silicon-substrate-microfiber comprising energy transmission/storage apparatus 720. Certain embodiments provide data being converted into electrical energy. The data may be derived from at least one of: vibration, pressure force, wind flow, sound waves, force and electrical properties. The pressure may include pressure force from at least an object. The object may also include human hand use to operate the communication apparatus 400. The operation of the communication apparatus may include keyboards, touch screen, gaming, texting, programming, display/input, output, and normally utilized operations. Disclosed embodiments further provide the silicon-substrate-microfiber comprising charge couple apparatus 740 being configured with miniaturized conduit particles 734. Certain embodiments of the conduit particles 734 comprise at least glass 739. Other embodiments of the conduit particle comprise of at least Zinc Oxide (ZnO) and/or gold. Some embodiments of the disclosed particles comprise of at least non-ferrous material being alloyed with at least a substrate-microfiber 724.

Disclosed embodiments further provide materials consisting of conduit properties comprising of at least glass fiber 739 being responsive to light data transmission. Further embodiments of the charge particle apparatus 740 comprise electron-silicon substrate-oxide 742 configured with materials being characterized with good optical properties for exhibiting effective sensitivity to electron range. Disclosed embodiments further provide the electron-silicon substrate-oxide 742 comprising coatings to prevent glass-glass interface 744. Certain embodiments comprise the silicon substrate 712, being at least the constituent of glass 739. Other embodiments provide the silicon substrate 712 being layered with fibers 710 to exhibit durability and better charged properties.

Certain embodiments provide an energy platform comprising AIN thin film. Disclosed embodiments provide communication apparatus consisting of solar cell methods of generating electrical energy and silicon wafers process of producing a simpler and cheaper alternative green energy communication apparatus. Disclosed embodiments further provide a communication apparatus comprising of direct band-gap semiconductors cadmium telluride (CdTe), copper indium diselenide alloy (CuInSe2) and copper indium gallium diselenide alloy Cu(InGa)Se2, comprising materials with high optical absorption coefficients being applicable for the photo absorption layer in thin film photovoltaic (TFPV) cells for the energy platform.

The electrodes 716 further comprise battery cells 748. Other embodiments provide the battery cells 748 further including electrolyte 750 comprising cathodes 751 and anodes 752. The cathodes 751 comprise the oxidized form of the electrode metal and the oxidizations and reductions are controlled by the electrochemical potential being responsive to the thermal expansion, pressure, composition and concentration of the electrolyte 750. The electrical potential differential being produced is the sum of the electrochemical potential at the electrode 716. Disclosed embodiments further comprise of Zinc batteries and/or zinc fuel cells 754 being configured for electrochemical power applications through the oxidation of zinc with oxygen from the air.

Embodiments provide a device for exhibiting high energy density. Certain embodiments comprise nano-materials 734 being embedded in the substrate 712 and etched/fused in the microfiber material 710 to provide advanced cell platform 756. Some embodiments of the cell platform 756 are being communicatively connected to the electrodes 716. Other embodiments of the cell platform 756 comprise a battery cell 753. Yet, other embodiments of the cell platform 756 comprise fuel cell 754. Still, other embodiments of the cell platform comprise energy storage medium. Disclosed embodiments further comprise a capacitor and/or a battery cell apparatus for electronic devices.

Yet. some embodiments provide CMOS multiple antenna platform configured with at least an opened end 755 and at least a shorted end 766 in communication with conductive nano wires 764 forming at least antenna network environment.

Disclosed embodiments provide the cell platform 756 further configured for medical devices applications 757. Other embodiments of the cell platform 756 comprise communication applications 758. Disclosed embodiments further provide the cell platform 756 comprising nickel-cadmium batteries (NiCd) 758 configured with nickel oxide hydroxide and metallic cadmium 760. Disclosed embodiments provide the nickel oxide and metallic cadmium 760 further consisting electrodes 716 being configured for deep discharge applications. Other embodiments provide methods and systems for storing electrical energy, comprising the cell platform 756. The cell platform 756 includes battery and/or capacitor configurations for withstanding higher number of charge/discharge cycles and faster charge and discharge rates.

Certain embodiments of the cell platform 756 further comprise an electrode device 762 comprising at least electrically conductive nano wires/tubes 764 being coated with at least one electrically isolating layer 765. Disclosed embodiments further provide nano-wires/tubes 714, 764 comprising at least a substrate 712 being coated with at least one metallic layer 760 having a nano-metric pattern thereon. and being at least partially exposed at a tip of electrically conductive core 760. The cell platform 754 further comprises a plurality of nano-wires/tubes 714, 764 being configured with flexible electrode devices 762 disposed in a guided re-enforced silicon substrate 712. Other embodiments further provide each electrode device 764 being configured with plurality of micro-wires 734 being connected to at least one nano-wire/tube. The nano-wires/tubes 714, 762 further comprise flexible electrode devices 762 being configured to provide electrical communications, video recording, mobile broadband applications, camera/webcam and television applications.

Disclosed embodiments further provide the cell platform 756 comprising particles of zinc mixed with an electrolyte consisting of at least potassium hydroxide solution. Certain embodiments provide a communication apparatus configured for converting sound waves, solar energy, vibration and wind into electrical energy. Some embodiments provide oxygen from the air to enable reaction at the cathode 751. The reactions can form hydroxyls, which may be migrated into zinc paste and form zinc oxide hydroxide 734 configured for releasing electrons to the cathode 751. Disclosed embodiments further provide the reactions comprising zinc decaying into zinc oxide 734, the communication apparatus generating electrical energy from sound waves, solar energy, vibration, and wind, in communication with the cell platform 756. The cell platform 756 is being configured so that the sound waves, solar energy, vibration, and wind and hydroxyls from the anode 752 are being recycled for energy production at the cathode 751. The recycling would enable the sound waves, solar energy, heat, vibration and wind to serve only as a catalyst to effectively produce maximum voltage.

Embodiments provide a substrate 712 and microfiber material 710 for the design configuration of the cell platform 756. The cell platform further comprises electro-active material to enable better charge transport. The cell platform 756 further comprises a plurality of nano-components consisting of nano-particles 767 forming conductive carbon-based nano-clusters 768 bound together by a conductive carbon-based cluster binder having high densities of mobile charge carriers such as electrons, electronic acceptors and ionic species. The cell platform 756 further comprises at least a terminal 769, being electrically coupled to the nano.particles 768 for enabling a charge transport being operable for supplying electrons and electron acceptor sites. Other embodiments of the cell platform 756 further comprise charge transport 740, occurring by means of the electron traveling through the highly conductive and short path of the binders 770. Disclosed embodiments provide the binders in close proximity with the nano.clusters 768 for enhancing the energy and power densities. Disclosed embodiments further comprise battery cell and/or capacitor.

Disclosed embodiments provide a radiator apparatus comprising a renewable energy source. Certain embodiments provide communication apparatus comprising solar panels made of crystalline silicon wafers for converting solar energy into electrical energy. Some embodiments provide thinner wafers using laser processing to ablate the circuit board, providing more electrically efficient communication environment for signal amplification. Disclosed embodiments provide the radiator apparatus being further configured with substrate-microfiber and metallic materials to prevent any radioactive or chemical impact within the environment. Disclosed embodiments further provide the radiation apparatus being further configured for extracting energy from the opposing outside wind to be stored within the cell platform. Disclosed embodiments provide methods and systems that don't produce noise and pollution. More electricity could be generated at any time without physically plugging the communication apparatus into a wall socket for recharge, thereby extending the life of the battery.

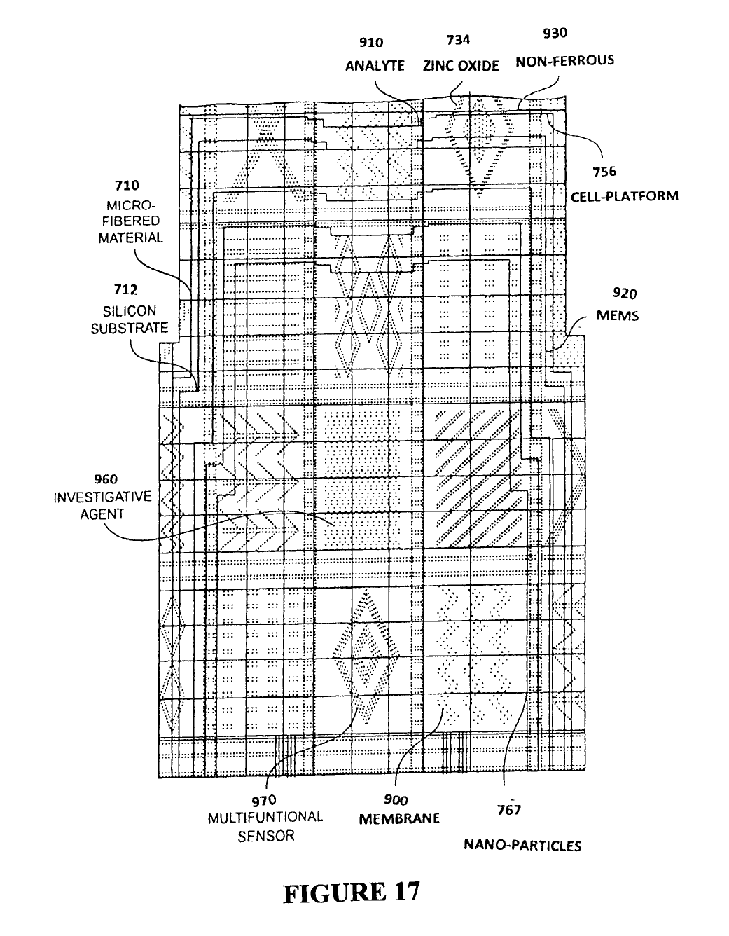

FIG. 17 illustrates exemplary embodiments of a charge transport comprising microfiber material 710 being configured with silicon substrate 712. The silicon microfiber comprises cell platform 756. The cell platform 756 comprises nonferrous material 930 embedded in the silicon substrate 712. Multifunctional sensors 970, nano.sensors 360, 327 and MEMS 920 are embedded in the silicon substrate for detection of charge characteristics. The cell platform 756 comprises nano particles 767 being configured with membranes 900. Disclosed embodiments provide methods and systems for generating electrical energy and for transporting the energy into a storage medium. Some embodiments provide zinc oxide 734.

Certain embodiments comprise an analyte 910. Other embodiments provide an investigative agent. Embodiments provide a MEMS 2-D scanning micro-mirror with miniature optics and flexible electronics for unrestricted probe movement. Embodiments provide communication apparatus being configured with flexible electronics for unrestricted freedom of movement due to pressure, vibration, sound waves to generate energy through voltage-transformation circuitry in communication with the battery cells. The platform provides safety into MEMS system to protect consumers from dissipative radiant energy. Certain embodiments provide communication apparatus being operable on low power consumption. Certain embodiments provide highly efficient fiber amplifiers using ultrafast laser technique.

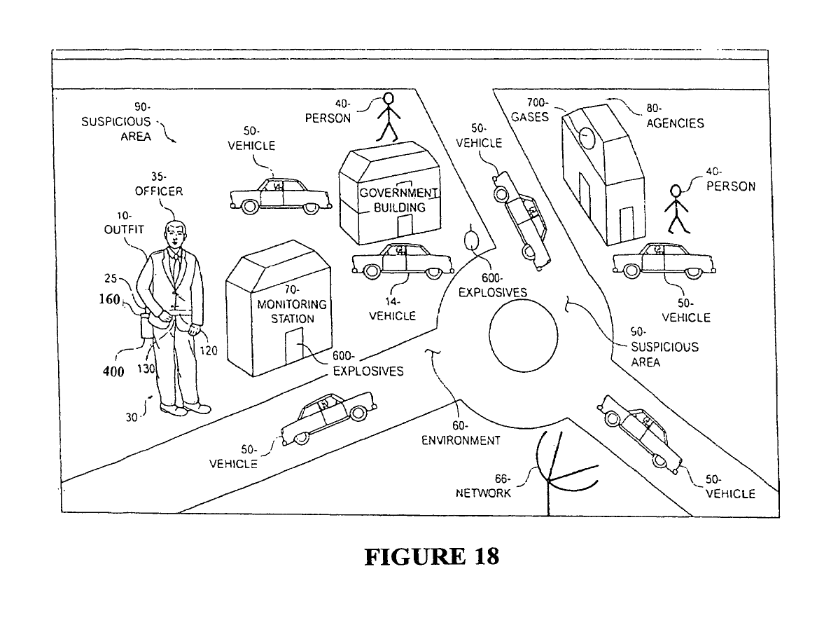

FIG. 18 illustrates communication environment 60, comprising a monitoring station 70, agencies 80 and a government building. Vehicles 14 and 50 and at least a person 40 are being watched by an Officer 35 monitoring a suspicious area 90. The Officer 35 is outfitted with certain embodiments of the disclosure, comprising outfit 10 on the officer 35, a communication apparatus 400, communication apparatus 400 being disposed in an outfit 160 operable for housing the communication apparatus, wearable outfit 30, waist belt 120, outfit 160 is firmly secured on the officer's waist by the waist belt 120, and connector 25 being disposed within the waist area 130. Officer 35 is seen to have identified a suspicious person 40 patrolling at least agencies 80. The outfits 10, 30 and 120 are seen to provide exemplary embodiments of detected explosives 600 and gases 700. The communication apparatus 110 is further configured to analyze detections and is in communication with a network 66.

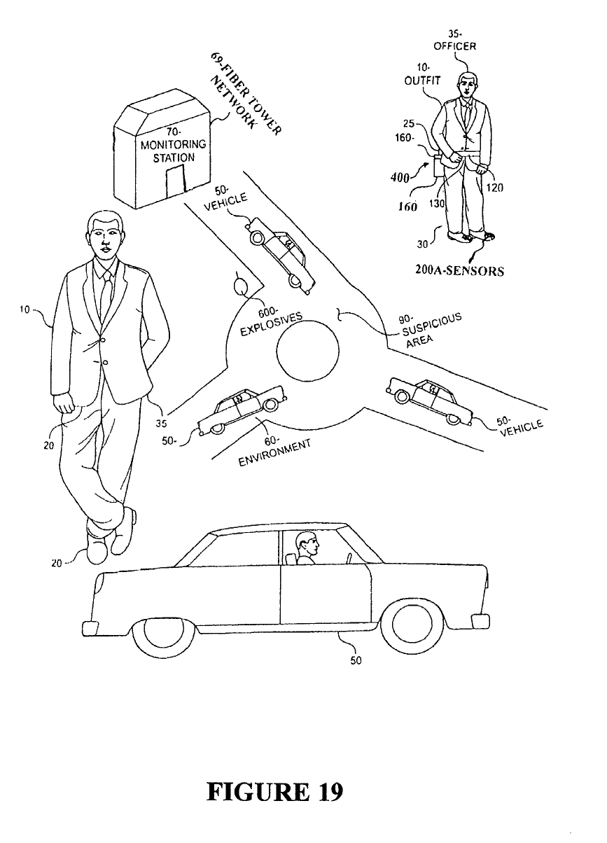

FIG. 19 illustrates an embodiment of a monitoring station 70 comprising a fiber tower network. A person 35 is seen wearing a detection outfit comprising of sensors embedded in silicon substrate and fused/etched in a microfiber material, a communication apparatus 400 is disposed in an outfit 160 comprising a housing being secured on the waist area 130 via a waist belt 120 by the person 35. The housing further comprises silicon substrate micro fiber being embedded with sensors operatively configured for generating electrical energy. The communication apparatus 400 is communicatively configured with signal booster operable to prevent cancerous disease and is responsive to network communications with the monitoring station 70 and/or fiber optic tower 69.

The communication apparatus may be configured with battery cells responsive to energy being created and responsible for supplemental empowering of the detection platform for the display device. Further embodiments of a person 35 are being disposed with communications apparatus 400. Disclosed embodiments provide the respective person 35 wearing outfits 10, 20, 30, 120, 160 and 130, operable for detecting weapons of mass destructions. The person 35 is communicating with communication apparatus 400 disposed in a vehicle 50 being positioned within an environment 60. The communication apparatus 400 may be configured to detect suspicious area 90 containing explosive 600. A suspicious vehicle 50 is seen to have been detected with weapons of mass destructions.

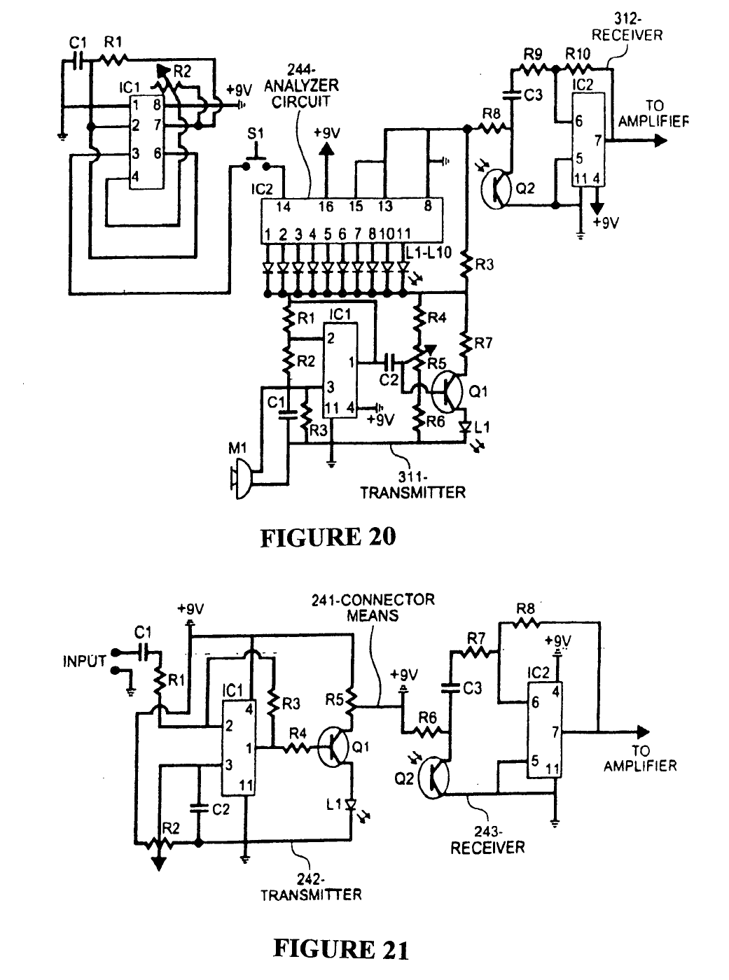

FIG. 20 illustrates transmitter 242 configured with energy apparatus comprising a battery cell which may be charged wirelessly. An amplifier is configured with the communication apparatus for amplifying signal communications. Transmitter 311 and receiver 312 are communicatively connected. Transmitter 311 and receiver 312 are communicatively connected to analyzer circuit 244. The CMOS circuitry is operable to dissipate less power. Certain embodiments of the disclosure further provide a static logic configuration being operable on p-type and n-type metal-oxide-semiconductor field-effect-transistors “MOSFET's,” being configured for implementing logic gates.

FIG. 21 illustrates an exemplary embodiment of a transmitter 242 and 311, and a receiver 243 and 312, configured with an energy apparatus comprising a battery cell which may be charged wirelessly. The amplifier is seen responsive to signal communications. Transmitter 242 is operatively configured with receiver 243 and communicatively connected to connector beam 244 responsive to communication network connections. The amplifier comprises a chip communicatively connected to receiver 243 and operatively configured with transmitter 242. The transmitter 242 and 311, and the receiver 243 and 312 comprise CMOS comprising of solar cells on n-type CZ silicon substrates, including Polycrystalline thin-film cells, lightly boron-doped CZ, or gallium-, indium-, and aluminum-doped CZ for converting solar energy, pressure force, sound wave, vibration, and wind force into electrical energy. Disclosed embodiments further provide a thin-film comprising of thin layer of transparent conducting oxide, including tin oxide. Certain embodiments provide the oxides being highly transparent and configured to conduct electricity efficiently. Some embodiments provide antireflection coatings.

Other embodiments provide Polycrystalline thin-film cells comprising tiny crystalline grains of semiconductor materials operable for converting solar energy into electrical energy. At least a CPU-1C1 is provided in communication with RFID chip reader-1C2, L1 and L2 are LED. S1 is an automatic momentary single pole double throw switch operative for transmitting and for receiving signals. C1 is an electrolytic capacitor being disposed on an energy platform comprising C2 and C3, which are IMF capacitors. O1 and O2 are infrared LED emitters and M1 is a speaker microphone. R1 through RI0 are resistors responsive to signals. Disclosed embodiments provide a digital signal processing system which allows reconfiguration of signal transmission to the environment and signal conditions. At least the antenna is developed for electrical operation, which can be reconfigured in terms of frequency and may also increase or decrease its directivity. The increase and/or decrease of signal directivity is a measure of the gain of the antenna in a particular direction.

Disclosed embodiments provide the communication apparatus being configured with the antenna to operatively pick up faint signal by increasing its gain or overcome interference by creating a null point. Certain embodiments provide a smart communication apparatus being configured for any given network or environment. Some embodiments provide a miniaturized adaptive micro antenna in communication with at least a chip being configured for signal amplification and to minimize interference and maximize intended signal reception. Disclosed embodiments provide signal booster chip comprising of at least a MEMS, in communication with a logic circuit. The MEMS further comprises MEMS based phase shifters being configured on at least a single silicon substrate microfiber comprising communication control circuitry. The sensors are being coated with silicon substrate polymer and/or with zinc oxide layer to provide energy transport platform.

Certain embodiments provide communication apparatus comprising silicon substrate microfiber configured with optical properties of thin films being operable for the advancement of the integrated circuit for converting solar energy into electrical energy. Disclosed embodiments further provide smaller feature sizes, faster switching speeds and lower power consumption apparatus. Some embodiments provide basic wiring such as dielectric and photolithographic layers, providing a circuit for electrical energy production. This integrated circuit could employ copper/low-k interconnects, silicon-germanium and silicon on insulator-based transistor structures. Infrared spectroscopy is provided and offers metrology approach to sensing through the display/input device/outfit, complementary to UV-VIS techniques that provide excellent sensitivity to layer composition, including chemical bond densities and free carriers with the enhanced immunity to roughness induced scattering.

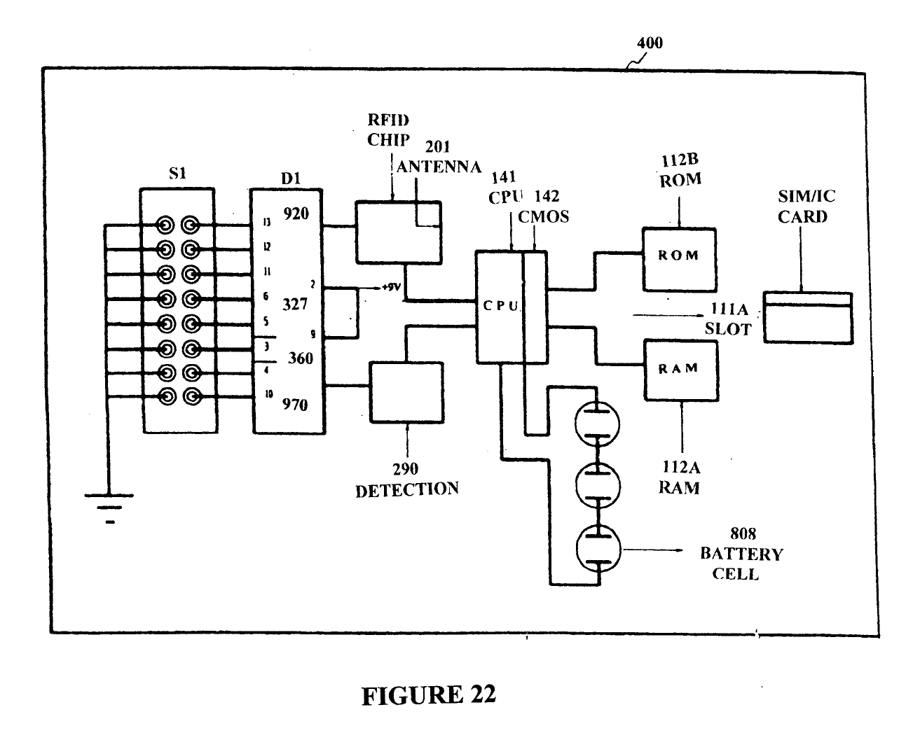

FIG. 22 illustrates an embodiment of the circuit diagram of the communication apparatus comprising a privacy indicator. Switch (S1) is communicatively connected to RFID CHIP for signal amplification. Certain embodiments provide a common node display (D1) comprising touch screen operatively configured with multifunctional sensors 970. The display device is further operable for generating energy. RFID CHIP is operatively configured with antenna 201. A CPU 141 is operatively configured with detection device 290 communicatively connected to at least a CMOS 142. The detection device is responsive to detection signal communications and operatively connected to a battery cell 808. The communication apparatus 400 further comprises an IC and/or SIM card slot 111A comprising SD card slot and/or HDMI/USB ports. Embodiments further provide user identification card 112.

The communication apparatus 400 may comprise an operating system consisting of software operatively configured with ROM 112B to read the ID card 112. The ROM 112B is communicatively configured to provide communications to the RAM 112A. The RAM 112A is responsive to communication database 113 where information may be stored or retrieved. A screen read-out 113A is provided configured with the communication apparatus. An 8-pin privacy indicator switch (S1) is operatively configured with the communication apparatus 400 and responsible for providing private communications. Switch (S1) comprises display selections corresponding to cathode A, cathode G and cathode D of at least a 7-segment common anode display settings (D1). Chip 200a comprises a detection tool responsible for providing communications to at least a network. The IC and/or SIM card 112 is further operable with the communication apparatus 400, comprising wireless communication applications in communication with a software program.

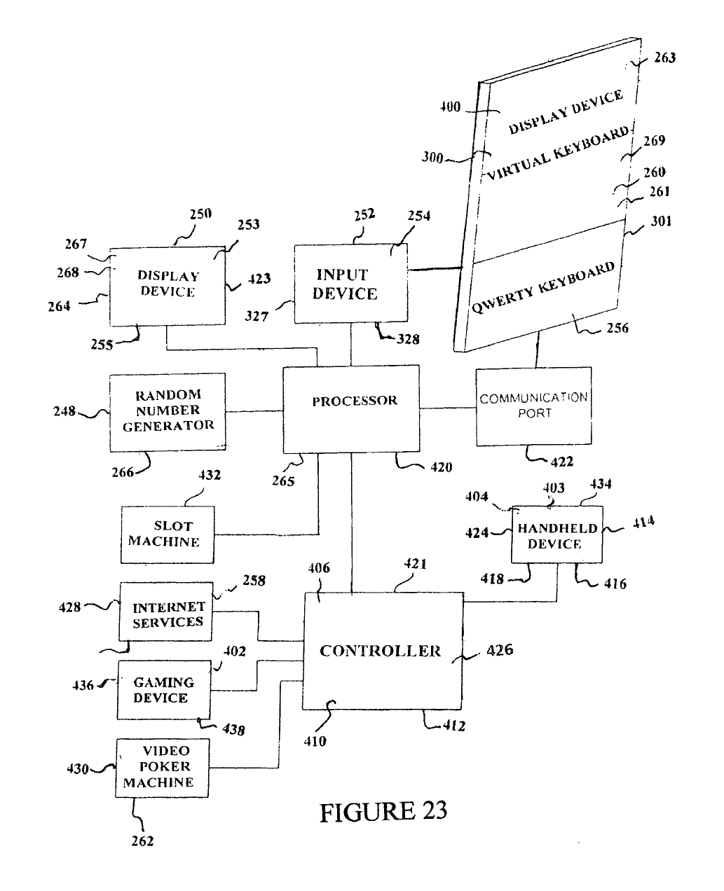

FIG. 23 illustrates an exemplary embodiment of the communication apparatus. The communication apparatus 400 comprises at least an input device 252, including a keyboard 254. The keyboard 254 may consist of a virtual keyboard 255 and/or QWERTY keyboard 256 in further communication with a random number generator 248. At least a social network application 258 is configured with the keyboard and in communication with the processor 420.

Disclosed embodiments further provide the keyboard being disposed on an LCD display screen 260 being configured with sensors 327 operable for object recognition. Certain embodiments provide the sensors 327 being configured for video recognition 262. Some embodiments provide the communication apparatus configured with a display device 260 operable with at least an activation button 264 configured for at least one of: phonebook 266, calendar 268, dictionary 267, calculator 265 and camera 263. Disclosed embodiments further provide the communication apparatus further comprising at least one of: a mobile communication device 400, a gaming device 402, a media device 403, and an interface device 404.

Some embodiments provide the interface device comprising at least an integrated phone/PDA 400 being configured with integrated connectivity apparatus 406 operable to provide global roaming. At least a communication port 422 is provided with the communication apparatus 400. Certain embodiments of the disclosure provide the communication apparatus comprising a GSM phone 400 being operable on plurality of microprocessors 420. Certain embodiments provide the communication apparatus being operable to allow multiple inputs/outputs 252. Some embodiments provide the communication apparatus comprising a touch interface 261 operable on a touch screen 260 configured for at least one of: interactive communication, interactive gaming, music, video and phone book.

Yet other embodiments provide the communication apparatus being configured with at least a slider 253 operable to access multimedia buttons and/or numeric keypads being configured with piezoelectric sensors 327. The piezoelectric sensors 327 further comprise crystals 328 configured to provide voice operations and/or voice over text applications. Disclosed embodiments provide the communication apparatus being configured with voice over text technology operable to provide hands free texting applications while driving. Still, other embodiments provide a communication apparatus comprising of carbon fiber 408 and/or silicon substrate microfiber consisting of resistive touch screen 260 and/or character recognition 269 and/or a communication board 300.

Certain embodiments provide housing 301 for the communication apparatus 400 comprising a carbon fiber 408 and/or a silicon microfiber. Disclosed embodiments further provide a communication apparatus being configured with at least a WAP browser 410 and/or an integrated GPS device 412 and/or an MP3 music device 414 and/or a camera apparatus 416 and/or an internal antenna apparatus 418 being configured with a controller 421 in communication with predictive text messaging applications 423. Certain embodiments provide the communication apparatus 400 being configured with at least one of: infrared sensor 326, calendar 268, FM radio 424, Bluetooth technology 426 and GPRS Internet services 428. Disclosed embodiments further provide the communication apparatus 400 comprising a video poker machine 430 and/or a slot machine 432 and/or a handheld device 434 and/or a gaming device 436 and/or a play station 438 in communication with communication port 422.

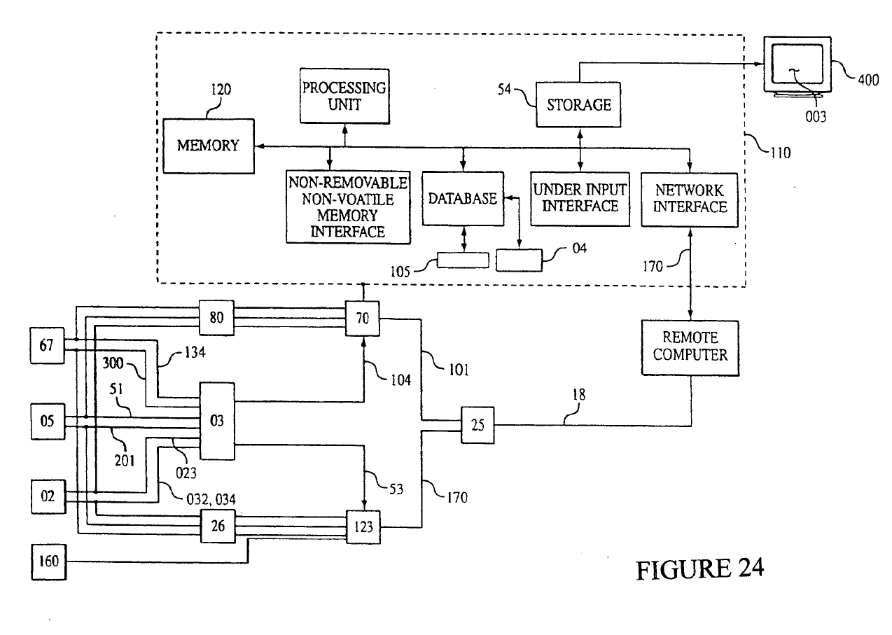

FIG. 24 illustrates an exemplary embodiment of the communication apparatus 400 comprising storage medium 54, a processing unit 122 in communication with a memory device 120. Disclosed embodiments further provide a non-removable non-volatile memory interface, a database, input interface and network interface 170. Certain embodiments provide a communication apparatus comprising hardware 105, a graspable hardware/browser 04 and a display device 003. Other embodiments provide a communication apparatus 400 comprising software 300, central processor 51, a RAM 05, a ROM 02, a network adaptor 160 and a media device 201. Disclosed embodiments further provide a communication apparatus 400 comprising at least an output device 70, a remote computer in communication with a connection key 25. The connection key is further in communication with industrial files 18, network files 110, decision engine 123, graphic user interface 101, sensors 104 and system memory 53.

Certain embodiments provide a communication apparatus being further configured with system bus architecture 67 in communication with an input device 80. Some embodiments provide the output device 70 further comprises a report generator 134 in communication with an instruction program 26. At least a CPU 03 is provided in communication with a java class 023. a clickn Vest Servlet class 032 and a Servletrunner application 034.

The foregoing relates to illustrative details of exemplary embodiments and modifications may be made without departing from the spirit and scope of the disclosure as defined by the following claims. While certain aspects and embodiments of the disclosure have been described, these have been presented by way of example only, and are not intended to limit the scope of the disclosure. Indeed, the novel of the apparatus described herein may be embodied in a variety of other forms without departing from the spirit thereof. The accompanying claims and their equivalents are intended to cover such forms or modifications as would fall within the scope and spirit of the disclosure. It is to be understood that the scope of the present invention is not limited to the above description, but encompasses the appended claims.

We claim:

1. A search engine apparatus comprising:
a computer apparatus in association with computer instructions executable on computer readable media;
a database in association with the computer apparatus, including transportation, science and engineering information;
an interactive interface apparatus communicatively connected to a network;
a support system; and
a processing apparatus in communication with the support system.

2. The search engine apparatus of claim 1, wherein the computer apparatus associates with computer instructions executable on computer readable media configured for receiving reference documents, transmitting reference documents, and sharing reference documents.

3. The search engine apparatus of claim 1, wherein said support system is communicatively connected to at least a carrier-based dedicated processing communication with multicast virtual networks.

4. The search engine apparatus of claim 1, wherein said processing apparatus is associated with at least one of: an input array, an output array, and a query array.

5. The search engine apparatus of claim 1, wherein said interactive interface apparatus includes a data bus comprising a platform for writing input into a data memory.

6. The search engine apparatus of claim 1, wherein said computer apparatus comprises a communication apparatus configured for determining key word maps.

7. The search engine apparatus of claim 1, wherein said processing apparatus and said computer apparatus allow a user to enter searchable topics of information.

8. The search engine apparatus of claim 1, wherein said computer apparatus comprises a spider.

9. The search engine apparatus of claim 1, wherein said computer apparatus comprises a crawler.

10. A management system for managing science, engineering and transportation data, comprising:
a computer system;
a database in association with said computer system, including transportation, science and engineering information;
an interactive interface;
a support system; and
a processing apparatus.

11. The management system of claim 10, wherein said interactive interface may allow a user to access information within said database.

12. The management system of claim 10, wherein said interactive interface may allow a user to input information into said database.

13. The management system of claim 10, wherein said computer system may verify information inputted into the database by users.

14. The management system of claim 10, wherein said management system may locate documents in said database including key-words.

15. The management system of claim 10, wherein said support system comprises a chat function.

16. A process for identifying patterns of information, comprising:
a computer system;
a database in association with said computer system, including transportation, science and engineering information;
an interactive interface;
a support system; and
a processing apparatus.

17. The process of claim 16, wherein said process may identify patterns of information relating to terrorism.

18. The process of claim 16, wherein said process may identify patterns of information relating to transportation systems.

19. The process of claim 16, wherein said database may be accessible by law enforcement agencies.

20. The process of claim 16, wherein said process may send alerts to law enforcement agencies based on identifying patterns of information relating to terrorist activity.
